(19) United States
(12) Patent Application Publication
(10) Pub. No.: US 2022/0146418 A1
(43) Pub. Date: May 12, 2022

(54) LABEL-FREE ASSESSMENT OF BIOMARKER EXPRESSION WITH VIBRATIONAL SPECTROSCOPY

(71) Applicant: Ventana Medical Systems, Inc., Tucson, AZ (US)

(72) Inventor: Daniel Bauer, Tucson, AZ (US)

(21) Appl. No.: 17/585,193

(22) Filed: Jan. 26, 2022

Related U.S. Application Data
(63) Continuation of application No. PCT/EP2020/073784, filed on Aug. 26, 2020.
(60) Provisional application No. 62/892,680, filed on Aug. 28, 2019.

(51) Int. Cl. G01N 21/3577; G06V 20/69; G06V 10/774; G06V 10/82; G01N 21/35; G01N 21/65

(52) U.S. Cl. CPC G01N 21/3577; G06V 20/695; G06V 10/774; G01N 2201/1296; G01N 21/35; G01N 21/65; G06V 10/82

(57) ABSTRACT

The present disclosure relates to automated systems and methods for predicting an expression of one or more biomarkers in a sample of a biological specimen. In some embodiments, the sample is one which has an unknown fixation status, or one where the duration of fixation to which the sample was subject is unknown. In some embodiments, the predicted expression is a quantitative estimation of the percent positivity of one or more biomarkers. In other embodiments, the predicted expression is a quantitative estimation of the staining intensity of one or more biomarkers. In some embodiments, the systems and methods utilize a trained biomarker expression estimation engine which has been trained with a plurality of training samples, where the trained biomarker expression estimation engine is adapted to derive biomarker expression features from the sample.

### CROSS-REFERENCE TO RELATED APPLICATIONS

The present application is a continuation of International Application No. PCT/EP2020/073784 filed on Aug. 26, 2020, which application claims the benefit of the filing date of U.S. Patent Application No. 62/892,680 filed on Aug. 28, 2019, the disclosure of which is hereby incorporated by reference herein in its entirety.

### BACKGROUND OF THE DISCLOSURE

The diagnosis of diseases based on the interpretation of tissue or cell samples taken from a diseased organism has expanded dramatically over the past few years. In addition to traditional histological staining techniques and immunohistochemical (IHC) assays, in situ techniques such as in situ hybridization (ISH) and in situ polymerase chain reaction are now used to help diagnose disease states in humans and to elucidate the gene expression sites in tissue sections. Thus, there are varieties of techniques that can assess not only cell morphology, but also the presence of specific molecules (e.g., DNA, RNA, and proteins) within cells and tissues. Each of these techniques requires that sample cells or tissues undergo preparatory procedures that may include fixing the sample with chemicals such as an aldehyde (such as formaldehyde, glutaraldehyde), formalin substitutes, alcohol (such as ethanol, methanol, isopropanol) or embedding the sample in inert materials such as paraffin, celloidin, agars, polymers, resins, cryogenic media or a variety of plastic embedding media (such as epoxy resins and acrylics). Other sample tissue or cell preparations require physical manipulation such as freezing (frozen tissue section) or aspiration through a fine needle (fine needle aspiration (FNA)).

Subsequently, the sample cells or tissue are embedded in a solid medium, typically paraffin wax, to allow one or more well-preserved, two-dimensional sections to be obtained. Typically, these sections are 3-7 μm thick and placed on a glass microscope slide. The slide is then washed and stained in a specific protocol and prepared for viewing under a microscope or pre-seed for imaging. A trained pathologist then analyzes the stained sample so as to ascertain, for example, tissue morphology and alternations in such morphology as a result of disease, the expression of one or more biomarkers, etc.

Pathologists are increasingly using molecular techniques to aid in characterizing tissue and for the diagnosis of disease. Immunohistochemical (IHC) sample staining can be utilized to identify proteins in cells of a tissue section and hence is widely used in the study of different types of cells, such as cancerous cells and immune cells in biological tissue. Thus, IHC staining may be used in research to understand the distribution and localization of the differentially expressed biomarkers of immune cells (such as T-cells or B-cells) in a cancerous tissue for an immune response study. For example, tumors often contain infiltrates of immune cells, which may prevent the development of tumors or favor the outgrowth of tumors.

In-situ hybridization (ISH) can be used to look for the presence of a genetic abnormality or condition such as amplification of cancer-causing genes specifically in cells that, when viewed under a microscope, morphologically appear to be malignant. In situ hybridization (ISH) employs labeled DNA or RNA probe molecules that are anti-sense to a target gene sequence or transcript to detect or localize targeted nucleic acid target genes within a cell or tissue sample. ISH is performed by exposing a cell or tissue sample immobilized on a glass slide to a labeled nucleic acid probe which is capable of specifically hybridizing to a given target gene in the cell or tissue sample. Several target genes can be simultaneously analyzed by exposing a cell or tissue sample to a plurality of nucleic acid probes that have been labeled with a plurality of different nucleic acid tags. By utilizing labels having different emission wavelengths, simultaneous multicolored analysis may be performed in a single step on a single target cell or tissue sample.

Analysis of histology and cytology samples, and hence recognizing disease, is a manual process which requires spatial pattern recognition. For example, a pathologist must recognize patterns and evaluate cellular details in any histopathology or cytology sample. By way of these visual cues, the pathologist may ascertain diagnostic information from the sample, e.g. evaluate a sample for evidence of cancer and/or and characterize its severity. It is believed that the cause of various problems in pathology may be attributed to the nature of the manual examination of stained specimens. Additionally, it is believed that sample quality and sample preparation may affect the ability of the pathologist to accurately evaluate a sample. Likewise, IHC and ISH staining rely on the skill of the operator and the experimental conditions and methods to make an accurate diagnosis. To make matters worse, borderline cases and mimickers of disease are problematic, thus further contributing to potential problems when evaluating a sample. Regardless of the tissue or cell sample or its method of preparation or preservation, the goal of the technologist and pathologist is to obtain accurate, readable, and reproducible results that permit the accurate interpretation of the data.

### BRIEF SUMMARY OF THE DISCLOSURE

A robust means of automatically detecting disease and its spatial patterns is highly desirable. As noted above, clinical pathology techniques employ histological or cytological staining to reveal morphological patterns in biomedical samples. Often, separate tissue sections are obtained for each biomarker of interest, which is costly and time consuming. It is believed that vibrational spectroscopic imaging, on the other hand, can provide information on a plurality of biomarkers from a single section of tissue.

The present disclosure describes systems and methods for estimating the expression of one or more biomarkers (e.g. percent positivity, staining intensity) in a sample derived from a biological specimen. In some embodiments, the present disclosure provides systems and methods that allow for entirely label-free molecular analysis of biomarkers in the biological specimen. In some embodiments, the estimation of the expression of one or more biomarkers in a sample is based on an identification of biomarker expression features present in vibrational spectral data acquired from the biological specimen. In some embodiments, the biomarker expression features present within the vibrational spectral data acquired from the biological specimen are identified using a trained biomarker expression estimation engine; and the estimated expression of one or more biomarkers (such as percent positivity; staining intensity) may be computed based on those identified biomarker expression features. As such, the systems and methods of the present disclosure may enable “label-less” diagnostics (such as the prediction of the expression of one or more biomarkers in a biological specimen without the need for staining in an IHC or ISH assay). It is to be understood that while the presently disclosed systems and methods can be used alone to provide “label-less” diagnostics, they can also be used in combination with or in conjunction with one or more IHC and/or ISH assays, for example, on the same or serial sections of a formalin-fixed, paraffin-embedded tissue (FFPET) sample, to provide further analysis of a sample.

In some embodiments, the biological specimen is unstained. In these embodiments, the systems and methods of the present disclosure enable biomarker expression estimation in an unstained sample, such as for samples whose duration of fixation is unknown or whose unmasking status is unknown. In other embodiments, the biological specimen is stained for the presence of one or more biomarkers, e.g. 1 biomarker, 2 biomarkers, 3 biomarkers, or 4 or more biomarkers.

The present disclosure also describes systems and methods for training a biomarker expression estimation engine to enable a label-free, quantitative estimation of the expression of one or biomarkers in a biological specimen based on ground truth data, e.g. training vibrational spectral data including one or more class labels. In some embodiments, the training vibrational spectral data includes differentially prepared biological specimens, e.g. biological specimens which have been differentially fixed and/or differentially unmasked. In this way, the biomarker expression estimation engine may be trained to estimate the expression of one or more biomarkers in biological specimens that have been prepared (e.g. fixed and/or unmasked) to different degrees (e.g. variably fixed samples; variably unmasked samples). As described herein, sample preparation may have an impact on biomarker expression and the systems and methods described herein for estimating biomarker expression take this variability into consideration. These and other embodiments are described in more detail herein.

A aspect of the present disclosure is a system for predicting an expression of one or more biomarkers in an test biological specimen the system comprising: (i) one or more processors, and (ii) one or more memories coupled to the one or more processors, the one or more memories to store computer-executable instructions that, when executed by the one or more processors, cause the system to perform operations comprising: obtaining test spectral data from the test biological specimen, wherein the obtained test spectral data includes vibrational spectral data derived from at least a portion of the biological specimen; deriving biomarker expression features from the obtained test spectral data using a trained biomarker expression estimation engine; and predicting the expression of the one or more biomarkers of the test biological specimen based on the derived biomarker expression features. In some embodiments, the test biological specimen is unstained. In some embodiments, the test biological specimen is stained for the presence of one or more biomarkers.

In some embodiments, the predicted biomarker expression includes one of a predicted percent positivity or a predicted staining intensity. In some embodiments, the predicted biomarker expression includes both a predicted percent positivity and a predicted staining intensity. In some embodiments, a fixation status (e.g. fixation quality, fixation duration) of the test biological specimen is unknown. In some embodiments, an unmasking status (e.g. unmasking quality) is unknown.

In some embodiments, the biomarker expression estimation engine is trained using one or more training spectral data sets, wherein each training spectral data set includes a plurality of training vibrational spectra derived from a plurality of training tissue samples where each of the training tissue samples is stained for the presence of one or more biomarkers, and wherein each training vibrational spectrum includes one or more class labels. In some embodiments, the one or more class labels comprise known biomarker expression levels for one or more biomarkers. In some embodiments, the known biomarker expression levels comprise at least one of known percent positivity for one or more biomarkers and known staining intensities for one or more biomarkers. In some embodiments, the system further includes one or more additional class labels selected from the group consisting of a known unmasking duration, a known unmasking temperature, a qualitative assessment of an unmasking state, a known fixation duration, and a qualitative assessment of a fixation state.

In some embodiments, the training spectral data sets are derived by: (i) obtaining a training biological specimen; (ii) dividing the obtained training biological specimen into a plurality of training tissue samples; (iii) staining each of the plurality of training tissue samples for the presence of one or more biomarkers; and (iv) quantitatively assessing an expression of the one or more biomarkers. In some embodiments, each training tissue sample is differentially prepared prior to staining. In some embodiments, each training tissue sample of the plurality of training tissue samples is differentially unmasked, differentially fixed, or both differentially unmasked and differentially fixed. In some embodiments, the quantitative assessment of the one or more biomarkers in the training tissue samples includes determining a staining intensity of the one or more biomarkers. In some embodiments, the quantitative assessment of the one or more biomarkers in the training tissue samples includes determining a percent positivity of the one or more biomarkers. In some embodiments, the quantitative assessment is performed by a pathologist. In some embodiments, the quantitative assessment is performed using one or more image analysis algorithms. In some embodiments, the plurality of training tissue samples are stained in an immunohistochemistry assay. In some embodiments, the plurality of training tissue samples are stained in an in situ hybridization assay. In some embodiments, the plurality of training tissue samples are stained in a multiplex assay.

In some embodiments, the test spectral data includes an averaged vibrational spectrum derived from a plurality of normalized and corrected vibrational spectra. In some embodiments, the plurality of normalized and corrected vibrational spectra are obtained by: (i) identifying a plurality of spatial regions within the test biological specimen; (ii) acquiring a vibrational spectrum from each individual region of the plurality of identified regions; (iii) correcting the acquired vibrational spectrum from each individual region to provide a corrected vibrational spectrum for each individual region; and (iv) amplitude normalizing the corrected vibrational spectrum from each individual region to a pre-determined global maximum to provide an amplitude normalized vibrational spectrum for each region. In some embodiments, the acquired vibrational spectrum from each individual region is corrected by: (i) compensating each acquired vibrational spectrum for atmospheric effects to provide an atmospheric corrected vibrational spectrum; and (ii) compensating the atmospheric corrected vibrational spectrum for scattering.

In some embodiments, the trained biomarker expression estimation engine includes a machine learning algorithm based on dimensionality reduction. In some embodiments, the dimensionality reduction includes a projection onto latent structure regression model. In some embodiments, the dimensionality reduction includes a principal component analysis plus discriminant analysis. In some embodiments, the trained biomarker expression estimation engine includes a neural network.

In some embodiments, the system further includes operations for correcting the predicated expression of the one or more biomarkers for poor unmasking and/or poor fixation of the test biological specimen. For example, the predicted expression of one or more biomarkers in a test biological specimen obtained through the use of a trained biomarker expression estimation engine may be corrected by: (i) obtaining a biomarker fixation sensitivity curve; (ii) estimating an actual fixation time of a test biological sample; and (iii) correcting the obtained predicted biomarker expression level for the test biological specimen to a fixation compensated expression level using the obtained fixation sensitivity curve.

In some embodiments, the system further includes operations for comparing an actual biomarker expression of the test biological specimen with the predicted expression of the one or more biomarkers of the test biological specimen. In some embodiments, the obtained test spectral data comprises vibrational spectral information for at least an amide I band. In some embodiments, the obtained test spectral data comprises vibrational spectral information for wavelengths ranging from between about 3200 to about 3400 cm⁻¹. In some embodiments, the obtained test spectral data comprises vibrational spectral information for wavelengths ranging from between about 2800 to about 2900 cm⁻¹. In some embodiments, the obtained test spectral data comprises vibrational spectral information for wavelengths ranging from between about 1020 to about 1100 cm⁻¹. In some embodiments, the obtained test spectral data comprises vibrational spectral information for wavelengths ranging from between about 1520 to about 1580 cm⁻¹.

A second aspect of the present disclosure is a non-transitory computer-readable medium storing instructions for predicting an expression of one or more biomarkers in an test biological specimen treated, comprising: obtaining test spectral data from the test biological specimen, wherein the test spectral data includes vibrational spectral data derived from at least a portion of the biological specimen; deriving biomarker expression features from the obtained test spectral data using a trained biomarker expression estimation engine, wherein the biomarker expression estimation engine is trained using training spectral data sets acquired from a plurality of differentially prepared training biological specimens and wherein the training spectral data sets comprise class labels of known biomarker expression for one or more biomarkers; predicting the expression of one more biomarkers in the test biological specimen based on the derived biomarker expression features. In some embodiments, the test biological specimen has an unknown fixation status and/or unknown unmasking status. In some embodiments, the predicted expression of the one or more biomarkers includes one of a predicted percent positivity or a predicted staining intensity. In some embodiments, the predicted expression of the one or more biomarkers includes both a predicted percent positivity and a predicted staining intensity. In some embodiments, the predicted expression of the one or more biomarkers is quantitative. In some embodiments, the test biological specimen is unstained. In some embodiments, the test biological specimen is stained for the presence of one or more biomarkers.

In some embodiments, each training spectral data set is derived by: (i) obtaining a training biological specimen; (ii) dividing the obtained training biological specimen into a plurality of training tissue samples; and (iii) preparing each training tissue sample of the plurality of training tissue samples under different preparation conditions; (iv) staining each of the plurality of training tissue samples for the presence of one or more biomarkers; and (v) quantitatively assessing an expression of the one or more biomarkers. In some embodiments, the different preparation conditions comprise different unmasking conditions. In some embodiments, the different preparation conditions comprise different fixation durations. In some embodiments, the training biological specimens comprise the same tissue type as the test biological specimen. In some embodiments, the training biological specimens comprise a different tissue type than the test biological specimen.

In some embodiments, the obtained test spectral data comprises vibrational spectral information for at least an amide I band. In some embodiments, the obtained test spectral data comprises vibrational spectral information for wavelengths ranging from between about 3200 to about 3400 cm⁻¹. In some embodiments, the obtained test spectral data comprises vibrational spectral information for wavelengths ranging from between about 2800 to about 2900 cm⁻¹. In some embodiments, the obtained test spectral data comprises vibrational spectral information for wavelengths ranging from between about 1020 to about 1100 cm⁻¹. In some embodiments, the obtained test spectral data comprises vibrational spectral information for wavelengths ranging from between about 1520 to about 1580 cm⁻¹.

A third aspect of the present disclosure is a method for predicting an expression of one or more biomarkers in a test biological specimen comprising: obtaining test spectral data from the test biological specimen, wherein the test spectral data includes vibrational spectral data derived from at least a portion of the biological specimen; deriving biomarker expression features from the obtained test spectral data using a trained biomarker expression estimation engine, wherein the biomarker expression estimation engine is trained using training spectral data sets acquired from a plurality of differentially prepared training biological specimens and wherein the training spectral data sets comprise class labels of known biomarker expression for one or more biomarkers; and predicting the expression of the one more biomarkers in the test biological specimen based on the derived biomarker expression features.

In some embodiments, the predicted biomarker expression includes one of a predicted percent positivity or a predicted staining intensity. In some embodiments, the predicted biomarker expression includes both a predicted percent positivity and a predicted staining intensity. In some embodiments, the one or more biomarkers include at least one cancer biomarker. In some embodiments, the test biological specimen has an unknown fixation status and/or unknown unmasking status. In some embodiments, the test biological specimen is unstained. In some embodiments, the test biological specimen is stained for the presence of one or more biomarkers.

In some embodiments, each training spectral data set is derived by: (i) obtaining a training biological specimen; (ii) dividing the obtained training biological specimen into a plurality of training tissue samples; and (iii) preparing each training tissue sample of the plurality of training tissue samples under different preparation conditions. In some embodiments, the method further includes staining each of the plurality of training tissue samples for the presence of one or more biomarkers; and quantitatively assessing known percent positivity and/or known staining intensity for the one or more biomarkers.

In some embodiments, trained biomarker expression estimation engine includes a machine learning algorithm based on dimensionality reduction. In some embodiments, the dimensionality reduction includes a projection onto latent structure regression model. In some embodiments, the trained biomarker expression estimation engine includes a neural network. In some embodiments, the method further includes compensating the predicated expression of the one or more biomarkers for poor unmasking and/or poor fixation of the test biological specimen. For example, the predicted expression of one or more biomarkers in a test biological specimen obtained through the use of a trained biomarker expression estimation engine may be corrected by: (i) obtaining a biomarker fixation sensitivity curve; (ii) estimating an actual fixation time of a test biological sample; and (iii) correcting the obtained predicted biomarker expression level for the test biological specimen to a fixation compensated expression level using the obtained fixation sensitivity curve.

In some embodiments, the obtained test spectral data comprises vibrational spectral information for at least an amide I band. In some embodiments, the obtained test spectral data comprises vibrational spectral information for wavelengths ranging from between about 3200 to about 3400 cm⁻¹. In some embodiments, the obtained test spectral data comprises vibrational spectral information for wavelengths ranging from between about 2800 to about 2900 cm⁻¹. In some embodiments, the obtained test spectral data comprises vibrational spectral information for wavelengths ranging from between about 1020 to about 1100 cm⁻¹. In some embodiments, the obtained test spectral data comprises vibrational spectral information for wavelengths ranging from between about 1520 to about 1580 cm⁻¹.

### BRIEF DESCRIPTION OF THE FIGURES

For a general understanding of the features of the disclosure, reference is made to the drawings. In the drawings, like reference numerals have been used throughout to identify identical elements.

FIG. 1 illustrates a representative digital pathology system including an image acquisition device and a computer system in accordance with one embodiment of the present disclosure.

FIG. 2 sets forth various modules that can be utilized in a system or within a digital pathology workflow to quantitatively or qualitatively predict an unmasking status of a test biological sample in accordance with one embodiment of the present disclosure.

FIG. 3 sets forth a flowchart illustrating the various steps of estimating the expression of one or more biomarkers within an unstained test biological specimen using a trained biomarker expression estimation engine in accordance with one embodiment of the present disclosure.

FIG. 4A illustrates the process of obtaining a plurality of training tissue samples, e.g. training samples 1, 2, 3, 4, 5, and 6 for differential preparation (e.g. for differential fixation and/or differential masking) from two different training biological specimens in accordance with one embodiment of the present disclosure. In some embodiments, training tissue samples 1, 2, and 3 may belong to a first set of training tissue samples from which a first training spectral data set may be acquired; while training tissue samples 4, 5, and 6 may belong to a second set of training tissue samples from which a second training data set may be acquired.

FIG. 4B illustrates the differential preparation of a plurality of training tissue samples obtained from two different training biological specimens in accordance with one embodiment of the present disclosure, and further illustrates the preparation of two different training spectral data sets.

FIG. 5A illustrates the preparation of a plurality of training tissue samples in accordance with one embodiment of the present disclosure.

FIG. 5B illustrates the preparation of a plurality of training tissue samples in accordance with one embodiment of the present disclosure.

FIG. 5C illustrates the preparation of a plurality of training tissue samples in accordance with one embodiment of the present disclosure.

FIG. 5D illustrates the preparation of a plurality of training tissue samples in accordance with one embodiment of the present disclosure.

FIG. 5E illustrates the preparation of a plurality of training tissue samples in accordance with one embodiment of the present disclosure.

FIG. 6 sets forth a flowchart illustrating the various steps of acquiring vibrational spectra for a training biological specimen in accordance with one embodiment of the present disclosure.

FIG. 7 sets forth a flowchart illustrating the various steps of acquiring an averaged vibrational spectrum for a test biological specimen in accordance with one embodiment of the present disclosure.

FIG. 8 sets forth a flowchart illustrating the various steps correcting, normalizing, and averaging acquired spectra derived from a biological specimen, including test biological specimens and training biological specimens, in accordance with one embodiments of the present disclosure.

FIGS. 9A, 9B, and 9C set forth a quantitative analysis of IHC expression (percent positivity) of BCL2 (FIG. 9A), ki-67 (FIG. 9B), and FOXP3 (FIG. 9C).

FIG. 9D illustrates a plot of IHC expression for all three biomarkers versus fixation time in which the mean expression is plotted on a normalized scale so relative changes in each biomarker versus fixation time can be observed. Bars represent significant levels of p<0.05 as determined by a double-sided ranksum test.

FIG. 10 provides an example of tonsil tissues labeled with antisera raised against Ki-67. Image analysis was conducted only on tonsil tissue (circled portion in left image). Connective tissue that sometimes showed high background but was not present in other sections was excluded.

FIG. 11 provides a visible image of example tissue section having multiple regions identified. The figure further provides an example of a collected, averaged, processed, and normalized vibrational spectrum from the indicated region in visible image.

FIG. 12A provides mid-IR absorption spectra, specifically illustrating a protein band of within the acquired mid-IR spectra.

FIG. 12B sets forth the peak location of the Amide I band's first derivative versus the band's FWHM, which elucidates that un-retrieved spectra have a significantly different spectra than the other retrieved tissues.

FIG. 13 sets forth an example of training a biomarker expression estimation engine, and specifically a PLSR machine learning algorithm. Initially, the model is trained with input vibrational spectra with a known classification, and a model is developed which assigns a weight to each wavelength corresponding roughly to how correlated (or anticorrelated) each wavelength is to the response (e.g. unmasking time). Finally, the model is applied to the vibrational spectral data it was trained on to assess how accurately it predicts unmasking time.

FIG. 14 illustrates typical FR-IR and Raman spectra for collagen.

FIG. 15 illustrates a biomarker expression estimation engine based on a PLSR model where the trained biomarker expression estimation engine (trained using acquired mid-IR spectra) can predict C4d staining. Predictive accuracy amongst blinded spectra was 0.4% of cells positive for C4d.

FIG. 16 illustrates a biomarker expression estimation engine based on a PLSR model where the trained biomarker expression estimation engine (trained using acquired mid-IR spectra) can predict Ki-67 staining. Predictive accuracy amongst blinded spectra was 0.8% of cells positive for Ki-67.

FIG. 17 provides a photograph of four tissues imaged with mid-IR in the time-temperature course. The biomarker expression estimation engine was trained on the tissues provided in the circled area which includes three tissue specimens (right side of figure and along bottom of figure); and the predictive power of the biomarker expression estimation engine was evaluated with the tissue within the “smaller” circled area that includes only one tissue specimen (left side of figure).

FIG. 18 illustrates prediction accuracy of the trained biomarker expression estimation engine across all times and temperatures in a blinded tonsil sample. Across all tested times and temperatures, the trained biomarker expression estimation engine was able to predict functional C4d stain intensity to better than about 10%. Values at the intersection of time and temperature indicate the percent error between the predicted and actual C4d stain intensity.

FIG. 19 provides a table setting forth the infrared and Raman characteristic frequencies of biological samples.

FIG. 20 sets forth a quantitative analysis of IHC expression (staining intensity) of BCL2.

FIG. 21 sets forth a quantitative analysis of IHC expression (staining intensity) of FOXP3.

FIG. 22 sets forth a quantitative analysis of IHC expression (staining intensity) of ki-67.

FIG. 23A illustrates estimated DAB staining versus predicted DAB staining for the BCL2 biomarker for a fixation experiment. In particular, FIG. 23A provides a and whisker plot of BCL2 concentration, exclusively in BCL2 positive cells, for tissue samples fixed in room temperature NBF for various amounts of time ranging from 0 hours (e.g. insufficiently/poorly fixed) to 24 hours (e.g. fully/properly fixed). Experimental protein concentrations were determined by analyzing brightfield images with an image analysis algorithm. Predicted concentrations represent the estimated BCL2 concentrations as predicted from the trained biomarker expression estimation engine trained with a PLSR-based algorithm. Boxes on the left (“Training”) represent BCL2 predictions made from a training set of MID-IR spectra; and boxes on the right (“Holdout”) represent BCL2 predictions made on blinded spectra the model had never “seen” before, e.g. validation spectra. Results indicate that the PLSR prediction model can accurately predict BCL2 concentration of differentially fixed tissues (unfixed through fully fixed).

FIG. 23B plots the cumulative distribution function for estimated and predicted DAB staining for the BLC2 biomarker displayed in FIG. 23A. The horizontal axis is the absolute value of the model's error which was defined to be the difference between the actual protein concentration from analyzing brightfield images and the MID-IR predicted protein concentrations calculated using MID-IR spectra from the tissue and the PLSR-based prediction engine. The model's prediction error for the training set (“Training”) is similar as that for the predicted/validation data, indicates a well-trained model that is not over fitting to noise in the MID-IR spectra.

FIG. 24A provides a box and whisker plot of FOXP3 concentration, exclusively in FOXP3 positive cells, for tissue samples fixed in in room temperature NBF for various amounts of time ranging from 0 hours (e.g. insufficiently/poorly fixed) to 24 hours (e.g. fully/properly fixed). Experimental protein concentrations were determined by analyzing brightfield images with image analysis program. Predicted concentrations represent the estimated FOXP3 concentrations as predicted from the trained biomarker expression estimation engine trained with a PLSR-based algorithm. Boxes on the left (“dotted boxes”) represent FOXP3 predictions made from the training set MID-IR spectra and boxes on the right (“boxes with diagonal lines”) represent FOXP3 predictions made on blinded spectra the model had never seen before, e.g. validation spectra. Results indict the PLSR prediction model can accurately predict FOXP3 concentration of differentially fixed tissues (unfixed through fully fixed).

FIG. 24B plots the cumulative distribution function for estimated and predicted DAB staining for the FOXP3 biomarker displayed in FIG. 24A. The horizontal axis is the absolute value of the model's error which was defined to be the difference between the actual protein concentration from analyzing brightfield images and the MID-IR predicted protein concentrations calculated using MID-IR spectra from the tissue and the PLSR-based prediction engine The model's prediction error for the training set (solid line) is similar as that for the predicted/validation data, indicates a well-trained model that is not over fitting to noise in the MID-IR spectra.

FIG. 25A provides a box and whisker plot of ki-67 concentration, exclusively in ki-67 positive cells, for tissue samples fixed in room temperature NBF for various amounts of time ranging from 0 hours (e.g. insufficiently/poorly fixed) to 24 hours (e.g. fully/properly fixed). Experimental protein concentrations were determined by analyzing brightfield images with image analysis program. Predicted concentrations represent the estimated ki-67 concentrations as predicted from the trained biomarker expression estimation engine trained with a PLSR-based algorithm. Boxes on the left (“dotted boxes”) represent ki-67 predictions made from the training set MID-IR spectra and boxes on the right (“boxes with diagonal lines”) represent ki-67 predictions made on blinded spectra the model had never seen before, e.g. validation spectra. Results indict the PLSR prediction model can accurately predict ki-67 concentration of differentially fixed tissues (unfixed through fully fixed).

FIG. 25B plots the cumulative distribution function for estimated and predicted DAB staining for the ki-67 biomarker displayed in FIG. 25A. The horizontal axis is the absolute value of the model's error which was defined to be the difference between the actual protein concentration from analyzing brightfield images and the MID-IR predicted protein concentrations calculated using MID-IR spectra from the tissue and the PLSR-based prediction engine The model's prediction error for the training set (solid line) is similar as that for the predicted/validation data, indicates a well-trained model that is not over fitting to noise in the MID-IR spectra.

FIG. 26A provides a box and whisker plot of percent of the tissue positive for FOXP3 for tissue samples fixed in room temperature NBF for various amounts of time ranging from 0 hours (e.g. insufficiently/poorly fixed) to 24 hours (e.g. fully/properly fixed). Experimental protein concentrations were determined by analyzing brightfield images with image analysis program. Predicted concentrations represent the estimated FOXP3 concentrations as predicted from the trained biomarker expression estimation engine trained with a PLSR-based algorithm. Boxes on the left (“dotted boxes”) represent FOXP3 predictions made from the training set MID-IR spectra and boxes on the right (“boxes with diagonal lines”) represent FOXP3 predictions made on blinded spectra the model had never seen before, e.g. validation spectra. Results indict the PLSR prediction model can accurately predict FOXP3 concentration of differentially fixed tissues (unfixed through fully fixed).

FIG. 26B plots the cumulative distribution function for estimated and predicted percent of the tissue positive for the FOXP3 biomarker displayed in FIG. 26A. The horizontal axis is the absolute value of the model's error which was defined to be the difference between the actual protein concentration from analyzing brightfield images and the MID-IR predicted protein concentrations calculated using MID-IR spectra from the tissue and the PLSR-based prediction engine The model's prediction error for the training set (solid line) is similar as that for the predicted/validation data, indicates a well-trained model that is not over fitting to noise in the MID-IR spectra.

FIG. 27A provides a box and whisker plot of percent of the tissue positive for BCL2 for tissue samples fixed in room temperature NBF for various amounts of time ranging from 0 hours (e.g. insufficiently/poorly fixed) to 24 hours (e.g. fully/properly fixed). Experimental protein concentrations were determined by analyzing brightfield images with image analysis program. Predicted concentrations represent the estimated BCL2 concentrations as predicted from the trained biomarker expression estimation engine trained with a PLSR-based algorithm. Boxes on the left (“dotted boxes”) represent BCL2 predictions made from the training set MID-IR spectra and boxes on the right (“boxes having diagonal lines”) represent BCL2 predictions made on blinded spectra the model had never seen before, e.g. validation spectra. Results indict the PLSR prediction model can accurately predict BCL2 concentration of differentially fixed tissues (unfixed through fully fixed).

FIG. 27B plots the cumulative distribution function for estimated and predicted percent of the tissue positive for the BCL2 biomarker displayed in FIG. 27A. The horizontal axis is the absolute value of the model's error which was defined to be the difference between the actual protein concentration from analyzing brightfield images and the MID-IR predicted protein concentrations calculated using MID-IR spectra from the tissue and the PLSR-based prediction engine The model's prediction error for the training set (solid line) is similar as that for the predicted/validation data, indicates a well-trained model that is not over fitting to noise in the MID-IR spectra.

FIG. 28A Box and whisker plot of percent of the tissue positive for ki-67 for tissue samples fixed in room temperature NBF for various amounts of time ranging from 0 hours (e.g. insufficiently/poorly fixed) to 24 hours (e.g. fully/properly fixed). Experimental protein concentrations were determined by analyzing brightfield images with image analysis program. Predicted concentrations represent the estimated ki-67 concentrations as predicted from the trained prediction engine trained with a PLSR-based algorithm. Boxes on the left (“dotted boxes”) represent ki-67 predictions made from the training set MID-IR spectra and boxes on the right (“boxes having diagonal lines”) represent ki-67 predictions made on blinded spectra the model had never seen before, e.g. validation spectra. Results indict the PLSR prediction model can accurately predict ki-67 concentration of differentially fixed tissues (unfixed through fully fixed).

FIG. 28B plots the cumulative distribution function for estimated and predicted percent of the tissue positive for the ki-67 biomarker displayed in FIG. 25A. Horizontal axis is the absolute value of the model's error which was defined to be the difference between the actual protein concentration from analyzing brightfield images and the MID-IR predicted protein concentrations calculated using MID-IR spectra from the tissue and the PLSR-based prediction engine The model's prediction error for the training set (solid line) is similar as that for the predicted/validation data, indicates a well-trained model that is not over fitting to noise in the MID-IR spectra.

FIG. 29A provides C4d staining results for tissue samples retrieved for 30 minutes a temperature of either 9.6° C., 110° C., 120° C., 130° C., or 140° C. The left graph demonstrates that training with blinded spectra can facilitate the prediction of C4d percent positivity of all tissues regardless of antigen retrieval temperature and despite the inflection point at 120° C. using a trained biomarker expression estimation engine based on PLSR. The right graph demonstrates that both stain intensity (top, curve, diamonds) and percent positivity (bottom, curve, squares) increase with retrieval temperature until 130° C., whereas the amount of detected C4d decreases, from DAB image analysis algorithm.

FIG. 29B provides Ki-67 staining results for tissue samples retrieved for 60 minutes at a temperature of either 25° C., 70° C., 80° C., 90° C., 100° C., 105° C., or 110° C. The left graph demonstrates that both stain intensity (diamonds) and percent positivity (squares) increase with retrieval temperature, but then saturate near 100° C. based on data from a DAB image analysis algorithm. The right graph demonstrate that MID-IR spectra can be used to determine ki-67 percent positivity staining of all tissues regardless of antigen retrieval temperature and despite the saturation at higher retrieval temperature using a trained biomarker expression estimation engine based on PCDA.

FIG. 30A sets forth a flow chart illustrating the steps of correcting an obtained predicted biomarker expression level in accordance with one embodiment of the present disclosure.

FIG. 30B sets forth a flow chart illustrating the steps of correcting an obtained predicted biomarker expression level in accordance with one embodiment of the present disclosure.

### DETAILED DESCRIPTION

It should also be understood that, unless clearly indicated to the contrary, in any methods claimed herein that include more than one step or act, the order of the steps or acts of the method is not necessarily limited to the order in which the steps or acts of the method are recited.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the singular terms “a,” “an,” and “the” include plural referents unless context clearly indicates otherwise. Similarly, the word “or” is intended to include “and” unless the context clearly indicates otherwise. The term “includes” is defined inclusively, such that “includes A or B” means including A, B, or A and B.

As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (e.g. “one or the other but not both”) when preceded by terms of exclusivity, such as “either,” “one of,” “only one of” or “exactly one of.” “Consisting essentially of,” when used in the claims, shall have its ordinary meaning as used in the field of patent law.

The terms “comprising,” “including,” “having,” and the like are used interchangeably and have the same meaning. Similarly, “comprises,” “includes,” “has,” and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b, and c. Similarly, the phrase: “a method involving steps a, b, and c” means that the method includes at least steps a, b, and c. Moreover, while the steps and processes may be outlined herein in a particular order, the skilled artisan will recognize that the ordering steps and processes may vary.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “antigen” refers to a substance to which an antibody, an antibody analog (e.g. an aptamer), or antibody fragment binds. Antigens may be endogenous whereby they are generated within the cell as a result of normal or abnormal cell metabolism, or because of viral or intracellular bacterial infections. Endogenous antigens include xenogenic (heterologous), autologous and idiotypic or allogenic (homologous) antigens. Antigens may also be tumor-specific antigens or presented by tumor cells. In this case, they are called tumor-specific antigens (TSAs) and, in general, result from a tumor-specific mutation. Antigens may also be tumor-associated antigens (TAAs), which are presented by tumor cells and normal cells. Antigen also includes CD antigens, which refers any of a number of cell-surface markers expressed by leukocytes and can be used to distinguish cell lineages or developmental stages. Such markers can be identified by specific monoclonal antibodies and are numbered by their cluster of differentiation.

As used herein, the term “biological specimen,” “sample,” or “tissue sample” refers to any sample including a biomolecule (such as a protein, a peptide, a nucleic acid, a lipid, a carbohydrate, or a combination thereof) that is obtained from any organism including viruses. Other examples of organisms include mammals (such as humans; veterinary animals like cats, dogs, horses, cattle, and swine; and laboratory animals like mice, rats, and primates), insects, annelids, arachnids, marsupials, reptiles, amphibians, bacteria, and fungi. Biological specimens include tissue samples (such as tissue sections and needle biopsies of tissue), cell samples (such as cytological smears such as Pap smears or blood smears or samples of cells obtained by microdissection), or cell fractions, fragments or organelles (such as obtained by lysing cells and separating their components by centrifugation or otherwise). Other examples of biological specimens include blood, serum, urine, semen, fecal matter, cerebrospinal fluid, interstitial fluid, mucous, tears, sweat, pus, biopsied tissue (for example, obtained by a surgical biopsy or a needle biopsy), nipple aspirates, cerumen, milk, vaginal fluid, saliva, swabs (such as buccal swabs), or any material containing biomolecules that is derived from a first biological specimen. In certain embodiments, the term “biological specimen” as used herein refers to a sample (such as a homogenized or liquefied sample) prepared from a tumor or a portion thereof obtained from a subject.

As used herein, the terms “biomarker” or “marker” refer to a measurable indicator of some biological state or condition. In particular, a biomarker may be a nucleic acid, a lipid, a carbohydrate, or a protein or peptide, e.g. a surface protein, that can be specifically stained, and which is indicative of a biological feature of the cell, e.g. the cell type or the physiological state of the cell. A biomarker may be used to determine how well the body responds to a treatment for a disease or condition or if the subject is predisposed to a disease or condition. An immune cell marker is a biomarker that is selectively indicative of a feature that relates to an immune response of a mammal. In the context of cancer, a biomarker refers to a biological substance that is indicative of the presence of cancer in the body. A biomarker may be a molecule secreted by a tumor or a specific response of the body to the presence of cancer. Genetic, epigenetic, proteomic, glycomic, and imaging biomarkers can be used for cancer diagnosis, prognosis, and epidemiology. Such biomarkers can be assayed in non-invasively collected biofluids like blood or serum. Several gene and protein based biomarkers have already been used in patient care including but, not limited to, AFP (Liver Cancer), BCR-ABL (Chronic Myeloid Leukemia), BRCA1/BRCA2 (Breast/Ovarian Cancer), BRAF V600E (Melanoma/Colorectal Cancer), CA-125 (Ovarian Cancer), CA19.9 (Pancreatic Cancer), CEA (Colorectal Cancer), EGFR (Non-small-cell lung carcinoma), HER-2 (Breast Cancer), KIT (Gastrointestinal stromal tumor), PSA (Prostate Specific Antigen), S100 (Melanoma), and many others. Biomarkers may be useful as diagnostics (to identify early stage cancers) and/or prognostics (to forecast how aggressive a cancer is and/or predict how a subject will respond to a particular treatment and/or how likely a cancer is to recur).

As used herein, the term “cytological sample” refers to a cellular sample in which the cells of the sample have been partially or completely disaggregated, such that the sample no longer reflects the spatial relationship of the cells as they existed in the subject from which the cellular sample was obtained. Examples of cytological samples include tissue scrapings (such as a cervical scraping), fine needle aspirates, samples obtained by lavage of a subject, et cetera.

As used herein, the term “immunohistochemistry” refers to a method of determining the presence or distribution of an antigen in a sample by detecting interaction of the antigen with a specific binding agent, such as an antibody. A sample is contacted with an antibody under conditions permitting antibody-antigen binding. Antibody-antigen binding can be detected by means of a detectable label conjugated to the antibody (direct detection) or by means of a detectable label conjugated to a secondary antibody, which binds specifically to the primary antibody (indirect detection). In some instances, indirect detection can include tertiary or higher antibodies that serve to further enhance the detectability of the antigen. Examples of detectable labels include enzymes, fluorophores and haptens, which in the case of enzymes, can be employed along with chromogenic or fluorogenic substrates.

As used herein, the term “percent positivity” refers to the number of positively stained cells divided by the number of positively stained cells combined with the number of negatively stained cells.

As used herein, the term “slide” refers to any substrate (e.g., substrates made, in whole or in part, glass, quartz, plastic, silicon, etc.) of any suitable dimensions on which a biological specimen is placed for analysis, and more particularly to a “microscope slide” such as a standard 3 inch by 1 inch microscope slide or a standard 75 mm by 25 mm microscope slide. Examples of biological specimens that can be placed on a slide include, without limitation, a cytological smear, a thin tissue section (such as from a biopsy), and an array of biological specimens, for example a tissue array, a cellular array, a DNA array, an RNA array, a protein array, or any combination thereof. Thus, in one embodiment, tissue sections, DNA samples, RNA samples, and/or proteins are placed on a slide at particular locations. In some embodiments, the term slide may refer to SELDI and MALDI chips, and silicon wafers.

As used herein the term “specific binding entity” refers to a member of a specific-binding pair. Specific binding pairs are pairs of molecules that are characterized in that they bind each other to the substantial exclusion of binding to other molecules (for example, specific binding pairs can have a binding constant that is at least 10³ M⁻¹ greater, 10⁴ M⁻¹ greater or 10⁵ M⁻¹ greater than a binding constant for either of the two members of the binding pair with other molecules in a biological sample). Particular examples of specific binding moieties include specific binding proteins (for example, antibodies, lectins, avidins such as streptavidins, and protein A). Specific binding moieties can also include the molecules (or portions thereof) that are specifically bound by such specific binding proteins.

As used herein, the term “spectra data” encompasses raw image spectral data acquired from a biological specimen or any portion thereof, such as with a spectrometer.

As used herein, the term “spectrum” refers to information (absorption, transmission, reflection) obtained “at” or within a certain wavelength or wavenumber range of electromagnetic radiation. A wavenumber range can be as large as 4000 cm⁻¹ or as narrow as 0.01 cm⁻¹. Note that a measurement at a so-called “single laser wavelength” will typically cover a small spectral range (e.g., the laser linewidth) and will hence be included whenever the term “spectrum” is used throughout this manuscript. A transmission measurement at a fixed wavelength setting of a quantum cascade laser, for example, shall hereby fall under the term spectrum throughout this application.

As used herein, the terms “stain,” “staining,” or the like as used herein generally refers to any treatment of a biological specimen that detects and/or differentiates the presence, location, and/or amount (such as concentration) of a particular molecule (such as a lipid, protein or nucleic acid) or particular structure (such as a normal or malignant cell, cytosol, nucleus, Golgi apparatus, or cytoskeleton) in the biological specimen. For example, staining can provide contrast between a particular molecule or a particular cellular structure and surrounding portions of a biological specimen, and the intensity of the staining can provide a measure of the amount of a particular molecule in the specimen. Staining can be used to aid in the viewing of molecules, cellular structures, and organisms not only with bright-field microscopes, but also with other viewing tools, such as phase contrast microscopes, electron microscopes, and fluorescence microscopes. Some staining performed by the system can be used to visualize an outline of a cell. Other staining performed by the system may rely on certain cell components (such as molecules or structures) being stained without or with relatively little staining other cell components. Examples of types of staining methods performed by the system include, without limitation, histochemical methods, immunohistochemical methods, and other methods based on reactions between molecules (including non-covalent binding interactions), such as hybridization reactions between nucleic acid molecules. Particular staining methods include, but are not limited to, primary staining methods (e.g., H&E staining, Pap staining, etc.), enzyme-linked immunohistochemical methods, and in situ RNA and DNA hybridization methods, such as fluorescence in situ hybridization (FISH).

As used herein, the term “target” refers to any molecule for which the presence, location and/or concentration is or can be determined. Examples of target molecules include proteins, epitopes, nucleic acid sequences, and haptens, such as haptens covalently bonded to proteins. Target molecules are typically detected using one or more conjugates of a specific binding molecule and a detectable label.

As used herein, the term “tissue sample” shall refer to a cellular sample that preserves the cross-sectional spatial relationship between the cells as they existed within the subject from which the sample was obtained. “Tissue sample” shall encompass both primary tissue samples (e.g. cells and tissues produced by the subject) and xenografts (e.g. foreign cellular samples implanted into a subject).

As used herein, the terms “unmask”, or “unmasking” refer to retrieving antigens or targets and/or improving the detection of antigens, amino acids, peptides, proteins, nucleic acids, and/or other targets in fixed tissue. For example, it is believed that antigenic sites that can otherwise go undetected, for example, may be revealed by breaking some of the protein cross-links surrounding the antigen during the unmasking. In some embodiments, antigens and/or other targets are unmasked through the application of one or more unmasking agents (defined below), heat, and/or pressure. In some embodiments, only one or more unmasking agents are applied to the specimen to effectuate unmasking. In other embodiments, only heat is applied to effectuate unmasking. In some embodiments, unmasking may occur only in the presence of water and added heat. Examples of unmasking operations are described in United States Patent Publication No. 2009/01700152, the disclosure of which is hereby incorporated by reference herein in its entirety.

Overview

In some embodiments, the present disclosure is directed to systems and methods which enable “label-less” diagnostics, e.g. the prediction of biomarker expression in the absence of staining a biological specimen, such as in an IHC and/or ISH assay. In some embodiments, the systems and methods disclosed herein utilize a trained biomarker expression estimation engine to evaluate vibrational spectral data acquired from a biological specimen and, based on the evaluation of the vibrational spectral data, provide as an output an estimate of the expression of one or more biomarkers.

In some embodiments, the output of the disclosed systems and methods is a quantitative estimate of the staining intensity of one or more biomarkers, or a quantitative estimate of percent positivity of one or more biomarkers. In some embodiments, the quantitative estimate of the staining intensity and/or the percent positivity of one or more biomarkers may be provided for biological specimens that have been prepared according to unknown conditions, e.g. the fixation duration and/or the unmasking status of the biological specimen is unknown.

Overall, Applicant submits that the disclosed systems and methods enable quick and accurate prediction of the expression of one or more biomarkers in an unstained biological specimen through the use of machine learning algorithms, ultimately facilitating improved IHC and/or ISH assay results and patient care. The systems and methods also are believed to save time and expense since, in some embodiments, no staining assays are required. At the same time, and again in some embodiments, the evaluation of the expression of one or more biomarkers is not influenced by sample preparation or inconsistencies in IHC and/or ISH analysis. These and other embodiments are described in more detail herein.

Systems

At least some embodiments of the present disclosure relate to computer systems for analyzing vibrational spectral data acquired from biological specimens. In some embodiments, the test biological specimen is stained for the presence of one or more biomarkers. In some embodiments, the test biological specimen is unstained.

In some embodiments, the biological specimens have an unknown fixation status and/or unmasking status. In accordance with the present disclosure, a trained biomarker expression estimation engine may be used to provide a quantitative estimate of the expression of one or more biomarkers within a biological specimen (e.g. an unstained test biological specimen). In some embodiments, the systems of the present disclosure may receive as input test vibrational spectral data from a test biological specimen (e.g. an unstained test biological specimen) and may provide as an output a quantitative estimate of the expression of one or more biomarkers, including percent positivity or staining intensity. In some embodiments and depending on how the biomarker expression estimation engine was trained, the trained biomarker expression estimation engine may also provide as an output a quantitative or qualitative estimate of one or both of fixation status and/or unmasking status in addition to an estimation of biomarker expression.

In some embodiments, the output may be in the form of a generated report. In other embodiments, the output may be an overlay superimposed over an image of a test biological specimen. In yet other embodiments, any output may be stored in a memory coupled to the system (e.g. storage system 240) and that output may be associated with the test biological specimen and/or other patient data.

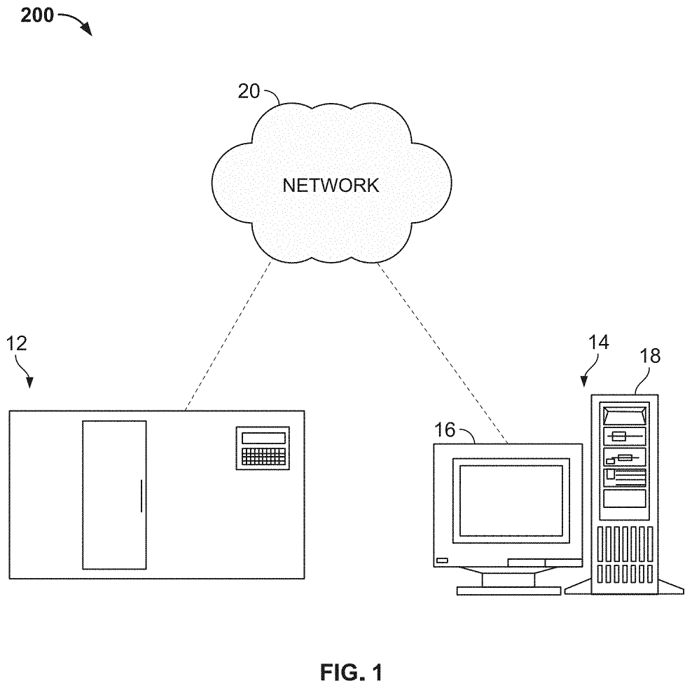

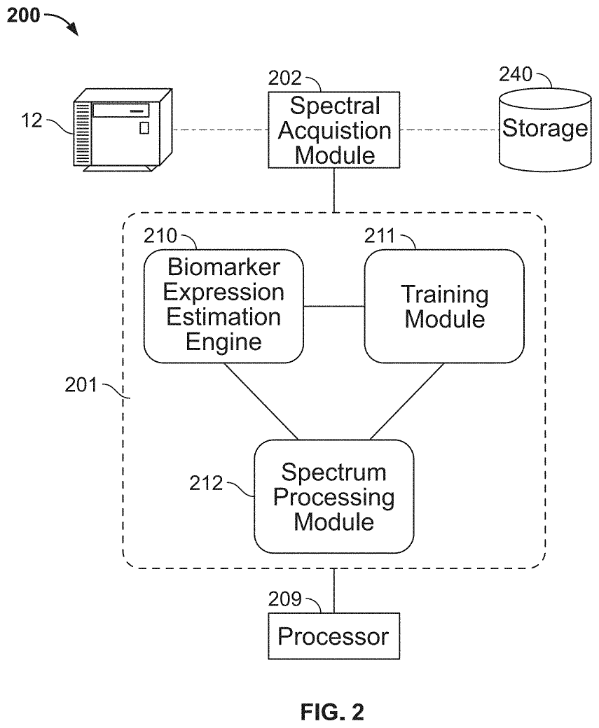

A system 200 for acquiring spectra data, e.g. vibrational spectral data, and analyzing biological specimens (including test biological specimens and training biological specimens) is illustrated in FIGS. 1 and 2. The system may include a spectral acquisition device 12, such as one configured to acquire a vibrational spectrum (e.g. a mid-IR spectrum or a Raman spectrum) of a biological specimen (or any portion thereof), and a computer 14, whereby the spectral acquisition device 12 and computer may be communicatively coupled together (e.g. directly, or indirectly over a network 20). The computer system 14 can include a desktop computer, a laptop computer, a tablet, or the like, digital electronic circuitry, firmware, hardware, memory 201, a computer storage medium (240), a computer program or set of instructions (e.g. where the program is stored within the memory or storage medium), one or more processors (209) (including a programmed processor), and any other hardware, software, or firmware modules or combinations thereof (such as described further herein). For example, the system 14 illustrated in FIG. 1 may comprise a computer with a display device 16 and an enclosure 18. The computer system can store acquired spectral data locally, such as in a memory, on a server, or another network connected device.

Vibrational spectroscopy is concerned with the transitions due to absorption or emission of electromagnetic radiation. These transitions are believed to appear in the range of 102 to 104 cm⁻¹ and originate from the vibration of nuclei constituting the molecules in any given sample. It is believed that a chemical bond in a molecule can vibrate in many ways, and each vibration is called vibrational mode. There are two types of molecular vibrations, stretching and bending. A stretching vibration is characterized by movement along the bond axis with increasing or decreasing of the interatomic distances, whereas a bending vibration consists of a change in bond angles with respect to the remainder of the molecule. The two widely used spectroscopic techniques based on vibrational energy are the Raman spectroscopy and the infrared spectroscopy. Both mid-infrared (MIR) absorption spectroscopy and Raman spectroscopy, utilizing the inelastic scattering of laser light, probe the specific vibrational energy levels of molecules in the target volume. The two techniques are complimentary, probing different vibrational modes based on vibrational selection rules, and are based on the fact that within any molecules the atoms vibrate with a few definite sharply defined frequency characteristics of that molecule. When a sample is irradiated with a beam of incident radiation, it absorbs energy at frequencies characteristic to that of the frequency of the vibration of chemical bonds present in the molecules. This absorption of energy through the vibration of chemical bond results in an infrared spectrum.

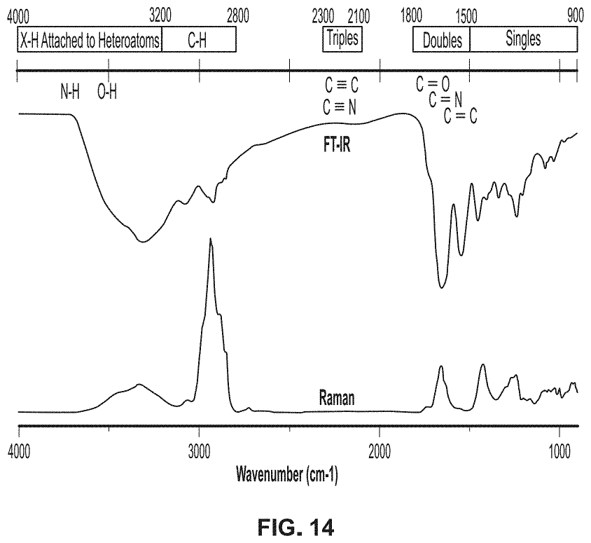

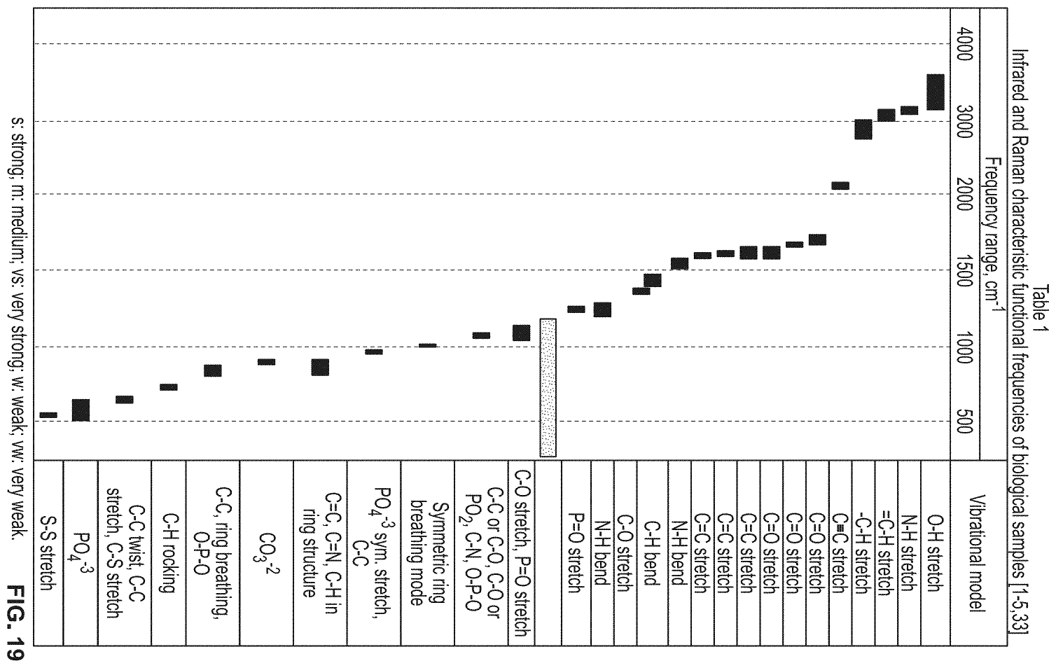

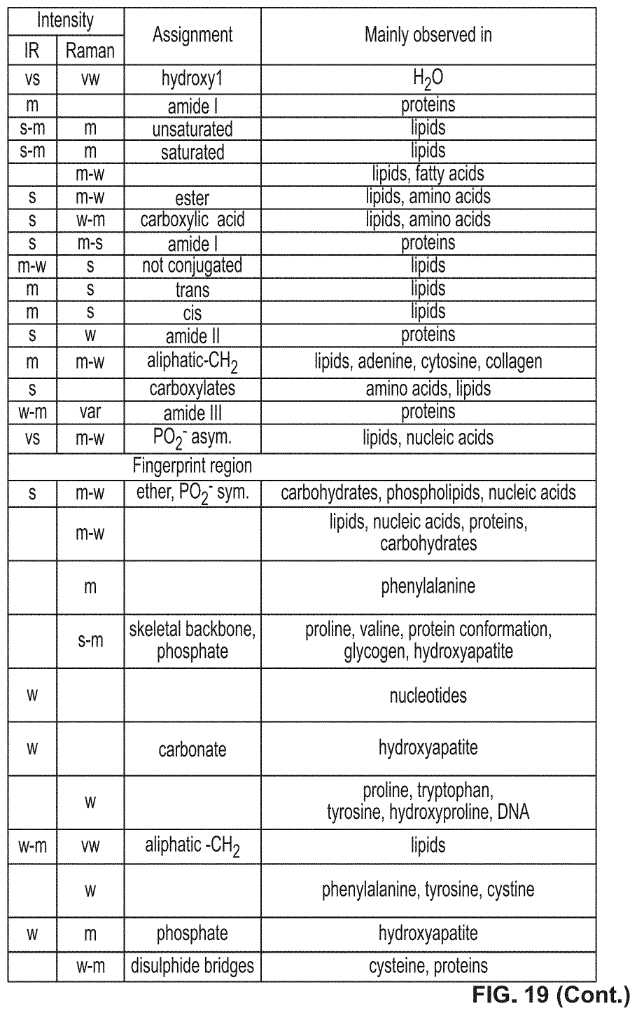

Although IR and Raman spectroscopies measure the vibrational energies of molecules, both methods are dependent on different selection rules, e.g., an absorption process and a scattering effect. Although their contrast mechanisms are different and each methodology has respective strengths and weaknesses, the resultant spectra from each modality are often correlated (see, e.g. FIGS. 14 and 19).

Infrared spectroscopy is based on the absorption of electromagnetic radiation, whereas Raman spectroscopy relies upon inelastic scattering of electromagnetic radiation. Infrared spectroscopy offers a number of analytical tools, from absorption to reflection and dispersion techniques, extended in a large range of wave numbers and including the near, middle, and far infrared regions in which the different bonds present in the sample molecules offer numerous generic and characteristic bands suitable to be employed for both qualitative and quantitative purposes. The sample is radiated with IR light in IR spectroscopy, and the vibrations induced by electrical dipole moment are detected.

Raman spectroscopy is a scattering phenomenon and arises due to the difference between the incident and scattered radiation frequencies. It utilizes scattered light to gain knowledge about molecular vibration, which can provide information regarding the structure, symmetry, electronic environment, and bonding of the molecule. In Raman spectroscopy, the sample is illuminated by a monochromatic visible or near IR light from a laser source and its vibrations during the electrical polarizability changes are determined.

Any vibrational spectral acquisition device may be utilized in the systems of the present disclosure. Examples of suitable spectral acquisition devices or components of such devices for use in acquiring mid-infrared spectra are described in US Patent Publication Nos.: 2018/0109078a and 2016/0091704; and in U.S. Pat. Nos. 10,041,832, 8,036,252, 9,046,650, 6,972,409, and 7,280,576, the disclosures of which are hereby incorporated by reference herein in their entireties.

Any method suitable for generating a representative mid-infrared spectrum for the biological specimens may be used. Fourier-transform Infrared Spectroscopy and its biomedical applications are discussed in, for example, in P. Lasch, J. Kneipp (Eds.) Biomedical Vibrational Spectroscopy” 2008 (John Wiley & Sons). More recently, however, tunable quantum cascade lasers have enabled the rapid spectroscopy and microscopy of biomedical specimen (see N. Kroger et al., in: Biomedical Vibrational Spectroscopy VI: Advances in Research and Industry, edited by A. Mahadevan-Jansen, W. Petrich, Proc. of SPIE Vol. 8939, 89390Z; N. Kroger et al., J. Biomed. Opt. 19 (2014) 111607; N. Kroger-Lui et al., Analyst 140 (2015) 2086) by virtue of their high spectral power density. The contents of each of these publications are hereby incorporated by reference in their entirety. It is believed that this work constitutes an advancement (as compared to foregoing Infrared microscopy setups) towards applicability in that the investigation is much faster (e.g. 5 minutes instead of 18 hours), does not need liquid nitrogen cooling and provides more many more pixels per image at substantially lower cost. One particular advantage of QCL-based microscopy in the context of the quality assessment of unstained tissue is the larger field of view (as compared to FT-IR imaging) which is enabled by the microbolometer array detector with e.g. 640×480 pixels.

In some embodiments, spectra may be obtained over broad wavelength ranges, one or more narrow wavelength ranges, or even at merely a single wavelength, or a combination thereof. For example, spectra may be acquired for an Amide I band and Amide II band. By way of another example, the spectra may be acquired over a wavelength ranging from about 3200 to about 3400 cm⁻¹, about 2800 to about 2900 cm⁻¹, about 1020 to about 1100 cm⁻¹, and/or about 1520 to about 1580 cm⁻¹. In some embodiments, the spectra may be acquired over a wavelength ranging from about 3200 to about 3400 cm⁻¹. In some embodiments, the spectra may be acquired over a wavelength ranging from about 2800 to about 2900 cm⁻¹. In some embodiments, the spectra may be acquired over a wavelength ranging from about 1020 to about 1100 cm⁻¹. In some embodiments, the spectra may be acquired over a wavelength ranging from about 1520 to about 1580 cm⁻¹. It is believed that narrowing down the spectral range is usually advantageous in terms of the acquisition speed, especially when using quantum cascade lasers. In some embodiments, a single tunable laser is tuned to the respective wavelengths one after the other. Alternatively, a set of non-tunable lasers at fixed frequency could be used such that the wavelength selection is done by switching on and off whichever laser is needed for a measurement at a particular frequency.

The spectra may be acquired using, for example, transmission or reflection measurements. For transmission measurements, barium fluorite, calcium fluoride, silicon, thin polymer films, or zinc selenide are usually used as substrate. For the reflection measurements, gold- or silver-plated substrates are common as well as standard microscope glass slides, or glass slides which are coated with a mid-IR-reflection coating (e.g. multilayer dielectric coating or thin sliver-coating). In addition, means for using surface enhancement (e.g. SEIRS) may be implemented such as structured surfaces like nanoantennas.

In some embodiments, other computer devices or systems may be utilized and that the computer systems described herein may be communicatively coupled to additional components, e.g. microscopes, imaging devices, scanner, other imaging systems, automated slide preparation equipment, etc. Some of these additional components and the various computers, networks, etc. that may be utilized are described further herein.

For example, in some embodiments the system 200 may further include an imaging device and any images captured from the imaging device may be stored in binary form, such as locally or on a server. In some embodiments, the images captured may be stored along with the biomarker expression estimates and/or any patient data, such as in storage sub-system 240. The captured digital images can also be divided into a matrix of pixels. The pixels can include a digital value of one or more bits, defined by the bit depth. In general, the imaging apparatus (or other image source including pre-scanned images stored in a memory) can include, without limitation, one or more image capture devices. Image capture devices can include, without limitation, a camera (e.g., an analog camera, a digital camera, etc.), optics (e.g., one or more lenses, sensor focus lens groups, microscope objectives, etc.), imaging sensors (e.g., a charge-coupled device (CCD), a complimentary metal-oxide semiconductor (CMOS) image sensor, or the like), photographic film, or the like. In digital embodiments, the image capture device can include a plurality of lenses that cooperate to prove on-the-fly focusing. An image sensor, for example, a CCD sensor can capture a digital image of the specimen.

In some embodiments, the imaging device is a bright-field imaging system, a multispectral imaging (MSI) system or a fluorescent microscopy system. The digitized tissue data may be generated, for example, by an image scanning system, such as a VENTANA DP200 scanner by VENTANA MEDICAL SYSTEMS, Inc. (Tucson, Ariz.) or other suitable imaging equipment. Additional imaging devices and systems are described further herein. In some embodiments, the digital color image acquired by the imaging apparatus is conventionally composed of elementary color pixels. Each colored pixel can be coded over three digital components, each comprising the same number of bits, each component corresponding to a primary color, generally red, green, or blue, also denoted by the term “RGB” components.

FIG. 2 provides an overview of the system 200 of the present disclosure and the various modules utilized within the system. In some embodiments, the system 200 employs a computer device or computer-implemented method having one or more processors 209 and one or more memories 201, the one or more memories 201 storing non-transitory computer-readable instructions for execution by the one or more processors to cause the one or more processors to execute certain instructions as described herein.

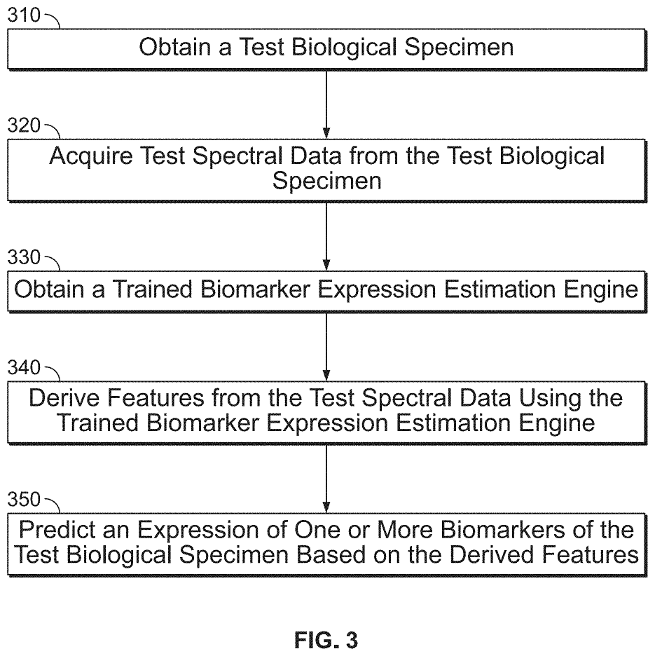

In some embodiments, and as noted above, the system includes a spectral acquisition module 202 for acquiring vibrational spectra, such as mid-IR spectra or RAMAN spectra, of an obtained biological specimen (see, e.g., step 310 of FIG. 3) or any portion thereof (see, e.g., step 320 of FIG. 3). In some embodiments, the system 200 further includes a spectrum processing module 212 adapted to process acquired vibrational spectral data. In some embodiments, the spectrum processing module 212 is configured to pre-process spectral data. In some embodiments, the spectrum processing module 212 corrects and/or normalizes the acquired vibrational spectra, or to convert acquired transmission spectra to absorption spectra. In other embodiments, the spectrum processing module 212 is configured to average a plurality of acquired vibrational spectra from a single biological specimen. In yet other embodiments, the spectrum processing module 212 is configured to further process any acquired vibrational spectrum, such as to compute a first derivative, a second derivative, etc. of an acquired vibrational spectrum.

In some embodiments, the system 200 further includes a training module 211 adapted to receive training vibrational spectral data and to use the received training vibrational spectral data to train a biomarker expression estimation engine 210.

In some embodiments, the system 200 includes a biomarker expression estimation engine 210 which is trained to detect biomarker expression features within test vibrational spectral data (see, e.g., step 340 of FIG. 3) and provide an estimate of biomarker expression (e.g. staining intensity or percent positivity) of a biological specimen based on the detected biomarker expression features (see, e.g., step 350 of FIG. 3). In some embodiments, the biomarker expression estimation engine 210 includes one or more machine-learning algorithms. In some embodiments, one or more machine-learning algorithms is based on dimensionality reduction as described further herein. In some embodiments, the dimensionality reduction utilized principal component analysis, such as principal component analysis with discriminate analysis. In other embodiments, the dimensionality reduction is a projection onto latent structure regression. In some embodiments, the biomarker expression estimation engine 210 includes a neural network. In other embodiments, the biomarker expression estimation engine 210 includes a classifier, such as a support vector machine.

In some embodiments, additional modules may be incorporated into the workflow or into system 200. In some embodiments, an image acquisition module be run to acquire digital images of a biological specimen or any portion thereof. In other embodiments, an automated image analysis algorithm may be run such that cells may be detected, classified, and/or scored (see, e.g., U.S. Patent Publication No. 2017/0372117 the disclosure of which is hereby incorporated by reference herein in its entirety). Other suitable image analysis algorithms are described in PCT Publication Nos. WO/2019/121564, WO/2019/110583, WO/2019/110567, WO/2019/110561, WO/2019/025533, WO/2019/025515, and WO/2018/122056, the disclosures of which are hereby incorporated by reference herein in their entireties.

Spectral Acquisition Module and Acquired Spectral Data

With reference to FIG. 2, in some embodiments, the system 200 runs a spectral acquisition module 202 to acquire vibrational spectra (e.g. using an spectra imaging apparatus 12, such as any of those described above) from at least a portion of a biological specimen (e.g. a test biological specimen or a training biological specimen). In other embodiments, the test biological specimens (described further herein) are unstained, e.g. it does not include any stains indicative of the presence of one or more biomarkers. In some embodiments, and for training biological specimens (described further herein), the biological specimen is stained for the presence of one or more biomarkers. Once the vibrational spectra are acquired using the spectral acquisition module 202, the acquired vibrational spectra may be stored in a storage module 240 (e.g. a local storage module or a networked storage module).

In some embodiments, the vibrational spectra may be acquired from a portion of the biological specimen (and this is regardless of whether the specimen is a training biological specimen or a test biological specimen, as described further herein). In such a case, the spectral acquisition module 202 may be programmed to acquire the vibrational spectra from a predefined portion of the sample, for example by random sampling or by sampling at regular intervals across a grid covering the entire sample. This can also be useful where only specific regions of the sample are relevant for analysis.

For example, a region of interest may include a certain type of tissue or a comparatively higher population of a certain type of cell as compared with another region of interest. For example, a region of interest may be selected that includes tonsil tissue but excludes connective tissue. In such a case, the spectral acquisition module 202 may be programmed to collect the vibrational spectra from a predefined portion of a region of interest, for example by random sampling of the region of interest or by sampling at regular intervals across a grid covering the entire region of interest. In embodiments where the sample includes one or more stains, vibrational spectra may be obtained from those regions of interest that do not include any stain or include comparatively less stain than other regions.

In some embodiments, at least two regions of the biological specimen are sampled, and vibrational spectra are acquired for each of the at least two regions (and again, this is regardless of whether the specimen is a training biological specimen or a test biological specimen). In other embodiments, at least 10 regions of the biological specimen are sampled, and vibrational spectra are acquired for each of the at least 10 regions. In yet other embodiments, at least 30 regions of the biological specimen are sampled, and vibrational spectra are acquired for each of the at least 30 regions. In further embodiments, at least 60 regions of the biological specimen are sampled, and vibrational spectra are acquired for each of the at least 60 regions. In yet further embodiments, at least 90 regions of the biological specimen are sampled, and vibrational spectra are acquired for each of the at least 90 regions. In even further embodiments, between about 30 regions and about 150 regions of the biological specimen are sampled, and vibrational spectra are acquired for each of the regions.

In some embodiments, a single vibrational spectrum is acquired per region of the biological specimen. In other embodiments, at least two vibrational spectra are acquired per region of the biological specimen. In yet other embodiments, at least three vibrational spectra are acquired per region of the biological specimen.

In some embodiments, the acquired vibrational spectra or acquired vibrational spectral data (used interchangeably herein) which are stored in storage module 240 include “training spectral data.” In some embodiments, the training spectral data is derived from training biological specimens, where the training biological specimens may be histological specimens, cytological specimens, or any combination thereof.

In some embodiments, the training spectral data are used to train a biomarker expression engine 210, such as through use of the training module 211 as described herein. In some embodiments, the training spectral data includes class labels, such biomarker expression levels (e.g. percent positivity, staining intensity), unmasking status (e.g. unmasking time, unmasking duration, relative unmasking quality information, such as “un-retrieved,” “fully retrieved,” and “partially retrieved”), fixation status (e.g. fixation duration, relative fixation quality, such as “partially fixed,” “fully fixed,” “adequately fixed, and “inadequately fixed”), etc. In some embodiments, the training spectral data includes a plurality of class labels. In some embodiments, the class labels include an identification of a tissue type, the specific binding agents utilized in any staining assay, tissue preparation information, patient information, etc.

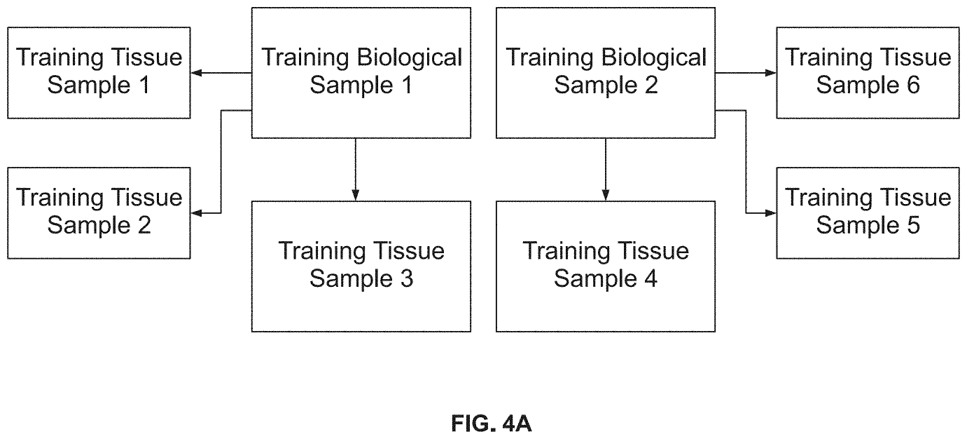

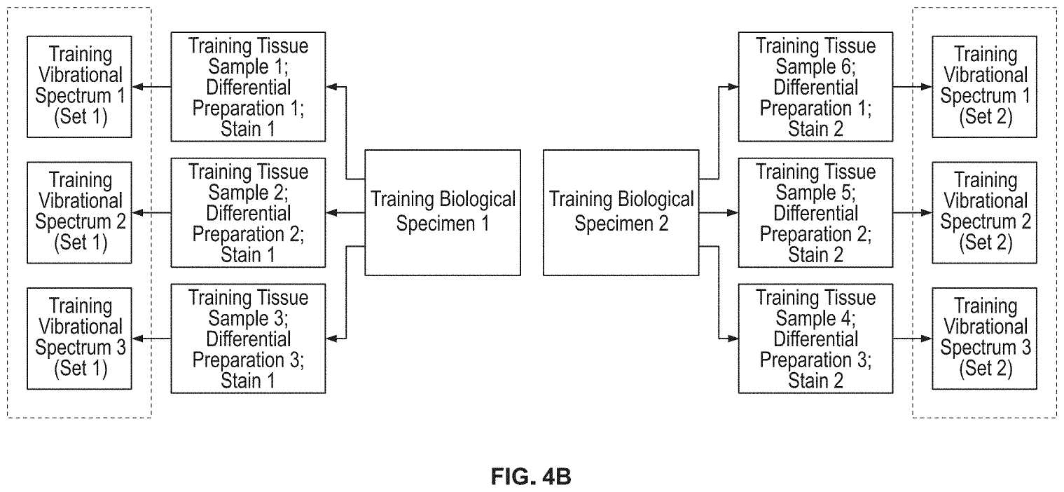

In some embodiments, multiple training vibrational spectral data sets are used to train a biomarker expression estimation engine. In some embodiments, each training spectral data set may be derived from a single training biological specimen which is divided into a plurality of parts (see FIG. 4A), such as a plurality of training tissue samples (e.g. a first training tissue sample, a training second tissue sample, and n^{th} training tissue sample), and each training tissue sample may be prepared differently. For example, and as described further below, each training tissue sample may be differentially prepared, e.g. stained differently, fixed differently, and/or unmasked differently (see FIG. 4B). In this regard, a single training biological specimen may give rise to a plurality of differentially prepared samples representing a continuum of different conditions and/or tissue preparation states. Of course, each different training vibrational spectral data set may be derived from a different subject or patient, may be derived from a different tissue type (e.g. tonsil tissue vs. breast tissue), and/or may be treated with different specific binding entities (e.g. a specific binding entity which recognizes a CD8 marker versus a specific binding entity which recognizes a CD3 biomarker; a specific binding entity which recognizes CD8 from a first manufacturer versus a specific binding entity which recognizes CD8 from a second manufacturer).

In some embodiments, the training biological specimens and each of the training tissue samples derived therefrom are stained for the presence of one or more biomarkers such that biomarker expression (e.g. percent positivity and/or staining intensity) may be evaluated for each training sample (such a as by a trained pathologist or using one or more image analysis algorithms). For example, each individual training sample may be stained with one or more of BCL2, C4d, ki-67, FOXP3, etc. Other biomarkers suitable for detection and classification are described herein.

In some embodiments, each training tissue sample is stained for the presence of a single biomarker and then images of the training tissue samples are captured using an imaging device and analyzed (such that the staining intensity and/or percent positivity of the biomarker in each individual training tissue sample may be determined). In other embodiments, each training tissue sample is stained for the presence of two or more biomarkers and then images of the training tissue samples are captured using an imaging device and analyzed (again, such that the staining intensity and/or percent positivity of each of the two or more biomarkers are independently analyzed). For those training tissue samples stained for the presence of two or more biomarkers, the images captured of those training tissue samples may first be unmixed and then each unmixed image channel image may be evaluated such that a staining intensity and/or percent positivity may be evaluated stain signals present in the particular unmixed image channel image. Methods of unmixing are described in PCT Publication No. WO/2019/110583, the disclosure of which is hereby incorporated by reference herein in its entirety.

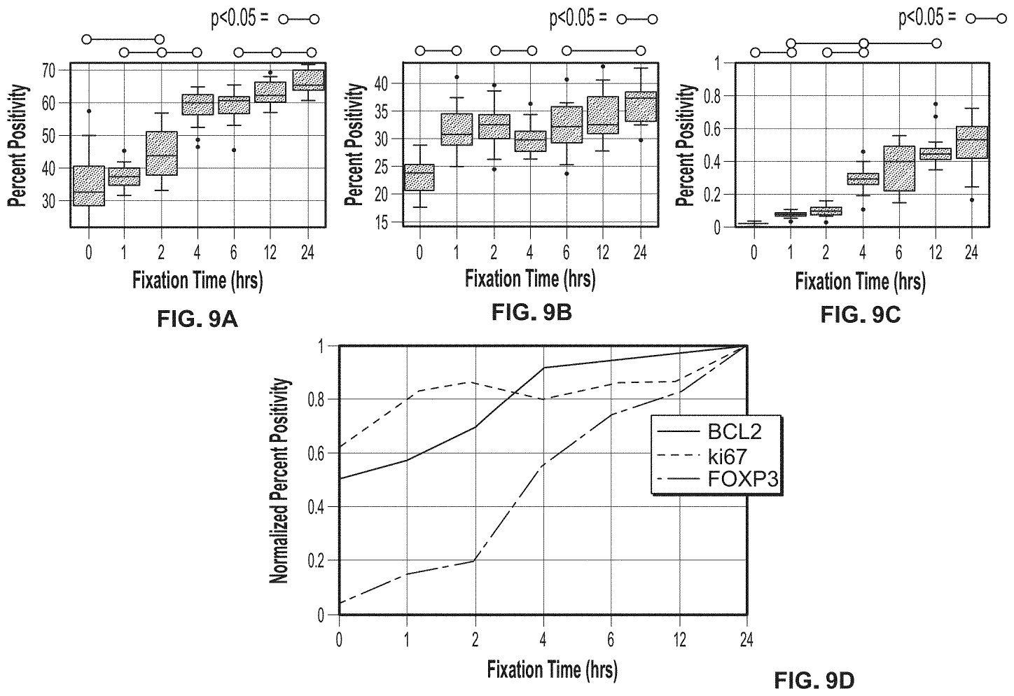

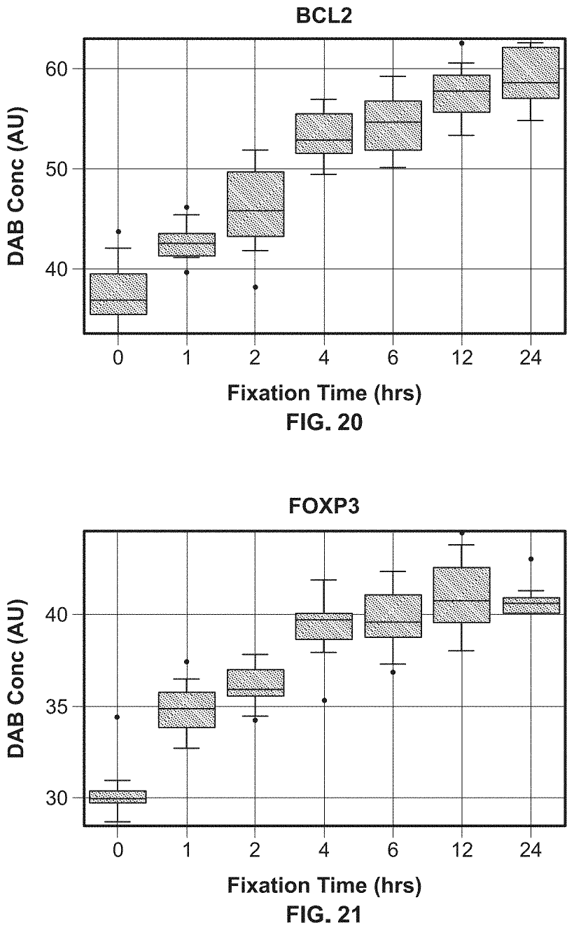

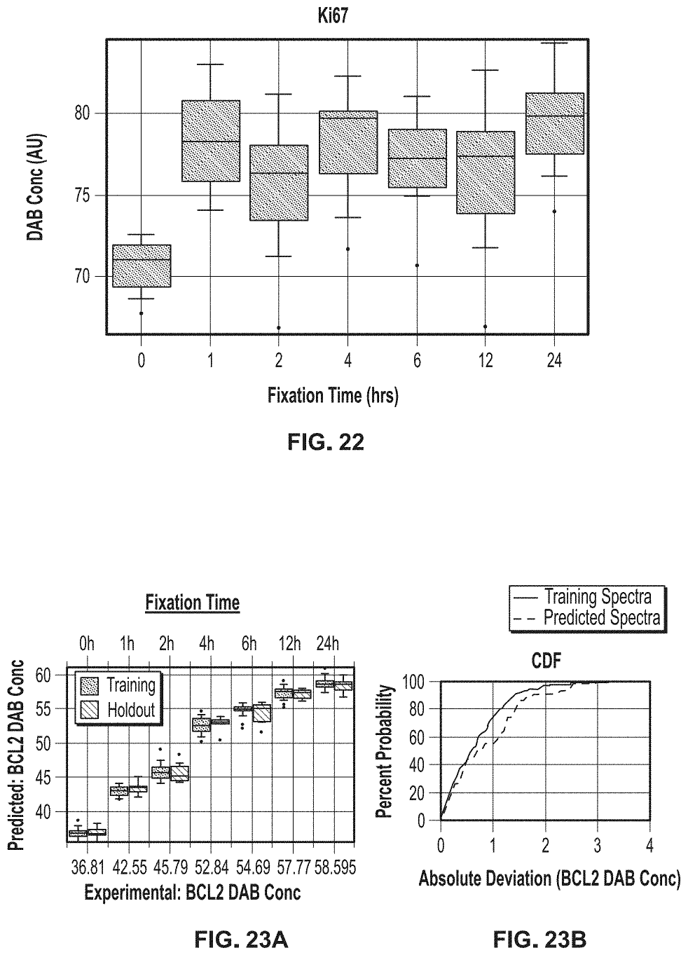

In some embodiments, the preparation of any training tissue specimen, including the steps of sample fixation and the unmasking of targets (e.g. protein and/or nucleic acid targets) within the sample, may have an impact on biomarker expression. Example 1 herein illustrates the impact of fixation time on the expression of three different biomarkers, namely BLC2, ki-67, and FOXP3, and, in particular, fixation time's impact on measured percent positivity (see also FIGS. 9A-9D). Likewise, FIGS. 20-22 illustrate the impact of fixation time on staining intensity of these same three biomarkers.

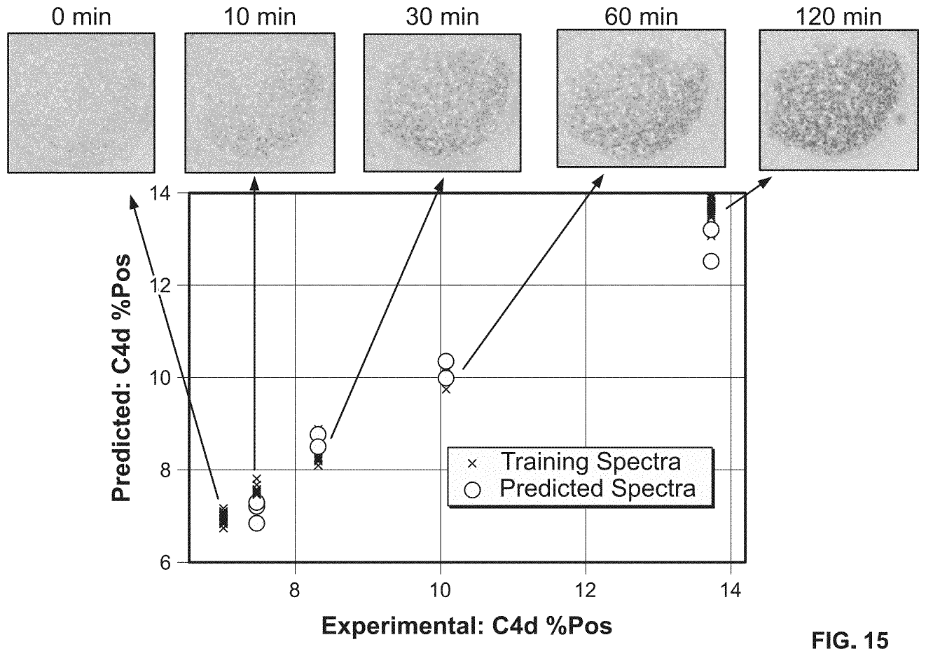

Example 2 herein similarly illustrates the impact of unmasking quality on the expression of ki-67 biomarker or the C4d biomarker. As described further in Example 2, it was shown that different biomarkers may show different responses to increasing unmasking treatments. For example, C4d in stain intensity and number of labeled cells to a point after which intensity and positivity decrease. Conversely, ki67 continues to increase in intensity and positivity through the duration of an applied unmasking process until saturation occurs, even under unmasking conditions which would otherwise damage the biological specimen (see, e.g., dots of FIG. 15, and the associated tissue images).

Given the foregoing, in some embodiments, the training vibrational spectral data sets may include training tissue samples which have been differentially fixed and/or differentially unmasked, as described below. In this way, the biomarker expression estimation engine may be trained with training spectral data spanning a continuum of different fixation and/or unmasking states such that the biomarker expression estimation engine may be able to determine the expression of one or biomarkers within an unstained test biological specimen regardless of the actual fixation and/or unmasking state of the test biological specimen, and/or regardless of whether the fixation and/or unmasking states of the test biological specimen are known or unknown.

In some embodiments, the training biological specimens are differentially fixed. Differential fixation is a process whereby each training tissue sample of a plurality of training tissue samples (each derived from a single training biological specimen as noted above) is subjected to a different fixation process. In some embodiments, any training tissue sample may be fixed for any pre-determined amount of time, e.g. 1 hour, 2 hours, 4 hours, 6 hours, 12 hours, etc. In this regard, a plurality of training tissue samples may each be partially fixed (e.g. not treated with fixative for a duration sufficient to seem the sample as “fully fixed” or “adequately fixed”), such as to different degrees. Additionally, the set of training tissue samples may include tissue samples which have not be fixed (e.g. 0 hours of fixation).

In some embodiments, the training biological specimens are differentially unmasked. Differential fixation is a process whereby each training tissue sample of a plurality of training tissue samples (each derived from a single training biological specimen as noted above) is subjected to different unmasking conditions, e.g. different unmasking reagents, different unmasking durations, different unmasking temperatures, and/or different unmasking pressures. For example, in some embodiments, a plurality of training samples derived from a single training biological specimen are each unmasked at the same temperature, but for different durations. For example, each training tissue sample derived from a single training biological specimen could be unmasked at the same temperature (e.g. 98.6° C.) but where the duration of unmasking could vary (5 minutes, 30 minutes, 60 minutes, etc.).

By way of another example, and in other embodiments, a plurality of training tissue samples derived from a single training biological specimen are each unmasked for the same duration, but at different temperatures. For example, each training tissue sample could be unmasked for the same duration (e.g. 10 minutes) but where the temperature of the unmasking is varied (98.6° C., 110° C., 120° C., 130° C., etc.). In some embodiments, the unmasking time and temperature could both be varied. As in the embodiments described above, a first set of training tissue samples could be unmasked at a first temperature but for different durations, providing a first set of training tissue samples. A second set and a third set of training tissue samples can be unmasked at a second temperature and a third temperature, respectively, and again for different durations, providing second and third sets of training tissue samples.

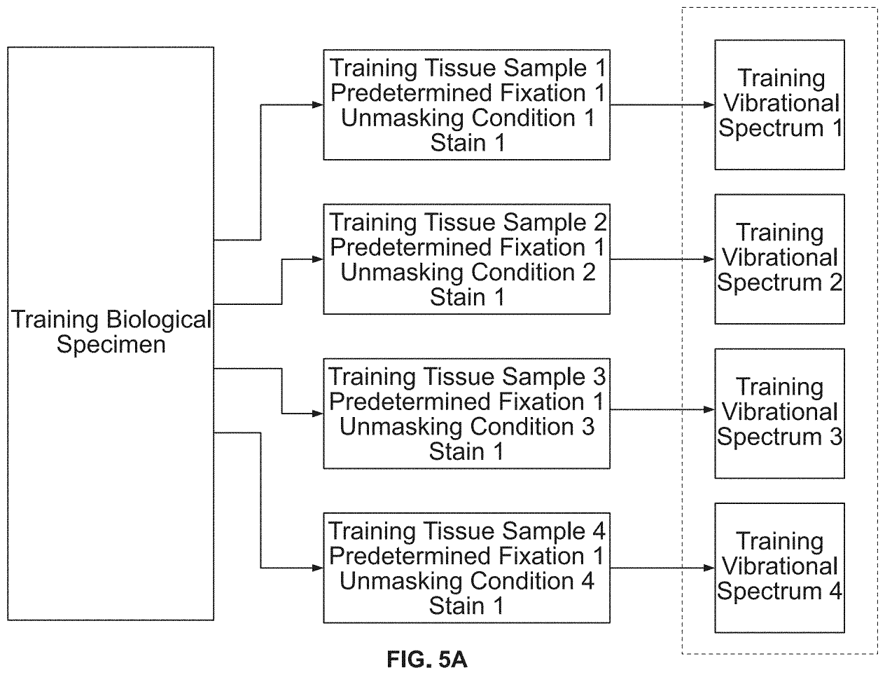

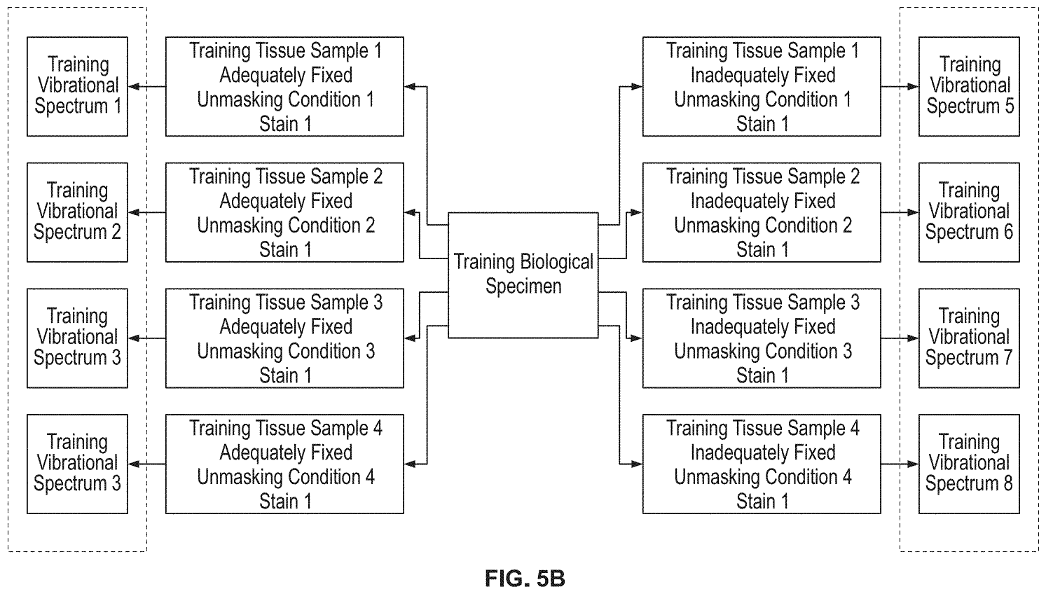

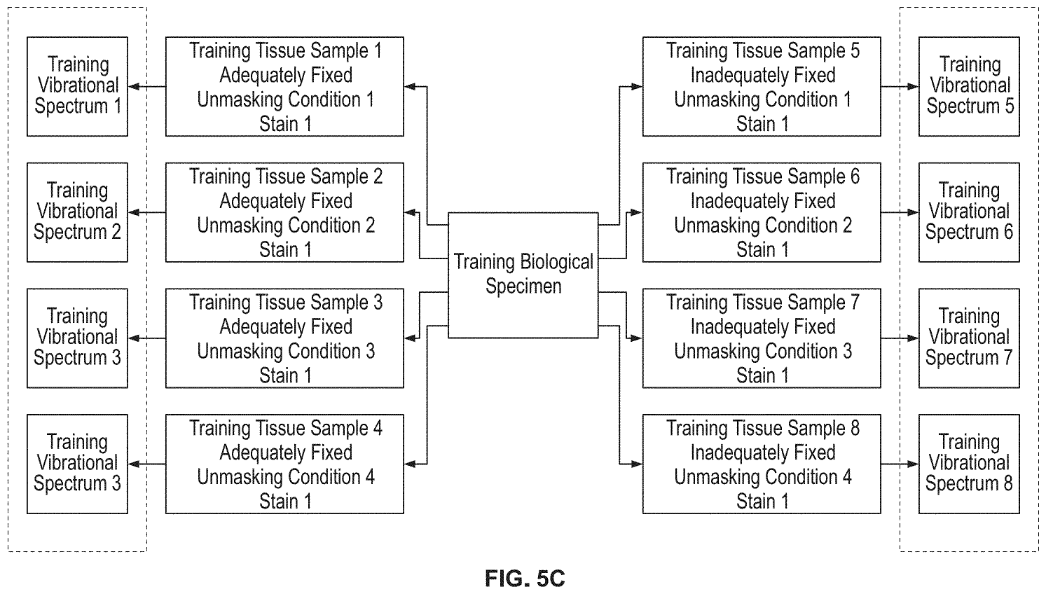

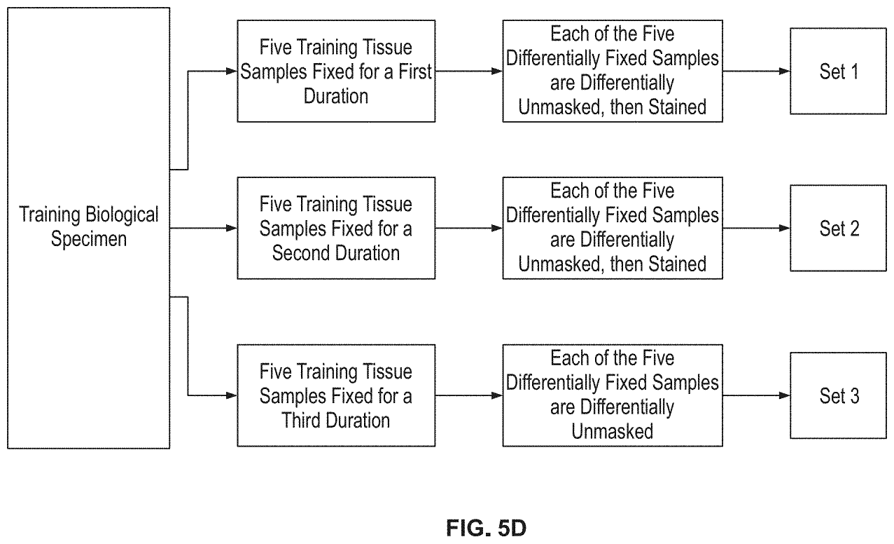

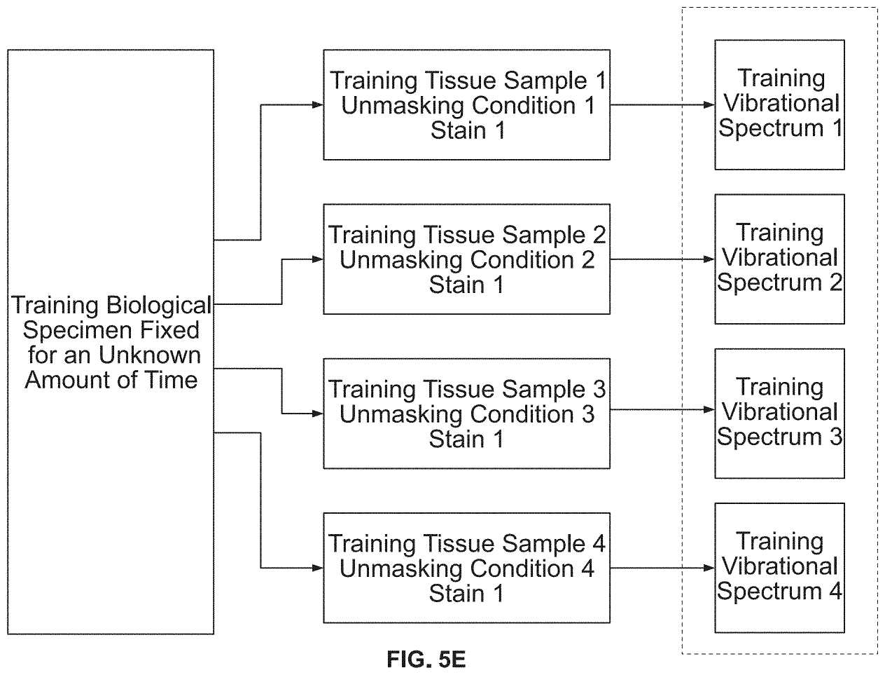

In some embodiments, a single training biological sample may be divided into a plurality of training tissue samples, and each individual training tissue sample of the plurality of training tissue samples may be (i) fixed for the same predetermined duration (e.g. 12 hours), but (ii) differentially unmasked. In some embodiments, the individual tissue samples may each be fixed for a time period which would provide “adequate” or “full” fixation. This is illustrated in FIG. 5A.

By way of example, and again with reference to FIG. 5A, the “predetermined fixation 1” may be a fixation duration of 12 hours; “stain 1” may refer to one or more stains applied to the training tissue sample; while the “unmasking conditions 1, 2, 3, and 4” may each have a duration of 10 minutes but where the unmasking temperatures are each varied, e.g. 98.6° C., 110° C., 120° C., 130° C., respectively. While FIG. 5A illustrates the preparation and acquisition of a single set of training spectral data, a plurality of additional training spectral data sets may be similarly prepared and acquired, but where any of the fixation duration, unmasking conditions, stains applied, tissue type, etc. are varied.

In yet other embodiments, a single training biological sample may be divided into two sets of training tissue samples, and where each different set of training tissue samples includes a plurality of individual training tissue samples. Following this particular example, a first set of training tissue samples may each be fixed for a time period which provides samples deemed “adequately fixed.” Then, each of the individual training tissue samples in the first set of training tissue samples, may be differentially unmasked. Likewise, a second set of training tissue samples may each be fixed for a time period which provides samples deemed “inadequately fixed.” Then, each of the individual training tissue samples in the second set of training tissue samples, may be differentially unmasked. This is illustrated in FIG. 5B.

In other embodiments, a single training biological sample may be divided into a plurality of training tissue samples, and each individual training tissue sample of the plurality of training tissue samples may be (i) differentially fixed (e.g. 12 hours), but (ii) unmasked under the same unmasking conditions. This is illustrated in FIG. 5C. In some embodiments, the unmasking conditions could be those deemed to render a sample “adequately” unmasked, given the duration of fixation and given the tissue type and unmasking reagent(s) utilized.

In some embodiments, the length of a fixation process may be a determinant in the conditions utilized in any unmasking process (e.g. longer unmasking times may be needed for samples which have been fixed for longer durations). Accordingly, in yet further embodiments, a single training biological sample may be divided into a plurality of training tissue sample sets, and where each different set of training tissue samples includes a plurality of individual training tissue samples, and where each different set of training tissue samples is fixed for a different duration.

Within each different training tissue sample set fixed for a pre-determined duration, each individual training tissue sample may be differentially unmasked, such as illustrated in FIG. 5D. In this manner, each of these differentially fixed training tissue samples may be unmasked for a certain predetermined amount of time and under predetermined conditions which render each sample “adequately” unmasked. Said another way, each differentially fixed sample may be unmasked for a specific amount of time and under set conditions to render that particular training tissue sample “adequately” unmasked. Each training tissue sample may then be stained for the presence of one or more biomarkers.

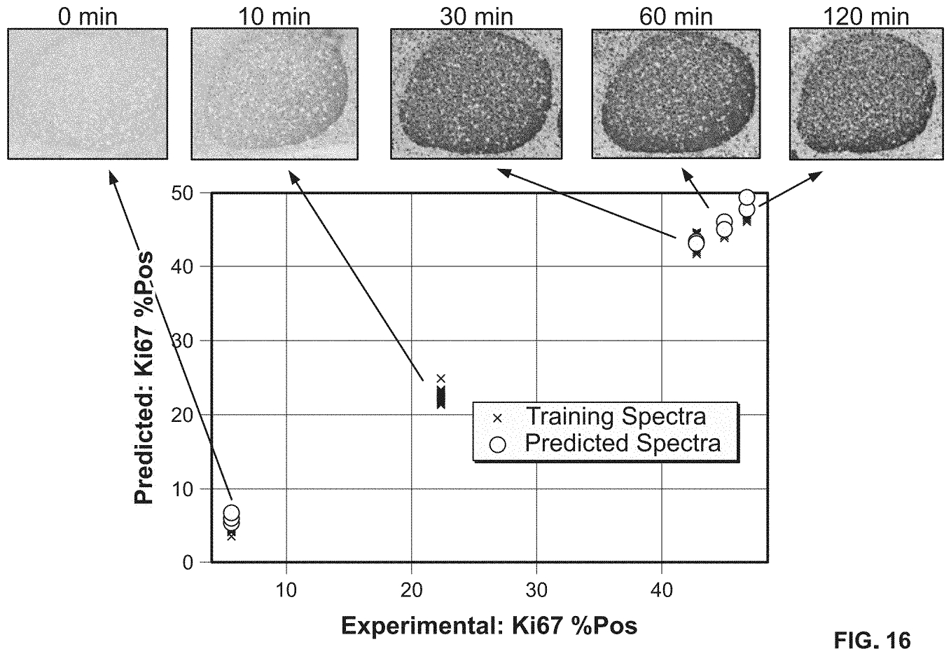

FIG. 5E sets forth a flowchart illustrating the process of obtaining one or more training spectral data sets from a training biological specimen fixed for an unknown amount of time. Here, the training biological specimen is divided, differentially unmasked, and stained for the presence of one or more biomarkers. The resulting stained training tissue samples are then imaged, cells are detected and/or classified, and then a vibrational spectrum is acquired for each training tissue sample. The resulting data (e.g. images, class labels, vibrational spectroscopy data, etc.) set may be stored on a server or other storage device for later retrieval. These methods are further described in Example 3. Applicant has discovered that even training biological specimens having unknown fixation times are valuable in training a biomarker expression estimation engine. In fact, as illustrated in FIGS. 15 and 16 and as described in Example 3, a biomarker expression estimation engine trained solely on training spectral data sets derived from training biological specimens having unknown fixation durations, allows for the estimation of one or more biomarkers in a test biological specimen with high accuracy.

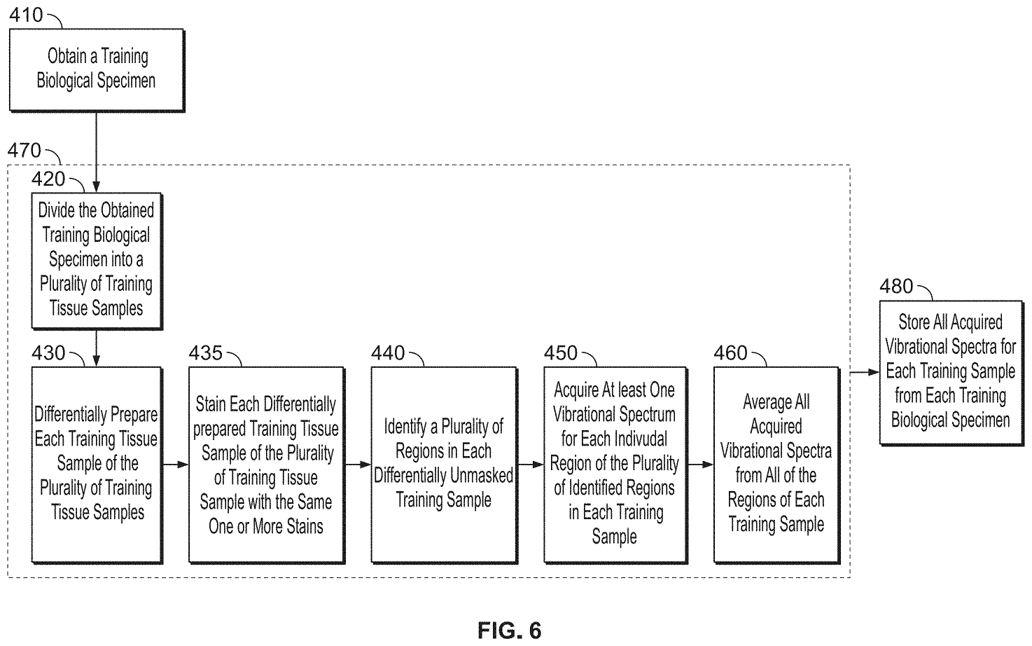

The process of acquiring spectral data from the differentially prepared samples stained for the presence of one or more biomarkers is illustrated in FIG. 6. As noted above, one or more training biological specimens are first acquired (step 410). Each of the one or more training biological specimens are then divided into at least two parts (step 420). In this way, each of the one or more training biological specimens provide at least two “training tissue samples.” Each of these training tissue samples may be differentially prepared, e.g. each may be differentially fixed and/or differentially unmasked (step 430). Following the differential preparation of the at least two training tissue samples, each of the at least two training tissue samples is stained for the presence of one or more biomarkers, including protein and/or nucleic acid biomarkers (step 435). Subsequent to staining, a plurality of regions in each of the at least two differentially prepared and stained training tissue samples are identified (step 440).

Next, at least one vibrational spectrum is acquired for each of the identified regions of the plurality of identified regions (step 450). The average of each acquired vibrational spectrum from each identified region (or a further processed variant thereof as described further below) is computed to provide an averaged vibrational spectrum for that training sample (step 460). Steps 400 through 460 may be repeated for a plurality of different training biological specimens (see dotted line 470). In some embodiments, the averaged vibrational spectra from all training tissue samples from all training biological specimens (referred to as “training spectral data sets”) are stored (step 480), such as in storage module 240. In this way, the training spectral data or training spectral data sets may be retrieved from the storage module 240 by the training module 211 for training of a biomarker expression estimation engine 210. In addition to storing the average vibrational spectra from all training samples, the storage module 240 is also adapted to store any class labels associated with the averaged vibrational spectra (e.g. the actual measured expression of one or more biomarkers (either as assessed by a pathologist or as determined using one or more image analysis algorithms), unmasking status, fixation status, etc.).

The processes described above for preparing training biological specimens and acquiring spectra data from such specimens may be repeated for a plurality of different training biological specimens (see step 470), where each of the plurality of different training biological specimens may be of the same tissue type or may of a different tissue type (e.g. tonsil tissue or breast tissue). The Example section herein further describes the methods of preparing training biological specimens and the acquisition of spectral data for use in training a biomarker expression estimation engine 210.

In some embodiments, the acquired spectral data stored in the storage module 240 include “test spectral data.” In some embodiments, the test spectral data is derived from test biological specimens, such as specimens derived from a subject (e.g. a human patient), where the test biological specimens may be histological specimens, cytological specimens, or any combination thereof. In some embodiments, the test spectral data is derived from unstained test specimens. In other embodiments, the test spectral data is derived from biological specimens stained for the presence of one or more biomarkers.

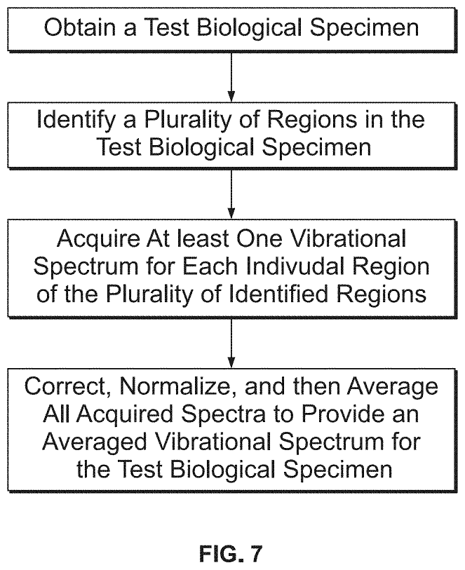

With reference to FIG. 7, a test biological specimen may be obtained (step 510), and then a plurality of spatial regions within the test biological specimen may be identified (step 520). At least one vibrational spectrum may be acquired for each identified region (step 530). The acquired vibrational spectra from all of the regions may then be corrected, normalized, and averaged to provide an averaged vibrational spectrum for the test biological specimen (“test spectral data”). As described further herein, the test spectral data may be supplied to a trained biomarker expression estimation engine 210 such that an expression one or more biomarkers within the test biological specimen may be predicated. The predicated expression of the one or more biomarkers may then be used in downstream processes or downstream decision making, e.g. scoring of the sample, where the scored sample may be used to guide treatment options. In some embodiments, the test biological specimens have been fixed for an unknown amount of time and/or have been unmasked under conditions which are not known.

As noted above, and regardless of whether the spectral data is acquired from a training or test biological specimen, a plurality of vibrational spectra are acquired for each biological specimen, e.g. to account for spatial the spatial heterogeneity of the sample. In some embodiments, the spectral processing module 212 is first utilized to covert each acquired vibrational transmission spectrum to a vibrational absorption spectrum. In some embodiments, transmission spectra and absorbance spectra are directly related via the equation Absorbance=ln(blank transmission/transmission through the tissue) and thus acquired transmission spectra may be converted to absorption spectra.

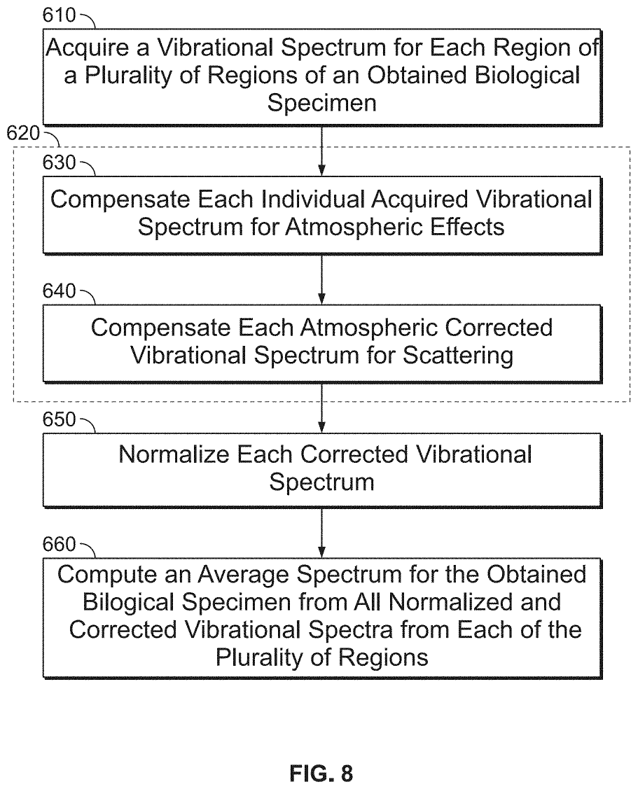

Once all of the vibrational spectra are converted from transmission to absorbance, in some embodiments, the spectral processing module 212 averages all of the acquired spectra from all of the various regions, and it is the averaged vibrational spectrum that is used for downstream analysis, e.g. for training or predicting a biomarker expression. In some embodiments, and with reference to FIG. 8, the vibrational spectra acquired from each of the plurality of spatial regions are first normalized and/or corrected prior to their averaging. In some embodiments, vibrational spectrum from each region is individually corrected (step 620) to provide a corrected vibrational spectrum. For example, the correction may include compensating each acquired vibrational spectrum for atmospheric effects (step 630) and then compensating each atmospheric corrected vibrational spectrum for scattering (step 640). Next, each corrected vibrational spectrum is normalized, e.g. to a maximum value of 2 to mitigate differences in specimen thickness and tissue density (step 650). Subsequently, the collective of the amplitude normalized spectra are averaged (step 660).

Biomarker Expression Estimation Engine

The systems and methods of the present disclosure employ machine learning techniques to mine spectral data. In the case of an biomarker expression estimation engine in a training mode, the biomarker expression estimation engine may learn features from a plurality of acquired and processed training vibrational spectra (such as training vibrational spectra stored within storage module 240) and correlate those learned features with class labels associated with the training spectra (e.g. known biomarker expression for one or more biomarkers, known unmasking temperatures, known unmasking duration, tissue quality, etc.). In the case of a trained biomarker expression estimation engine, the trained biomarker expression engine may derive biomarker expression features from an unstained test biological specimen and, based on the learned datasets, predict an expression of one or more biomarkers within the unstained test biological specimen based on the derived biomarker expression features.

Machine learning can be generally defined as a type of artificial intelligence (AI) that provides computers with the ability to learn without being explicitly programmed. Machine learning focuses on the development of computer programs that can teach themselves to grow and change when exposed to new data. In other words, machine learning can be defined as the subfield of computer science that gives computers the ability to learn without being explicitly programmed.

Machine learning explores the study and construction of algorithms that can learn from and make predictions on data—such algorithms overcome following strictly static program instructions by making data driven predictions or decisions, through building a model from sample inputs. The machine learning described herein may be further performed as described in “Introduction to Statistical Machine Learning,” by Sugiyama, Morgan Kaufmann, 2016, 534 pages; “Discriminative, Generative, and Imitative Learning,” Jebara, MIT Thesis, 2002, 212 pages; and “Principles of Data Mining (Adaptive Computation and Machine Learning),” Hand et al., MIT Press, 2001, 578 pages; which are incorporated by reference as if fully set forth herein. The embodiments described herein may be further configured as described in these references.

In some embodiments, the biomarker expression estimation engine 210 employs “supervised learning” for the task of predicting a biomarker expression of a test spectrum derived from a test biological specimen. Supervised learning is the machine learning task of learning a function that maps an input to an output based on example input-output pairs. It infers a function from labeled training data (here, the biomarker expression is the label associated with training spectral data) consisting of a set of training examples (here training spectra). In supervised learning, each example is a pair consisting of an input object (typically a vector) and a desired output value (also called the supervisory signal). A supervised learning algorithm analyzes the training data and produces an inferred function, which can be used for mapping new examples. An optimal scenario allows for the algorithm to correctly determine the class labels for unseen instances.

The biomarker expression estimation engine 210 may include any type of machine learning algorithm known to those of ordinary skill in the art. Suitable machine learning algorithms include regression algorithms, similarity-based algorithms, feature selection algorithms, regularization method-based algorithms, decision tree algorithms, Bayesian models, kernel-based algorithms (e.g. support vector machines), clustering-based methods, artificial neural networks, deep learning networks, ensemble methods, and dimensionality reduction methods. Examples of suitable dimensionality reduction methods include principal component analysis (such as principal component analysis plus discriminant analysis) and projection onto latent structure regression.

In some embodiments, the biomarker expression estimation engine 210 utilizes principal component analysis. The main idea of principal component analysis (PCA) is to reduce the dimensionality of a data set consisting of many variables correlated with each other while retaining the variation present in the dataset, up to the maximum extent. The same is done by transforming the variables to a new set of variables, which are known as the principal components (or simply, the PCs) and are orthogonally ordered such that the retention of variation present in the original variables decreases as they move down in the order. In this way, the first principal component retains maximum variation that was present in the original components. The principal components are the eigenvectors of a covariance matrix, and hence they are orthogonal. Principal component analysis and methods of employing the same are described in U.S. Patent Publication No. 2005/0123202 and in U.S. Pat. Nos. 6,894,639 and 8,565,488, the disclosures of which are hereby incorporated by reference herein in their entireties. PCA and Linear Discriminant Analysis are further described by Khan et. al., “Principal Component Analysis-Linear Discriminant Analysis Feature Extractor for Pattern Recognition,” “IJCSI International Journal of Computer Sciences Issues, Vol. 8, Issue 6, No. 2, November 2011, the disclosure of which is hereby incorporated by reference herein in its entirety.

In some embodiments, the biomarker expression estimation engine 210 utilizes projection onto latent structure regression (PLSR). PLSR is a technique that combines features from and generalizes PCA and multiple linear regression. Its goal is to predict a set of dependent variables from a set of independent variables or predictors. This prediction is achieved by extracting from the predictors a set of orthogonal factors called latent variables which have the best predictive power. These latent variables can be used to create displays akin to PCA displays. The quality of the prediction obtained from a PLS regression model is evaluated with cross-validation techniques such as the bootstrap and jackknife. There are two main variants of PLS regression: The most common one separates the roles of dependent and independent variables; the second one—gives the same roles to dependent and independent variables. PLSR is further described by Abdi, “Partial Least Squares Regression and Projection on Latent Structure Regression (PLS Regression),” WIREs Computational Statistics, John Wiley & Sons, Inc., 2010, the disclosure of which is hereby incorporated by reference herein in its entirety. The Examples section provided herein describes a trained biomarker expression estimation engine based on PLSR and illustrates that the PLSR-based trained biomarker expression estimation engine 210 may be used to provide at least quantitative estimates of biomarker expression levels.

In some embodiments, the biomarker expression estimation engine 210 utilizes T-distributed Stochastic Neighbor Embedding (t-SNE). T-SNE is a nonlinear dimensionality reduction technique well-suited for embedding high-dimensional data for visualization in a low-dimensional space of two or three dimensions. Specifically, it models each high-dimensional object by a two- or three-dimensional point in such a way that similar objects are modeled by nearby points and dissimilar objects are modeled by distant points with high probability.

The t-SNE algorithm comprises two main stages. First, t-SNE constructs a probability distribution over pairs of high-dimensional objects in such a way that similar objects have a high probability of being picked while dissimilar points have an extremely small probability of being picked. Second, t-SNE defines a similar probability distribution over the points in the low-dimensional map, and it minimizes the Kullback-Leibler divergence between the two distributions with respect to the locations of the points in the map. Note that while the original algorithm uses the Euclidean distance between objects as the base of its similarity metric, this should be changed as appropriate. T-SNE is further described in PCT Publication No. WO/2019/084697 and in U.S. Patent Publication Nos. 2018/0356949 and 2018/0340890, the disclosures of which are hereby incorporated by reference herein in their entireties.

In some embodiments, the biomarker expression estimation engine 210 utilizes reinforcement learning. Reinforcement Learning (RL) refers to a type of Machine Learning method in which the agent receives a delayed reward in the next time step to evaluate its previous action. Said another way, RL is model-free machine learning paradigm concerned with how software agents ought to take actions in an environment so as to maximize some notion of cumulative reward. Typically, a RL setup is composed of two components, an agent, and an environment. The environment refers to the object that the agent is acting on, while the agent represents the RL algorithm. The environment starts by sending a state to the agent, which then based on its knowledge to take an action in response to that state. After that, the environment sends a pair of next state and reward back to the agent. The agent will update its knowledge with the reward returned by the environment to evaluate its last action. The loop keeps going on until the environment sends a terminal state, which ends to episode. Reinforcement learning algorithms are further described in U.S. Pat. Nos. 10,279,474 and 7,395,252, the disclosures of which are hereby incorporated by reference herein in their entireties.

In some embodiments, the machine learning algorithm is a Support Vector Machine (“SVM”). In general, an SVM is a classification technique, which is based on statistical learning theory where a nonlinear input data set is converted into a high dimensional linear feature space via kernels for the non-linear case. A support vector machines project a set of training data, E, that represents two different classes into a high-dimensional space by means of a kernel function, K. In this transformed data space, nonlinear data are transformed so that a flat line can be generated (a discriminating hyperplane) to separate the classes so as to maximize the class separation. Testing data are then projected into the high-dimensional space via K, and the test data (such as the features or metrics enumerated below) are classified on the basis of where they fall with respect to the hyperplane. The kernel function K defines the method in which data are projected into the high-dimensional space.

In some embodiments, the biomarker expression estimation engine 210 includes a neural network. In some embodiments, the neural network is configured as a deep learning network. Generally speaking, “deep learning” is a branch of machine learning based on a set of algorithms that attempt to model high level abstractions in data. Deep learning is part of a broader family of machine learning methods based on learning representations of data. An observation can be represented in many ways such as a vector of intensity values per pixel, or in a more abstract way as a set of edges, regions of particular shape, etc. Some representations are better than others at simplifying the learning task. One of the promises of deep learning is replacing handcrafted features with efficient algorithms for unsupervised or semi-supervised feature learning and hierarchical feature extraction.

In some embodiments, the neural network is a generative network. A “generative” network can be generally defined as a model that is probabilistic in nature. In other words, a “generative” network is not one that performs forward simulation or rule-based approaches. Instead, the generative network can be learned (in that its parameters can be learned) based on a suitable set of training data (e.g. a plurality of training spectral data sets). In some embodiments, the neural network is configured as a deep generative network. For example, the network may be configured to have a deep learning architecture in that the network may include multiple layers, which perform a number of algorithms or transformations.

In some embodiments, the neural network includes an autoencoder. An autoencoder neural network is an unsupervised learning algorithm that applies backpropagation, setting the target values to be equal to the inputs. The aim of an autoencoder is to learn a representation (encoding) for a set of data, typically for dimensionality reduction, by training the network to ignore signal “noise.” Along with the reduction side, a reconstructing side is learnt, where the autoencoder tries to generate from the reduced encoding a representation as close as possible to its original input. Additional information regarding autoencoders can be found at http://ufldl.stanford.edu/tutorial/unsupervised/Autoencoders/, the disclosure of which is hereby incorporated by reference herein in its entirety.

In some embodiments, the neural network may be a deep neural network with a set of weights that model the world according to the data that it has been fed to train it. Neural networks typically consist of multiple layers, and the signal path traverses from front to back between the layers. Any neural network may be implemented for this purpose. Suitable neural networks include LeNet, AlexNet, ZFnet, GoogLeNet, VGGNet, VGG16, DenseNet, and the ResNet. In some embodiments, a fully convolutional neural network is utilized, such as described by Long et al., “Fully Convolutional Networks for Semantic Segmentation,” Computer Vision and Pattern Recognition (CVPR), 2015 IEEE Conference, June 20015 (INSPEC Accession Number: 15524435), the disclosure of which is hereby incorporated by reference.

In some embodiments, the neural network is configured as an AlexNet. For example, the classification network structure can be AlexNet. The term “classification network” is used herein to refer to a CNN, which includes one or more fully connected layers. In general, an AlexNet includes a number of convolutional layers (e.g., 5) followed by a number of fully connected layers (e.g., 3) that are, in combination, configured and trained to classify data.

In other embodiments, the neural network is configured as a GoogleNet. While the GoogleNet architecture may include a relatively high number of layers (especially compared to some other neural networks described herein), some of the layers may be operating in parallel, and groups of layers that function in parallel with each other are generally referred to as inception modules. Other of the layers may operate sequentially. Therefore, a GoogleNet is different from other neural networks described herein in that not all of the layers are arranged in a sequential structure. Examples of neural networks configured as GoogleNets are described in “Going Deeper with Convolutions,” by Szegedy et al., CVPR 2015, which is incorporated by reference as if fully set forth herein.

In other embodiments, the neural network is configured as a VGG network. For example, the classification network structure can be VGG. VGG networks were created by increasing the number of convolutional layers while fixing other parameters of the architecture. Adding convolutional layers to increase depth is made possible by using substantially small convolutional filters in all of the layers.

In other embodiments, the neural network is configured as a deep residual network. For example, the classification network structure can be a Deep Residual Net or ResNet. Like some other networks described herein, a deep residual network may include convolutional layers followed by fully connected layers, which are, in combination, configured and trained for detection and/or classification. In a deep residual network, the layers are configured to learn residual functions with reference to the layer inputs, instead of learning unreferenced functions. In particular, instead of hoping each few stacked layers directly fit a desired underlying mapping, these layers are explicitly allowed to fit a residual mapping, which is realized by feedforward neural networks with shortcut connections. Shortcut connections are connections that skip one or more layers.

A deep residual net may be created by taking a plain neural network structure that includes convolutional layers and inserting shortcut connections which thereby takes the plain neural network and turns it into its residual learning counterpart. Examples of deep residual nets are described in “Deep Residual Learning for Image Recognition” by He et al., NIPS 2015, which is incorporated by reference as if fully set forth herein. The neural networks described herein may be further configured as described in this reference.

Training an Biomarker Expression Estimation Engine

In some embodiments, the biomarker expression estimation engine 210 is adapted to operate in a training mode. In some embodiments, the training module 211 may operate to provide training spectral data to the biomarker expression estimation engine 210 and to operate the biomarker expression estimation engine 210 in its training mode in accordance with any suitable training algorithm. In some embodiments, a training module 211 is in communication with the biomarker expression estimation engine 210 and is configured to receive training spectral data (or a further processed variants of the training absorbance spectra data, e.g. a first or second derivative of the training spectral data, magnitudes of individual bands within the training spectra data, the integral of bands within the training spectral data, the ratio of two or more band intensities within the training spectral data, the ratios from second and third order derivatives of the training spectral data, etc.) and supply the training spectral data to the biomarker expression estimation engine 210.

In some embodiments, the training module 211 is also adapted to supply the class labels associated with the training spectral data, including actual biomarker expression values (e.g. percent positivity, staining intensity). In some embodiments, the class labels associated with the training spectral data may include actual biomarker expression values (such as those ascertained by a trained pathologist or those computed using one or more image analysis algorithms) as well as information pertaining to sample preparation prior to staining (e.g. fixation status, unmasking status).

In some embodiments, the training algorithms utilize a known set of training vibrational spectral data (such as described herein) and a corresponding set of known output class labels (e.g. biomarker expression levels, etc.), and are configured to vary internal connections within the biomarker expression estimation engine 210 such that processing of input training spectral data provides the desired corresponding class labels.

The biomarker expression estimation engine 210 may be trained in accordance with any methods known to those of ordinary skill in the art. For example, any of the training methods disclosed in U.S. Patent Publication Nos. 2018/0268255, 2019/0102675, 2015/0356461, 2016/0132786, 2018/0240010, and 2019/0108344, the disclosures of which are hereby incorporated by reference herein in their entireties.

In some embodiments, the biomarker expression estimation engine 210 is trained using a cross-validation method. Cross-validation is a technique that can be used to aid in model selection and/or parameter tuning when developing a classifier. Cross-validation uses one or more subsets of cases from the set of labeled cases as a test set. For example, in k-fold cross-validation, a set of labeled cases is equally divided into k “folds,” e.g. K-fold cross-validation is a resampling procedure used to evaluate machine learning models. A series of train-then-test cycles is performed, iterating through the k folds such that in each cycle a different fold is used as a test set while the remaining folds are used as the training set. Since each fold is used as the test set at some point, non-randomly selected cases in the set of labeled cases would seemingly bias the cross-validation. For example, in the scenario of 5-fold cross validation (k=5), the data set is split into 5 folds. In the first iteration, the first fold is used to test the model and the rest are used to train the model. In the second iteration, 2nd fold is used as the testing set while the rest serve as the training set. This process is repeated until each fold of the 5 folds have been used as the testing set. Methods of performing k-fold cross validation are further described in US Patent Publication Nos.: 2014/0279734 and 2005/0234753, the disclosures of which are hereby incorporated by reference herein in their entireties.

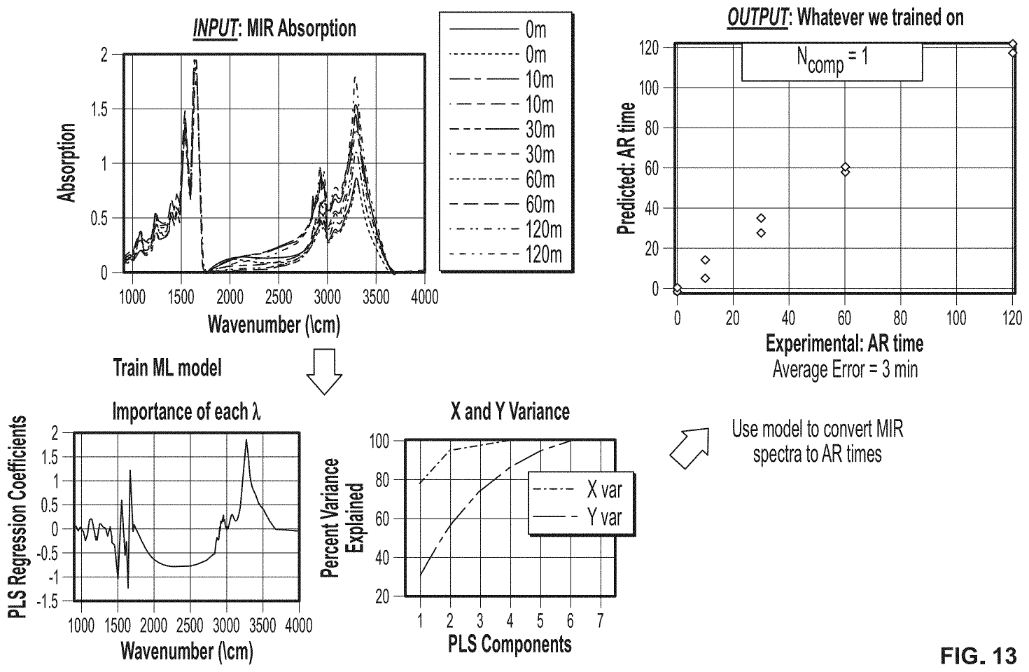

In the context of a biomarker expression estimation engine 210 which utilizes a machine learning algorithm based on PLSR, FIG. 13 illustrate show the PLSR model is trained to mine the vibrational spectra for biomarker expression features within the training spectra. In some embodiments, the PLSR model is also trained to recognize the changes in these features for different types of tissues and/or for different types of molecules (proteins, nucleic acids). In some embodiments, the PLSR algorithm takes the vibrational spectral data (e.g. absorption spectra, first derivative, second derivative) and creates a model that is used to determine which features (wavelengths) are most predictive of the response variable (biomarker expression, etc.). In some embodiments, the generated model may be further evaluated for performance using the same and unknown vibrational spectral data for performance evaluation and optimization.

In the context of a biomarker expression estimation engine 210 which utilizes a machine learning algorithm based on principal component analysis, a PCA is performed on an initial training data set of a default sample size to generate a PCA transform matrix. A second PCA is performed on a combined data set which includes the initial training data set and a test data set. The number of samples in initial training data set is then incremented to generate an expanded training data set. A PCA of the expanded training data set is performed to determine if the PCA number for the expanded training data set is the same as for the initial training data set. If so, the error between the initial test data set and the expanded test data set is assessed based on the PCA signals and PCA transform matrix to estimate a final solution error. The PCA matrix of the combined data set is transformed back to the initial training data set domain (e.g., spectral domain) using the transform matrix from the first PCA to generate a test data set estimate. The method iterates with the size of the training matrix expanding until the PCA number converges and a final error target is achieved. Upon reaching the error target, the training data set of the identified size adequately represents the training target function information contained in the specified input parameter range. A machine learning system (e.g. the biomarker expression estimation engine 210) may then be trained with the training matrix of the identified size. Additional aspects of training using PCA are disclosed in U.S. Pat. Nos. 8,452,718 and 7,734,087, the disclosures of which are hereby incorporated by reference herein in their entireties.

In embodiments where the biomarker expression estimation engine 210 includes a neural network, a back-propagation algorithm may be used for training the biomarker expression estimation engine 210. Back propagation is an iterative process in which the connections between network nodes are given some random initial values, and the network is operated to calculate corresponding output vectors for a set of input vectors (the training spectral data set). The output vectors are compared to the desired output of the training spectral data set and the error between the desired and actual output is calculated. The calculated error is propagated back from the output nodes to the input nodes and is used for modifying the values of the network connection weights in order to decrease the error. After each such iteration the training module 211 may calculate a total error for the entire training set and the training module 211 may then repeat the process with another iteration. The training of the biomarker expression estimation engine 210 is complete when the total error reaches a minimum value. If a minimum value of the total error is not reached after a predetermined number of iterations and if the total error is not a constant the training module 211 may consider that the training process does not converge.

In the context of training with acquired spectral data derived from a plurality of differentially prepared, stained training tissue samples as described above, each acquired training spectrum is associated with known expression levels of one or more biomarkers (where the known expression levels of the one or more biomarkers serve as class labels, as described herein). In some embodiments, and again in the context of training with acquired spectral data derived from a plurality of differentially prepared, stained training tissue samples, each acquired training spectrum may be associated with (i) known expression levels of one or more biomarkers, and (ii) known sample preparation conditions and/or sample preparation status (e.g. fixation duration, fixation quality, unmasking conditions, unmasking status). For example, the two training spectral data sets illustrated in FIG. 4B (see dotted line boxes setting forth sets 1 and 2) may be provided to the training module 211 for training of the biomarker expression estimation engine 210, along with the known expression levels of the one or more biomarkers, and any additional class labels.

When the training of the biomarker expression estimation engine 210 is complete, the system 200 is ready to operate for detect biomarker expression features within test spectral data and, based on the detected biomarker expression features, estimate an expression level of one or more biomarkers within an unstained test biological specimen. In some embodiments, the biomarker expression estimation engine 210 may be periodically retrained to adapt for variations in input data.

Estimation of Biomarker Expression

Once the biomarker expression estimation engine 210 has been appropriately trained, such as described above, it may be used to detect biomarker expression features within test vibrational spectral data, such as test spectral data acquired from an unstained test biological specimen, and, based on the detected biomarker expression features, predict the expression of one or more biomarkers in the unstained test biological specimen. In some embodiments, and with reference to FIG. 3, an unstained test biological specimen is obtained (step 310) (such as from a subject suspected of having a certain disease or known to have a certain disease) and then test vibrational spectral data is acquired from that unstained test biological specimen (step 320) (see also FIG. 7). In some embodiments, the test vibrational spectral data includes absorbance spectra, the first and/or second derivatives of the absorbance spectra, magnitudes of individual bands within the training spectra data, the integral of bands within the training spectral data, the ratio of two or more band intensities within the training spectral data, the ratios from second and third order derivatives of the training spectral data, etc.

Once test spectral data and/or the variants thereof described above have been acquired and processed, biomarker expression features may be derived from the test spectral data using the trained biomarker expression estimation engine 210 (step 340). In some embodiments, the derived biomarker expression features include a mapping of how relevant each wavenumber is to predicting retrieval status. Values close to zero have little significance. In some embodiments, biomarker expression features that may be detected include peak amplitudes, peak positions, peak ratios, a sum of spectral values (such as the integral over a certain spectral range), one or more changes in slope (first derivative) or changes in curvature (second derivative), etc. Based on the derived biomarker expression features, an estimate of the expression of one or more biomarkers may be computed (step 350). In some embodiments, the estimated expression of one or more biomarkers includes a quantitative estimation of a staining intensity of one or more biomarkers and/or a quantitative estimation of a percent positivity of one or more biomarkers, enabling “label-less” scoring of the expression of one or more biomarkers.

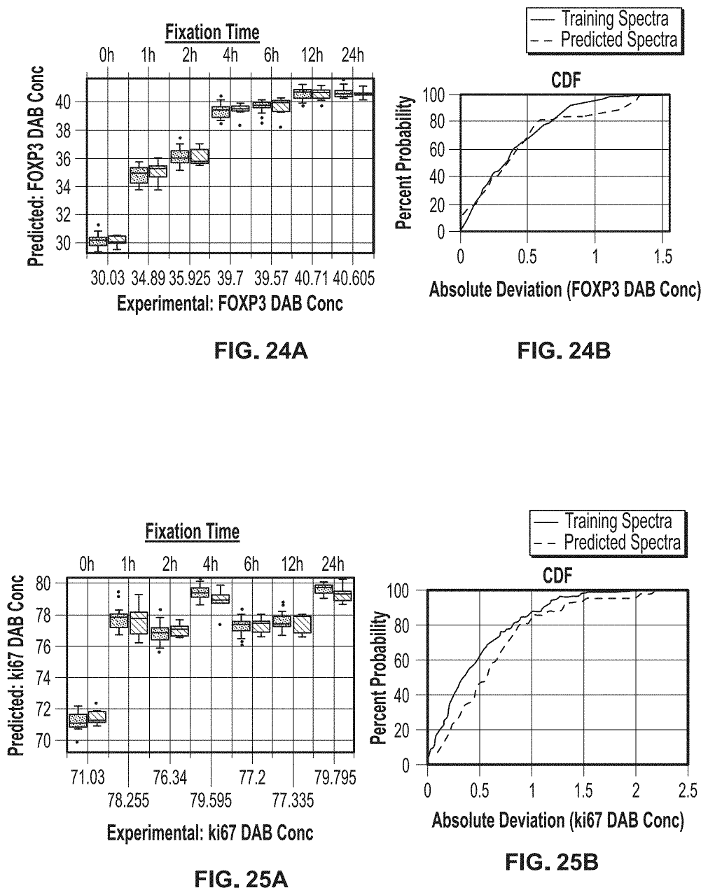

FIGS. 23A, 24A, and 25A each illustrate measured (experimental) staining intensity levels of BCL2 (FIG. 23A), FOXP3 (FIG. 24A), and ki-67 (FIG. 25A) versus predicted staining intensity levels of BLC2, FOXP3, and ki-67 positive cells. In each instance, a separate model was trained that was able to predict the stain intensity of each of the three biomarkers using the MID-IR spectra (see Example 4). For this example, the first derivative spectra were used and the two regions of spectra 1750-2800 cm⁻¹ and 3700-4000 cm⁻¹ were set to zero, although a different number of components in each model were necessary to achieve ideal performance.

As can be seen from the data in FIGS. 23A, 24A, and 25A, the methods of the present disclosure are able to predict biomarker intensity for all three proteins despite the significantly varied expressions intensities across fixation times. FIGS. 23A, 24A, and 25A each illustrate that a biomarker expression estimation engine 210 trained with data pertaining to the expression levels (e.g. staining intensity levels, such as the staining intensity of the DAB) of one or more biomarkers at various fixation durations may be used to quantitatively predict the expression levels of one or more biomarkers and can do so with high accuracy. FIGS. 23B, 24B, and 25B set forth cumulative distribution functions (CDF) for estimated and predicted DAB staining for each of the aforementioned biomarkers.

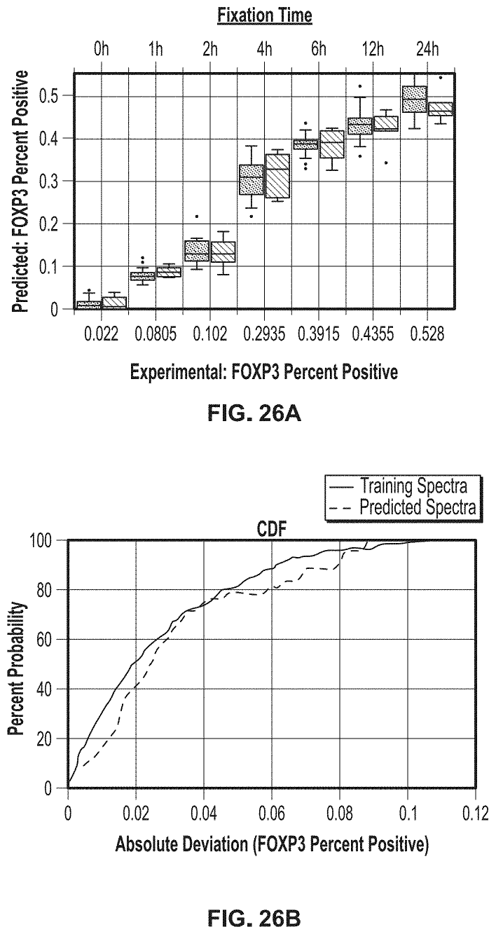

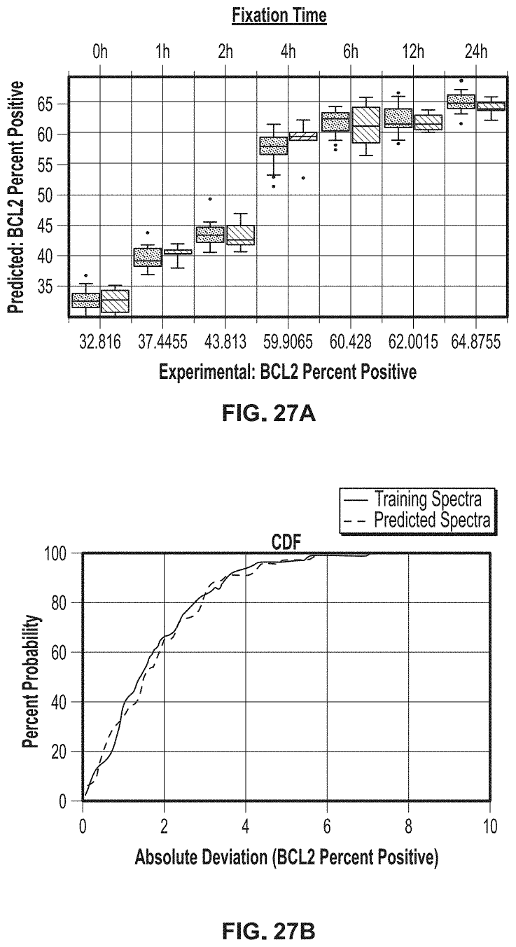

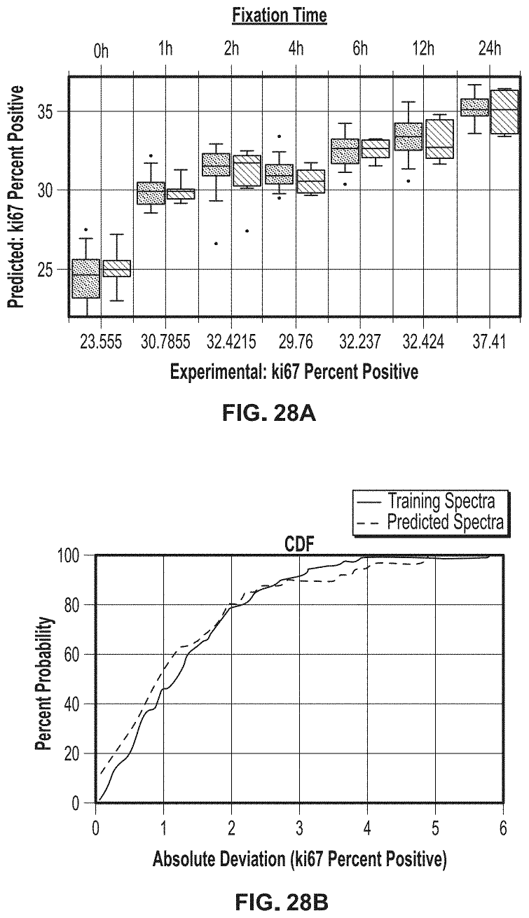

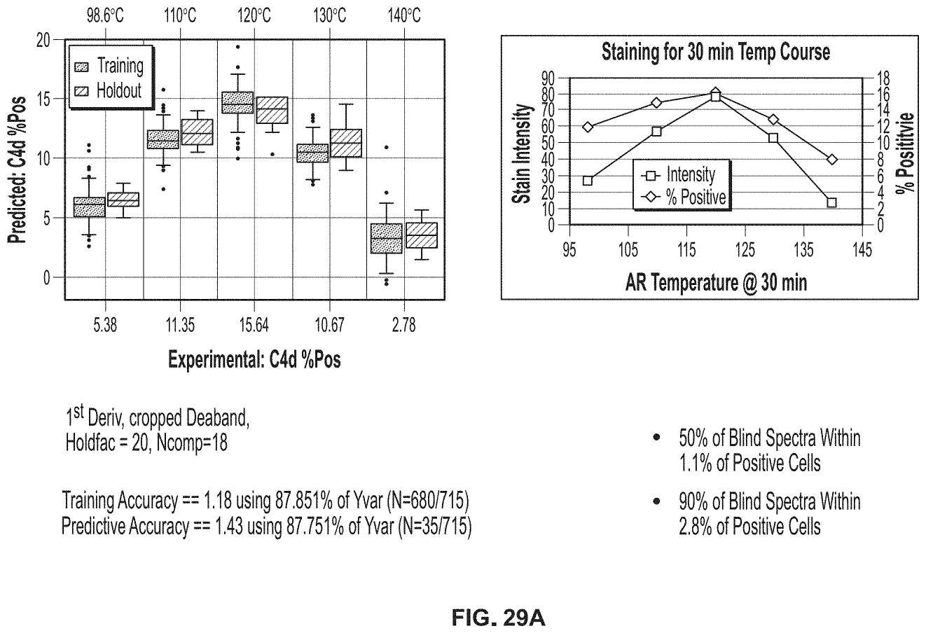

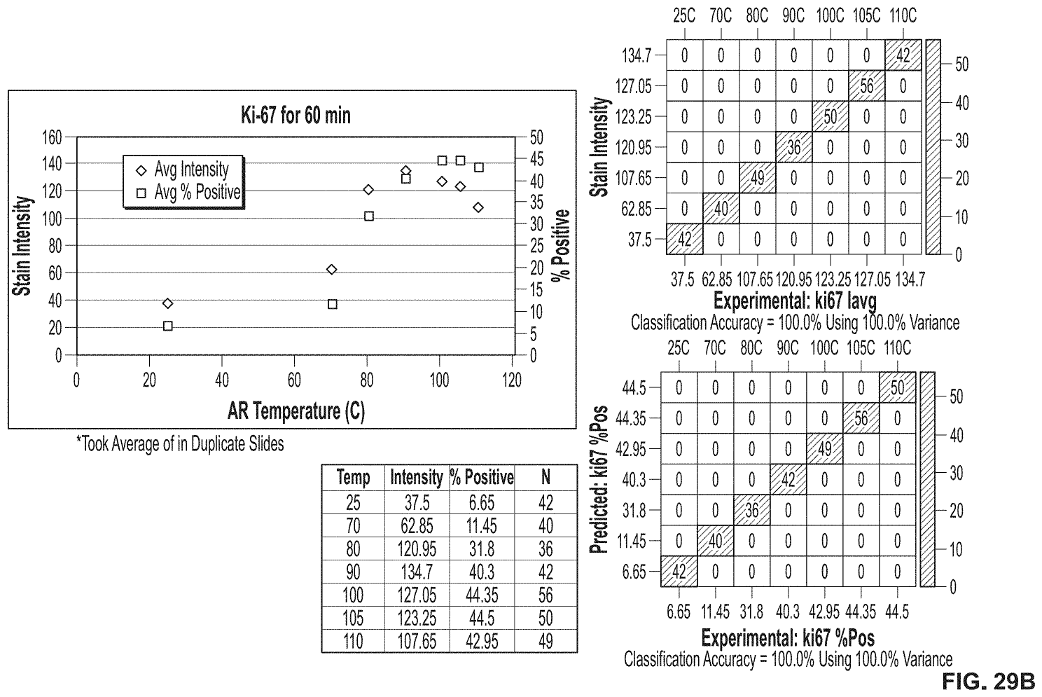

FIGS. 26A, 27A, and 28A each illustrate measured (experimental) expression levels of FOXP3 (FIG. 27A), BCL2 (FIG. 27A), and ki-67 (FIG. 28A) positive cells versus predicted expression levels (percent positivity) of FOXP3, BLC2, and ki-67 positive cells. FIGS. 26A, 27A, and 28A each illustrate that a biomarker expression estimation engine 210 trained with data pertaining to the expression levels of one or more biomarkers at various fixation durations may be used to quantitatively predict the expression levels of one or more biomarkers and can do so with high accuracy. FIGS. 26B, 27B, and 28B set forth cumulative distribution functions (CDF) for the estimated and predicted percent of the tissue positive for each of the aforementioned biomarkers.

FIGS. 15 and 16 illustrate the results achieved using a trained biomarker expression estimation engine 210 to determine the expression of two different biomarkers in tissue samples having unknown fixation times. FIGS. 15 and 16 comparatively illustrate the predicted percent positivity of two different biomarkers (cd4 and life-67) using the systems and methods described herein to known (e.g. experimentally derived values, such as derived after tissue staining and analysis with a detection and classification algorithm) percent positivity values for differentially unmasked test biological specimens having been fixed for unknown durations. As illustrated in at least these figures, the biomarker expression estimation engine 210 is able to accurately predict biomarker expression information across differentially unmasked specimens (and, where the fixation status of the samples were unknown).

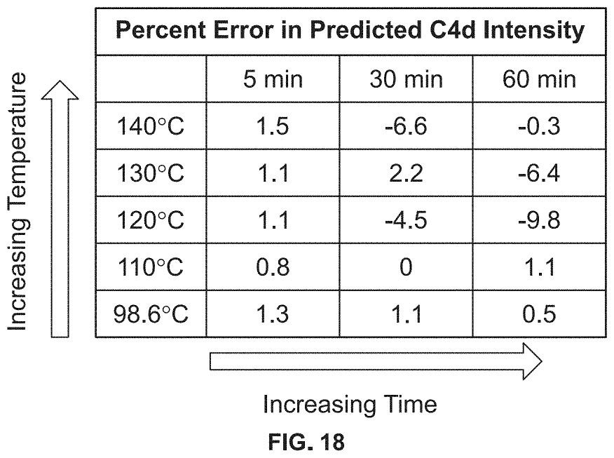

FIG. 18 further illustrates the predictive power of the systems and methods of the present disclosure. Indeed, FIG. 18 illustrates prediction accuracy of the trained biomarker expression estimation engine across all times and temperatures in a blinded tonsil sample of unknown fixation duration. Across all tested times and temperatures, the trained biomarker expression estimation engine was able to predict functional C4d stain intensity to better than about 10%. Values at the intersection of time and temperature indicate the percent error between the predicted and actual C4d stain intensity.

In this example, three separate PLSR prediction engines were trained. In the first model, tissues were retrieved at various temperatures (98.6° C., 110° C., 120° C., 130° C., and 140° C.) for a duration of about 5 minutes each. Several tissues were treated as training sets, meaning they were imaged with a MID-IR microscope and a PLSR model was trained on that dataset. A blinded tissue was then imaged with the MID-IR microscope and the trained biomarker expression estimation engine was used to calculate how much C4d stain that tissue was expected to stain. The model's predicted value was compared with the average stain intensity, as calculated from digitally analyzing brightfield DAB images, and the percent error was calculated in a standard fashion, as 100*(MID-IR predicted staining−Brightfield ground truth staining)/Brightfield ground truth staining.

This process was then repeated for the same antigen retrieval temperatures but using retrieval durations of 30 minutes and 60 minutes. Thus, three separate engines were trained and validated in this example. In view of the foregoing, in some embodiments, the data may be used to train a holistic prediction model that is able to determine biomarker staining regardless of the retrieval time and temperature of the sample exclusively based on acquired MID-IR spectra from a specimen.

In embodiments where the biomarker expression estimation engine 210 is trained with class labels including biomarker expression levels and sample preparation status (e.g. fixation status and/or unmasking status), the trained biomarker expression estimation engine 210 may further provide as an output a predicted difference between (i) an expression level of one or more biomarkers of the test specimen based on the preparation status of the test specimen (e.g. a fixation duration), and (ii) an expected expression level of one or more biomarkers of the same test specimen prepared under different conditions (e.g. a sample fixed for a different period of time). It is believed that this may be useful in those instances where the test biological specimen was not fixed for a sufficient duration and/or not unmasked properly and thus the fixation duration and/or the unmasking status for the biomarker of interest may be deemed “inadequate.” In some embodiments, the predicted difference may be used such that an expression level of the one or more biomarkers is increased or decreased based on the fixation duration and/or unmasking status, and that increased or decreased fixation level or change in unmasking status may be used for downstream scoring.

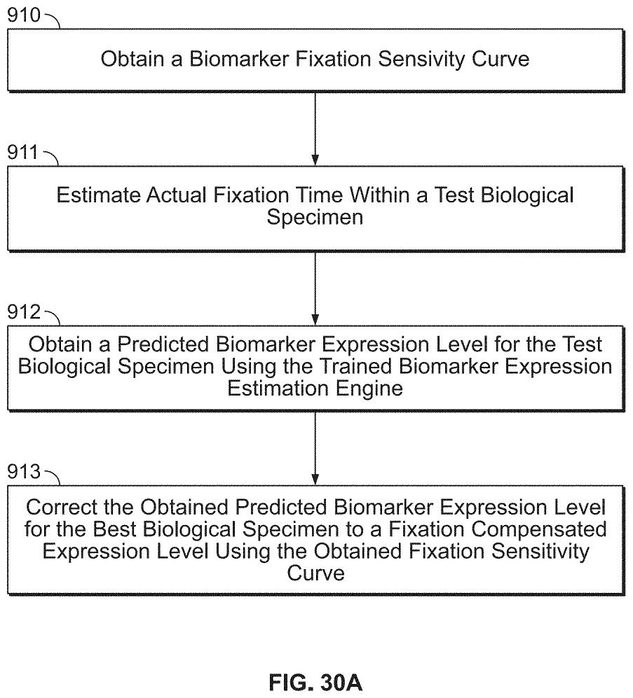

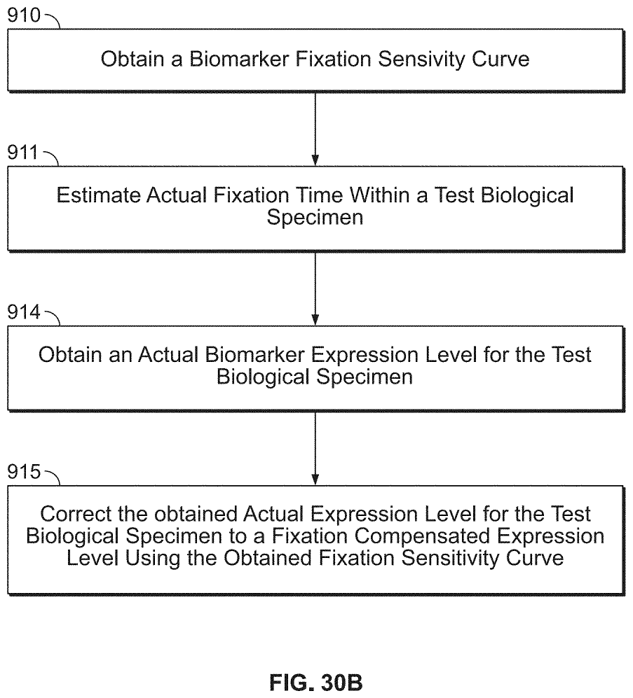

With reference to FIG. 30A, in some embodiments, the system further includes operations for correcting the predicated expression of the one or more biomarkers for poor unmasking and/or poor fixation of the test biological specimen. For example, a biomarker fixation sensitivity curve may be obtained (step 910). An example of a suitable biomarker fixation sensitivity curve is illustrated in FIG. 9D. There, the graph illustrates the normalized percent positivities for three different biomarkers versus fixation time and, more specifically, where the mean expression is plotted on a normalized scale so relative changes in each biomarker versus fixation time can be observed and, as in this example, used as a biomarker fixation sensitivity curve in correcting an obtained predicted biomarker expression level.

Next, a fixation time of a test biological specimen is obtained (step 911). Subsequently, the trained biomarker expression estimation engine of the present disclosure is used to obtain a predicted biomarker expression level for the test biological specimen (912). In some embodiments, the test biological specimen is an unstained test biological specimen. At step 913, the obtained predicted biomarker expression level for the test biological specimen is corrected to provide a fixation compensated expression level using the obtained fixation sensitivity curve. FIG. 30B illustrates an alternative method where actual biomarker expression levels are measured (step 914) and then compensated for using the obtained fixation sensitivity curve (step 915).

In some embodiments, the systems of the present disclosure may include one or more scoring modules such that one or more expression scores (H-scores, etc.) may be estimated based on the predicted biomarker expression data received as output. Any of the scoring methods disclosed in US Patent Publication No. 2015/0347702, the disclosure of which is hereby incorporated by reference herein in its entirety, may be utilized for determining a biomarker expression score where biomarker expression values are estimated using the trained biomarker expression estimation engine 210 described herein.

In some embodiments, the information provided as output may be used in further downstream processes and may be used to render decisions as to whether the test biological specimen should be treated with one or more specific binding entities.

### Example 1

Provided herewith is a comparison of the expression of three different biomarkers (BCL2, FOXP3, and ki67) versus fixation time. The tissue blocks for each fixation time were stained for each biomarker and the expression across the whole slide was quantified with an image analysis algorithm (e.g. one adapted to quantitatively determine expression levels for each stain, such as an automated algorithm which first segments the tissue on the slide and then determines regions of the tissue that were not of interest; the algorithm would then automatically determine whether the tissue was positive or negative for a given protein biomarker). Summary results in the form of box and whisker plots versus fixation time are displayed in FIGS. 9A, 9B, and 9C for BCL2, ki-67, and FOXP3, respectively. BCL2 and FOXP3 were found to be particularly labile and susceptible to improper fixation, as seen by their expression levels steadily increasing monotonically with fixation time.

On the other hand, ki-67 was found to be relatively robust to improper fixation as long as the biospecimen was fixed in NBF for at least 1 hour. Finally, these three figures are summarized in FIG. 9D, which displays the average expression level for each biomarker versus fixation time on a scale normalized to the maximum expression at 24 hours for all three biomarkers.

Turning to FIGS. 20, 21, and 22, biomarker expression levels of staining tissue/cells were analyzing digitally, and the relative concentration of each biomarker was quantified, results are shown below indicating that tissues that have been fixed longer tend to stain more intensely/darker. Box and whisker plots versus fixation time are again illustrated. Similar to that noted above, BCL2 and FOXP3 were found to be particularly labile and susceptible to improper fixation, as seen by their expression levels steadily increasing monotonically with fixation time. On the other hand, Ki-67 was found to be relatively robust to improper fixation.

### Example 2

MirrIR microscope slides (Kevley Technologies, Chesterland, Ohio) for reflective infrared studies were used for the mid-IR spectra measurements. Four-micron serial sections of formalin-fixed paraffin-embedded (FFPE) tonsil tissue were placed on pre-treated MirrIR slides. Deparaffinization of tonsil tissue was performed manually according to OP2100-025. Briefly, after xylene steps slides were hydrated through descending grades of ethanol and then transferred in the VENTANA Cell Conditioning 1 (CC1) solution to the Rapid Antigen Retrieval (RAR) test-bed.

Antigen retrieval was performed in CC1 solution in the RAR chamber, which was pre-pressurized to 30 psi before heaters were turned on. The total heating time for any given experiment included 90 seconds ramp-up time and 2 minutes of cooling time. After the antigen retrieval step, the slides were gently washed in deionized water and air-dried at room temperature. Dried slides with intact tonsil tissues were used for the mid-IR measurements. Description of individual antigen retrieval experiments is in LN #3685 (Bohuslav Dvorak), pages 52-59 and 64-69.

Immunoreactivity data was collected for all samples and treatments analyzed with mid-IR spectroscopy. Briefly, samples were processed using a hybrid procedure where deparaffinization and antigen retrieval were performed manually. Deparaffinization (depar) was performed using xylene followed by rehydration through a graded alcohol series according to OP2100-025. Samples were then placed in CC1 (catalog number: 950-124). After antigen retrieval samples were transferred in reaction buffer (catalog number: 950-300) to a BenchMark UTLRA instrument for subsequent processing steps from peroxide inhibitor through counterstain.

For the studies presented here, tonsil samples were labeled with antisera raised against Ki-67 (30-9) or C4d (SP91). These markers were selected because they show different responses to increasing antigen retrieval treatments. It was discovered that Ki-67 increases in stain intensity and number of labeled cells to a point after which intensity and positivity decrease.

Conversely, it was discovered that C4d continues to increase in intensity and positivity through antigen retrieval conditions that otherwise damage the sample. C4d was additionally selected because it displays poor performance when treated with current retrieval methods, but clear immunoreactivity when treated with high temperature antigen retrieval (this behavior is described in detail in the addendum to D081973 entitled Stain Quality Improvements from Rapid Antigen Retrieval).

### Example 3—Estimation of Biomarker Expression Using a Trained Biomarker Expression Estimation Engine

Overview

This experiment utilized mid-infrared (mid-IR) spectroscopy to interrogate the vibrational state of molecules in histological tissue sections. In this work changes in the mid-IR spectra due to differentially retrieved tonsil tissues were studied and used to train a biomarker expression estimation engine. The identified shifts in the mid-IR spectra were correlated with immunohistochemical (IHC) staining for Ki-67 and C4d proteins.

Introduction

Mid infrared spectroscopy (mid-IR) is a powerful optical technique that probes the vibrational state of individual molecules in the tissue and is very sensitive to the conformational state of proteins. This extreme sensitivity makes mid-IR spectroscopy ideally suited for microscopy applications because the presence and even conformational state of endogenous and exogenous materials manifest through changes in the mid-IR absorption profile of the biospecimen. Vibrational spectroscopy has even been used for diagnostic applications, for example to distinguish healthy from cancerous tissue.

Method and Materials

Retrieval Procedure

MirrIR microscope slides (Kevley Technologies, Chesterland, Ohio) for reflective infrared studies were used for the mid-IR spectra measurements. Four-micron serial sections of formalin-fixed paraffin-embedded (FFPE) tonsil tissue were placed on pre-treated MirrIR slides. Deparaffinization of tonsil tissue was performed manually according to OP2100-025. Briefly, after xylene steps slides were hydrated through descending grades of ethanol and then transferred in the VENTANA Cell Conditioning 1 (CC1) solution to the Rapid Antigen Retrieval (RAR) test-bed.

The antigen retrieval step was performed in CC1 solution in the RAR chamber, which was pre-pressurized to 30 psi before heaters were turned on. The total heating time for any given experiment included 90 seconds ramp-up time and 2 minutes of cooling time. After the antigen retrieval step, the slides were gently washed in deionized water and air-dried at room temperature. Dried slides with intact tonsil tissues were used for the mid-IR measurements. Description of individual antigen retrieval experiments is in LN #3685 (Bohuslav Dvorak), pages 52-59 and 64-69.

IHC Staining and Quantitation

Immunoreactivity data was collected for all samples and treatments analyzed with mid-IR spectroscopy. These samples were generated using the methods described in detail in D081973 Rapid Antigen Retrieval Product and Process Feasibility Report. Briefly, samples were processed using a hybrid procedure where deparaffinization and antigen retrieval were performed manually. Deparaffinization (depar) was performed using xylene followed by rehydration through a graded alcohol series according to OP2100-025. Samples were then placed in CC1 (catalog number: 950-124).

Antigen retrieval was performed using RAR test-beds (Part number: 101430300) for the times and at the temperature settings described in this report. After antigen retrieval samples were transferred in reaction buffer (catalog number: 950-300) to a BenchMark UTLRA instrument for subsequent processing steps from peroxide inhibitor through counterstain.

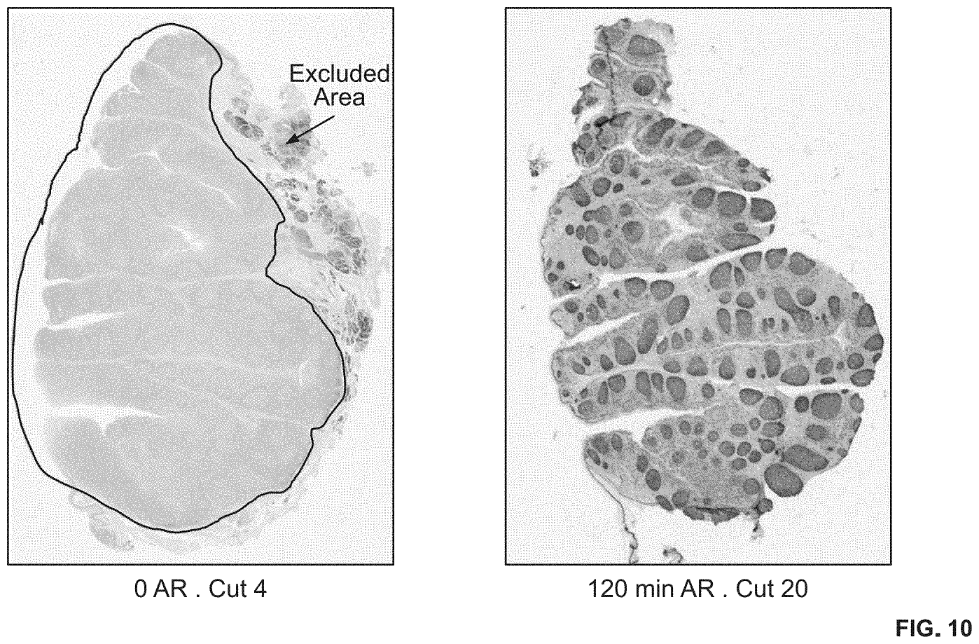

Sample slides were scanned using a Leica Aperio AT2 (Leica Biosystems, Nussloch, Germany) slide scanner and the intensity of immunoreactivity and the proportion of tissue stained was quantified using the “Positive Pixel Count v9” algorithm supplied with Aperio Imagescope software. For each tissue, a region of interest (ROI) was selected to include tonsil tissue expected to stain. Connective tissue which showed high background with some staining treatments but that was missing in others was excluded as illustrated in FIG. 10.

This method of quantification produces intensity units that are repeatable across samples and can be compared within an experiment. However, no attempt was made to map or reconcile the intensity measurements, or the percentage of positive pixels reported to pathologist scores.

Collection of Mid-IR Data

The mid-IR spectra were collected on a Fourier Transform Infrared (FTIR) microscope (Bruker Hyperion 3000, Bruker Optics, Billerica Mass.) with an attached optical interferometer (Vertex 70). Serial sections from tonsil blocks were sectioned 4 micrometer thick onto mid-IR reflective slides (Kevley Technologies, MirrIR), differentially retrieval, and imaged with the mid-IR microscope.

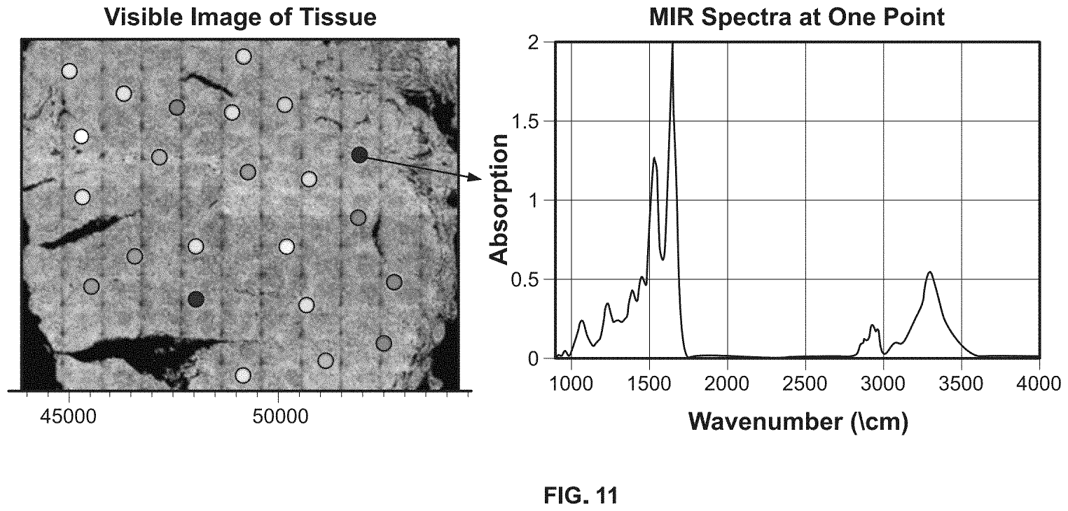

Tonsils tissue sections retrieved under different experimental conditions were placed on the FTIR microscope and the entire tissue section was imaged with a visible objective by raster scanning the field of view (FOV). The Bruker software OPUS was used to randomly select regions of tissue from which mid-IR spectra were collected using a mercury-cadmium-telluride (MCT) detector. Typically, 20-80 spectra were collected from each tissue sample. Absorption spectra were collected at a resolution of 4 cm-1 and each selected ROI was sampled 64 times and these spectra were averaged together to yield the final spectra for a given position. An example tissue image, sampling pattern and the resulting average spectra for a single ROI are shown below in FIG. 11. All spectra were collected with a 15× IR objective producing roughly a 200 μm×200 μm FOV.

Preprocessing Mid-IR Data

Collected spectra were preprocessed to remove artifacts, standardize the format of the spectra, and to isolate the mid-IR absorption of the tissue. The microscope directly measures mid-IR transmission. To convert transmission spectra to absorption spectra a reference transmission spectrum was collected at a spatial location outside of the sample and used to divide the spectrum collected through the tissue. This calculation provides the amount of light attenuated (absorbed+scattered) by the tissue. Next, atmospheric absorption, primarily from water vapor and carbon dioxide, were removed using algorithms in the OPUS software. Baseline correction was then used to correct for tissue scattering using a concave rubberband correction (8 iterations, 64 baseline points). The resulting spectrum represents absorption by the sample tissue. Finally, all spectra were normalized to a maximum value of 2 to mitigate differences in section thickness and tissue density.

Experimental Design and Results

Variation of the Antigen Retrieval Time at Constant Antigen Retrieval Temperature

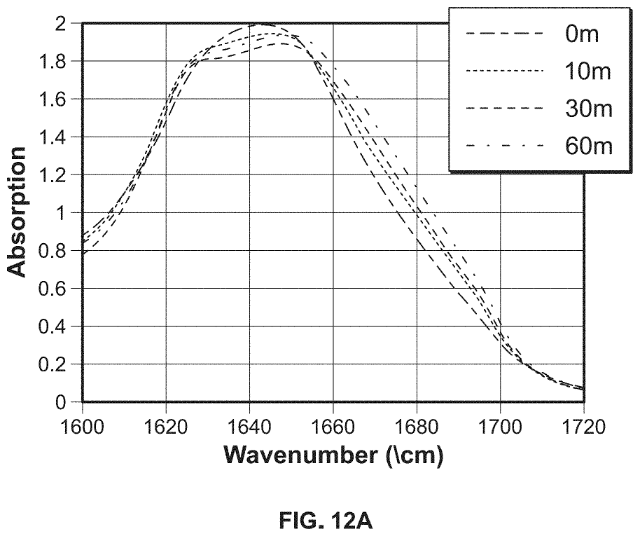

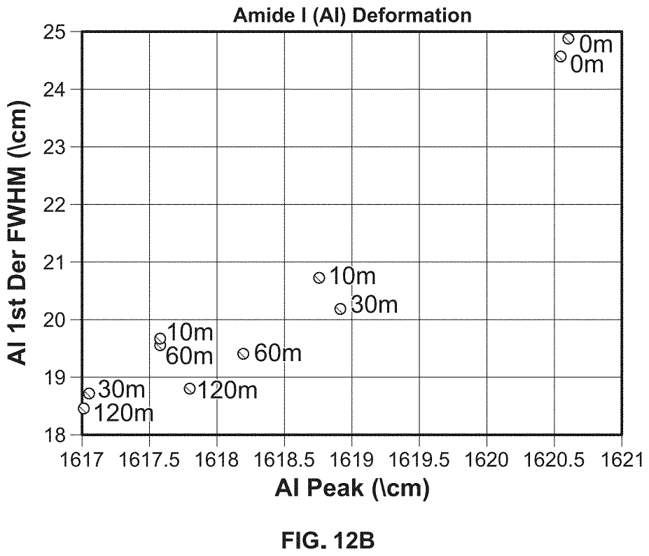

In this experiment, antigen retrieval was performed on tonsil tissue at 98.6 C for either 0, 10, 30, 60, or 120 minutes. Each treatment was run on duplicate samples. The mid-IR spectra show a conspicuous shift in the primary protein band, referred to as the Amide I band, that was loosely correlated with antigen retrieval treatment. Examples of this Amide I shift are shown in FIG. 12A. Quantification of the Amide I band's peak wavelength versus full width at half maximum (FWHM) enables course discrimination of antigen retrieval treatment into un-retrieved and partially, fully, and over retrieved (FIG. 12B).

Multiple other metrics were evaluated throughout this project including principal component analysis, integration of the Amide I band, normalization to several bands to correct for scattering, and quantitation of the methyl and methylene peaks. Unfortunately, none of these other metrics were able to improve the level of stratification of the antigen retrieval status of tissue. In the end, a supervised machine learning model was established to make use of non-obvious signatures in the mid-IR spectra that indicated the expression level of one or more biomarkers.

These small differences in spectra were identified using the projection onto latent structure regression (PLSR) method. This algorithm takes the mid-IR signal (e.g. absorption spectra, 1st derivative, 2nd derivative) and creates a model that is used to determine which features (wavelengths) are most predictive of the response variable (antigen retrieval status, target retrieval status, etc.). The generated model was then evaluated for performance using the same and unknown mid-IR data for performance evaluation and optimization. FIG. 13 illustrates how the PLSR model is trained to mine the mid-IR spectra for the antigen retrieval signature. In this experiment the model had an accuracy of 3 minutes.

These studies demonstrate that the supervised machine learning model is able to mine the data and develop a model that can be used to determine the biomarker expression levels in a tonsil sample. To further verify that the model recognizes a true biomarker expression signature, a series of spectra that the algorithm was not trained on were given to the model to determine how well it could make blinded predictions. In addition, it has been demonstrated that the PLSR model can correlate differences in the mid-IR spectra with IHC staining intensity for Ki-67 and C4d proteins (see FIGS. 15 and 16) for samples having unknown fixation times.

Variation of the Antigen Retrieval Time and Temperature

In this study, the mid-IR spectra coupled with machine learning models was investigated to determine whether it could be used to estimate the expression of one or more biomarkers (e.g. percent positivity; staining intensity) of a sample for which the fixation time was unknown and whose unmasking conditions were varied. Five multi-tissue slides with four separate tonsil tissues were retrieved for 5 minutes at temperatures between 98.6° C. and 140° C.

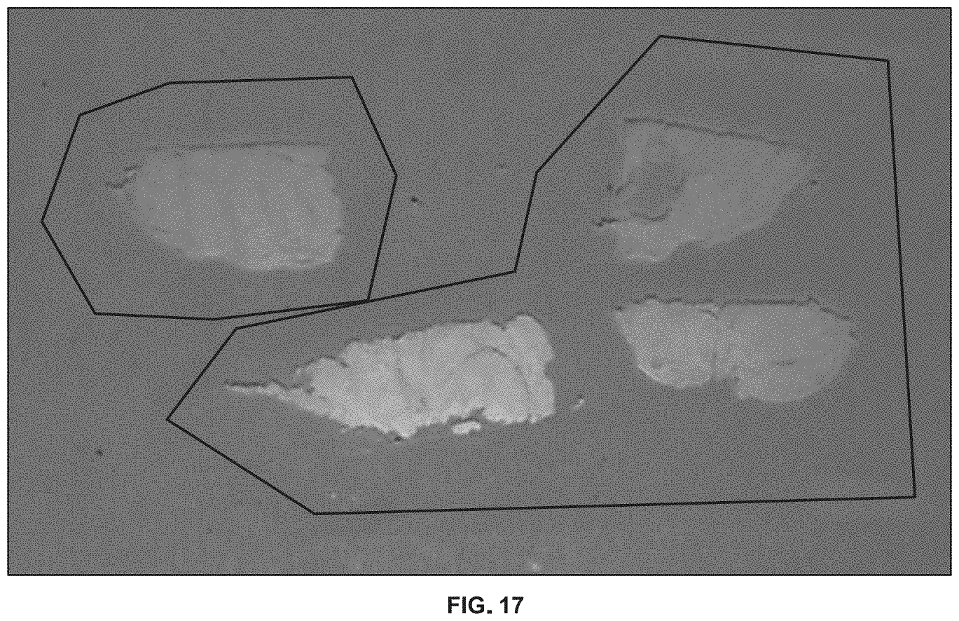

The mid-IR spectra from three tonsil tissues (FIG. 17, portion circled that includes three tissue specimens) were used to train the PLSR model. This model was then used to infer the antigen retrieval conditions in the “unknown” tonsil tissue (FIG. 17, circled portion that includes only a single tissue specimen). The results from FIG. 11 demonstrate, at least in tonsil tissue, that across all times and temperatures the mid-IR spectra coupled with PLSR is able to accurately quantify the degree to which an unknown sample is retrieved, and the degree to which an unknown sample will stain for C4d. This is of critical importance because time and temperature are the two most important variables that impact antigen retrieval.

### Example 4—Training a Predictive Stain Area or Intensity Model

A PLSR model may be trained using functional staining data. In this case, the process by which input data (spectra) are selected and curated would be similar to training a model to predict fixation time. However, the training would be different. In this case all slides are imaged with a bright-field scanner and fed into a digital pathology algorithm. In order to get meaningful protein expression data all non-staining regions of the tissue (stroma, connective tissue, holes, overlapping tissue/folds) are removed for the analysis area. Cells that are determined to be positive for a protein, are identified and the region of active tissue that is positive for a given biomarker is quantified digitally. Slides are then characterized by the percent positivity of the tissue, meaning the percent of the tissues potentially staining area that is actually staining. This process is repeated for all tissues. A model can then be trained according to one of two processes:

(a) the average biomarker expression for a given fixation time. All tissue from a given fixation time are trained to yield the average expression of the protein of interest. Similar to training model for fixation time because all tissues for a given fixation time are trained for the same output (fixation time/quality). Pros and cons: Less noisy, model optimized for average performance, and can be trained with less data.

(b) a model can be trained using the biomarker expression for each tissue individually. For instance, if two tissues of the same fixation time have different biomarker expression their spectra will be mined individually to find spectral feature that best account for the differential staining. Benefits: More powerful and generalizable model, model optimized for individual performance, required large training set.

An alternative method to determine functional staining would be to quantify the intensity of the biomarker amongst cells that are currently staining. This would be done by identifying cells/regions of tissue that are positive for a biomarker, spectrally unmixing the DAB expression to yield a number proportional to the protein concentration (or alternatively just using the raw intensity reading from the detector). This final measure of intensity can be used to train a model that can be used to predict how strongly a tissue will stain for a given protein. Additionally, a model could be trained to predict stain positivity or intensity based on a pathologist reading.

Examples of Biomarkers

Identified below are non-limiting examples of biomarkers whose expression may be estimated using the systems and methods of the present disclosure. Certain markers are characteristic of particular cells, while other markers have been identified as being associated with a particular disease or condition. Examples of known prognostic markers include enzymatic markers such as, for example, galactosyl transferase II, neuron specific enolase, proton ATPase-2, and acid phosphatase. Hormone or hormone receptor markers include human chorionic gonadotropin (HCG), adrenocorticotropic hormone, carcinoembryonic antigen (CEA), prostate-specific antigen (PSA), estrogen receptor, progesterone receptor, androgen receptor, gC1q-R/p33 complement receptor, IL-2 receptor, p75 neurotrophin receptor, PTH receptor, thyroid hormone receptor, and insulin receptor.

Lymphoid markers include alpha-1-antichymotrypsin, alpha-1-antitrypsin, B cell marker, bcl-2, bcl-6, B lymphocyte antigen 36 kD, BM1 (myeloid marker), BM2 (myeloid marker), galectin-3, granzyme B, HLA class I Antigen, HLA class II (DP) antigen, HLA class II (DQ) antigen, HLA class II (DR) antigen, human neutrophil defensins, immunoglobulin A, immunoglobulin D, immunoglobulin G, immunoglobulin M, kappa light chain, kappa light chain, lambda light chain, lymphocyte/histocyte antigen, macrophage marker, muramidase (lysozyme), p80 anaplastic lymphoma kinase, plasma cell marker, secretory leukocyte protease inhibitor, T cell antigen receptor (JOVI 1), T cell antigen receptor (JOVI 3), terminal deoxynucleotidyl transferase, unclustered B cell marker.

Tumor markers include alpha fetoprotein, apolipoprotein D, BAG-1 (RAP46 protein), CA19-9 (sialyl lewisa), CA50 (carcinoma associated mucin antigen), CA125 (ovarian cancer antigen), CA242 (tumor associated mucin antigen), chromogranin A, clusterin (apolipoprotein J), epithelial membrane antigen, epithelial-related antigen, epithelial specific antigen, epidermal growth factor receptor, estrogen receptor (ER), gross cystic disease fluid protein-15, hepatocyte specific antigen, HER2, heregulin, human gastric mucin, human milk fat globule, MAGE-1, matrix metalloproteinases, melan A, melanoma marker (HMB45), mesothelin, metallothionein, microphthalmia transcription factor (MITF), Muc-1 core glycoprotein. Muc-1 glycoprotein, Muc-2 glycoprotein, Muc-5AC glycoprotein, Muc-6 glycoprotein, myeloperoxidase, Myf-3 (Rhabdomyosarcoma marker), Myf-4 (Rhabdomyosarcoma marker), MyoD1 (Rhabdomyosarcoma marker), myoglobin, nm23 protein, placental alkaline phosphatase, prealbumin, progesterone receptor, prostate specific antigen, prostatic acid phosphatase, prostatic inhibin peptide, PTEN, renal cell carcinoma marker, small intestinal mucinous antigen, tetranectin, thyroid transcription factor-1, tissue inhibitor of matrix metalloproteinase 1, tissue inhibitor of matrix metalloproteinase 2, tyrosinase, tyrosinase-related protein-1, villin, von Willebrand factor, CD34, CD34, Class II, CD51 Ab-1, CD63, CD69, Chk1, Chk2, claspin C-met, COX6C, CREB, Cyclin D1, Cytokeratin, Cytokeratin 8, DAPI, Desmin, DHP (1-6 Diphenyl-1,3,5-Hexatriene), E-Cadherin, EEA1, EGFR, EGFRvIII, EMA (Epithelial Membrane Antigen), ER, ERB3, ERCC1, ERK, E-Selectin, FAK, Fibronectin, FOXP3, Gamma-H2AX, GB3, GFAP, Giantin, GM130, Golgin 97, GRB2, GRP78BiP, GSK3 Beta, HER-2, Histone 3, Histone 3_K14-Ace [Anti-acetyl-Histone H3 (Lys 14)], Histone 3_K18-Ace [Histone H3-Acetyl Lys 18), Histone 3_K27-TriMe, [Histone H3 (trimethyl K27)], Histone 3_K4-diMe [Anti-dimethyl-Histone H3 (Lys 4)], Histone 3_K9-Ace [Acetyl-Histone H3 (Lys 9)], Histone 3_K9-triMe [Histone 3-trimethyl Lys 9], Histone 3_S10-Phos [Anti-Phospho Histone H3 (Ser 10), Mitosis Marker], Histone 4, Histone H2A.X-5139-Phos [Phospho Histone H2A.X (Ser139)antibody], Histone H2B, Histone H3_DiMethyl K4, Histone H4_TriMethyl K20-Chip grad, HSP70, Urokinase, VEGF R1, ICAM-1, IGF-1, IGF-1R, IGF-1 Receptor Beta, IGF-II, IGF-IIR, IKB-Alpha IKKE, IL6, IL8, Integrin alpha V beta 3, Integrin alpha V beta6, Integrin Alpha V/CD51, integrin B5, integrin B6, Integrin B8, Integrin Beta 1(CD 29), Integrin beta 3, Integrin beta 5 integrinB6, IRS-1, Jagged 1, Anti-protein kinase C Beta2, LAMP-1, Light Chain Ab-4 (Cocktail), Lambda Light Chain, kappa light chain, M6P, Mach 2, MAPKAPK-2, MEK 1, MEK 1/2 (Ps222), MEK 2, MEK1/2 (47E6), MEK1/2 Blocking Peptide, MET/HGFR, MGMT, Mitochondrial Antigen, Mitotracker Green F M, MMP-2, MMP9, E-cadherin, mTOR, ATPase, N-Cadherin, Nephrin, NFKB, NFKB p105/p50, NF-KB P65, Notch 1, Notch 2, Notch 3, OxPhos Complex IV, p130Cas, p38 MAPK, p44/42 MAPK antibody, P504S, P53, P70, P70 S6K, Pan Cadherin, Paxillin, P-Cadherin, PDI, pEGFR, Phospho AKT, Phospho CREB, phospho EGF Receptor, Phospho GSK3 Beta, Phospho H3, Phospho HSP-70, Phospho MAPKAPK-2, Phospho MEK1/2, phospho p38 MAP Kinase, Phospho p44/42 MAPK, Phospho p53, Phospho PKC, Phospho S6 Ribosomal Protein, Phospho Src, phospho-Akt, Phospho-Bad, Phospho-IKB-a, phospho-mTOR, Phospho-NF-kappaB p65, Phospho-p38, Phospho-p44/42 MAPK, Phospho-p70 S6 Kinase, Phospho-Rb, phospho-Smad2, PIM1, PIM2, PKC β, Podocalyxin, PR, PTEN, R1, Rb 4H1, R-Cadherin, ribonucleotide Reductase, RRM1, RRM11, SLC7A5, NDRG, HTF9C, HTF9C, CEACAM, p33, S6 Ribosomal Protein, Src, Survivin, Synapopodin, Syndecan 4, Talin, Tensin, Thymidylate Synthase, Tuberlin, VCAM-1, VEGF, Vimentin, Agglutinin, YES, ZAP-70 and ZEB.

Cell cycle associated markers include apoptosis protease activating factor-1, bcl-w, bcl-x, bromodeoxyuridine, CAK (cdk-activating kinase), cellular apoptosis susceptibility protein (CAS), caspase 2, caspase 8, CPP32 (caspase-3), CPP32 (caspase-3), cyclin dependent kinases, cyclin A, cyclin B1, cyclin D1, cyclin D2, cyclin D3, cyclin E, cyclin G, DNA fragmentation factor (N-terminus), Fas (CD95), Fas-associated death domain protein, Fas ligand, Fen-1, IPO-38, Mc1-1, minichromosome maintenance proteins, mismatch repair protein (MSH2), poly (ADP-Ribose) polymerase, proliferating cell nuclear antigen, p16 protein, p27 protein, p34cdc2, p57 protein (Kip2), p105 protein, Stat 1 alpha, topoisomerase I, topoisomerase II alpha, topoisomerase III alpha, topoisomerase II beta.

Neural tissue and tumor markers include alpha B crystallin, alpha-internexin, alpha synuclein, amyloid precursor protein, beta amyloid, calbindin, choline acetyltransferase, excitatory amino acid transporter 1, GAP43, glial fibrillary acidic protein, glutamate receptor 2, myelin basic protein, nerve growth factor receptor (gp75), neuroblastoma marker, neurofilament 68 kD, neurofilament 160 kD, neurofilament 200 kD, neuron specific enolase, nicotinic acetylcholine receptor alpha4, nicotinic acetylcholine receptor beta2, peripherin, protein gene product 9, S-100 protein, serotonin, SNAP-25, synapsin I, synaptophysin, tau, tryptophan hydroxylase, tyrosine hydroxylase, ubiquitin.

Cluster differentiation markers include CD1a, CD1b, CD1c, CD1d, CD1e, CD2, CD3delta, CD3epsilon, CD3gamma, CD4, CD5, CD6, CD7, CD8alpha, CD8beta, CD9, CD10, CD11a, CD11b, CD11c, CDw12, CD13, CD14, CD15, CD15s, CD16a, CD16b, CDw17, CD18, CD19, CD20, CD21, CD22, CD23, CD24, CD25, CD26, CD27, CD28, CD29, CD30, CD31, CD32, CD33, CD34, CD35, CD36, CD37, CD38, CD39, CD40, CD41, CD42a, CD42b, CD42c, CD42d, CD43, CD44, CD44R, CD45, CD46, CD47, CD48, CD49a, CD49b, CD49c, CD49d, CD49e, CD49f, CD50, CD51, CD52, CD53, CD54, CD55, CD56, CD57, CD58, CD59, CDw60, CD61, CD62E, CD62L, CD62P, CD63, CD64, CD65, CD65s, CD66a, CD66b, CD66c, CD66d, CD66e, CD66f, CD68, CD69, CD70, CD71, CD72, CD73, CD74, CDw75, CDw76, CD77, CD79a, CD79b, CD80, CD81, CD82, CD83, CD84, CD85, CD86, CD87, CD88, CD89, CD90, CD91, CDw92, CDw93, CD94, CD95, CD96, CD97, CD98, CD99, CD100, CD101, CD102, CD103, CD104, CD105, CD106, CD107a, CD107b, CDw108, CD109, CD114, CD115, CD116, CD117, CDw119, CD120a, CD120b, CD121a, CDw121b, CD122, CD123, CD124, CDw125, CD126, CD127, CDw128a, CDw128b, CD130, CDw131, CD132, CD134, CD135, CDw136, CDw137, CD138, CD139, CD140a, CD140b, CD141, CD142, CD143, CD144, CDw145, CD146, CD147, CD148, CDw149, CDw150, CD151, CD152, CD153, CD154, CD155, CD156, CD157, CD158a, CD158b, CD161, CD162, CD163, CD164, CD165, CD166, and TCR-zeta.

Other cellular markers include centromere protein-F (CENP-F), giantin, involucrin, lamin A&C [XB 10], LAP-70, mucin, nuclear pore complex proteins, p180 lamellar body protein, ran, r, cathepsin D, Ps2 protein, Her2-neu, P53, S100, epithelial marker antigen (EMA), TdT, MB2, MB3, PCNA, and Ki67.

Tissue Staining

The training biological specimens of the present disclosure may be stained using any reagent or biomarker label, such as dyes or stains, histochemicals, nucleic acid probes or immunohistochemicals that directly react with the specific biomarkers or with various types of cells or cellular compartments. Such histochemicals may be chromophores detectable by transmittance (or reflectance) microscopy or fluorophores detectable by fluorescence microscopy. In general, the training biological specimens of the present disclosure may be incubated with a solution comprising at least one histochemical, which will directly react with or bind to chemical groups of the target. Some histochemicals must be co-incubated with a mordant or metal to allow staining. A training biological specimen may be incubated with a mixture of at least one histochemical that stains a component of interest and another histochemical that acts as a counterstain and binds a region outside the component of interest. Alternatively, mixtures of multiple probes may be used in the staining and provide a way to identify the positions of specific probes. The training biological specimens of the present disclosure may be co-incubated with appropriate substrates for an enzyme that is a cellular component of interest and appropriate reagents that yield colored precipitates at the sites of enzyme activity.

Immunohistochemistry is among the most sensitive and specific histochemical techniques. Any training biological specimen of the present disclosure may be combined with a labeled binding composition comprising a specifically binding agent. Various labels may be employed, such as fluorophores, or enzymes that produce a product that absorbs light or fluoresces. A wide variety of labels are known that provide for strong signals in relation to a single binding event. Multiple probes used in the staining may be labeled with more than one distinguishable fluorescent label. These color differences provide a way to identify the positions of specific probes. The method of preparing conjugates of fluorophores and proteins, such as antibodies, is extensively described in the literature and does not require exemplification here.

Examples of suitable immunohistochemical stains used for research and, in limited cases, for diagnosis of various diseases, include, for example, anti-estrogen receptor antibody (breast cancer), anti-progesterone receptor antibody (breast cancer), anti-p53 antibody (multiple cancers), anti-Her-2/neu antibody (multiple cancers), anti-EGFR antibody (epidermal growth factor, multiple cancers), anti-cathepsin D antibody (breast and other cancers), anti-Bcl-2 antibody (apoptotic cells), anti-E-cadherin antibody, anti-CA125 antibody (ovarian and other cancers), anti-CA15-3 antibody (breast cancer), anti-CA19-9 antibody (colon cancer), anti-c-erbB-2 antibody, anti-P-glycoprotein antibody (MDR, multi-drug resistance), anti-CEA antibody (carcinoembryonic antigen), anti-retinoblastoma protein (Rb) antibody, anti-ras oneoprotein (p21) antibody, anti-Lewis X (also called CD15) antibody, anti-Ki-67 antibody (cellular proliferation), anti-PCNA (multiple cancers) antibody, anti-CD3 antibody (T-cells), anti-CD4 antibody (helper T cells), anti-CD5 antibody (T cells), anti-CD7 antibody (thymocytes, immature T cells, NK killer cells), anti-CD8 antibody (suppressor T cells), anti-CD9/p24 antibody (ALL), anti-CD10 (also called CALLA) antibody (common acute lymphoblasic leukemia), anti-CD11c antibody (Monocytes, granulocytes, AML), anti-CD13 antibody (myelomonocytic cells, AML), anti-CD14 antibody (mature monocytes, granulocytes), anti-CD15 antibody (Hodgkin's disease), anti-CD19 antibody (B cells), anti-CD20 antibody (B cells), anti-CD22 antibody (B cells), anti-CD23 antibody (activated B cells, CLL), anti-CD30 antibody (activated T and B cells, Hodgkin's disease), anti-CD31 antibody (angiogenesis marker), anti-CD33 antibody (myeloid cells, AML), anti-CD34 antibody (endothelial stem cells, stromal tumors), anti-CD35 antibody (dendritic cells), anti-CD38 antibody (plasma cells, activated T, B, and myeloid cells), anti-CD 41 antibody (platelets, megakaryocytes), anti-LCA/CD45 antibody (leukocyte common antigen), anti-CD45RO antibody (helper, inducer T cells), anti-CD45RA antibody (B cells), anti-CD39, CD100 antibody, anti-CD95/Fas antibody (apoptosis), anti-CD99 antibody (Ewings Sarcoma marker, MIC2 gene product), anti-CD106 antibody (VCAM-1; activated endothelial cells), anti-ubiquitin antibody (Alzheimer's disease), anti-CD71 (transferrin receptor) antibody, anti-c-myc (oncoprotein and a hapten) antibody, anti-cytokeratins (transferrin receptor) antibody, anti-vimentins (endothelial cells) antibody (B and T cells), anti-HPV proteins (human papillomavirus) antibody, anti-kappa light chains antibody (B cell), anti-lambda light chains antibody (B cell), anti-melanosomes (HMB45) antibody (melanoma), anti-prostate specific antigen (PSA) antibody (prostate cancer), anti-S-100 antibody (melanoma, salivary, glial cells), anti-tau antigen antibody (Alzheimer's disease), anti-fibrin antibody (epithelial cells), anti-keratins antibody, anti-cytokeratin antibody (tumor), anti-alpha-catenin (cell membrane), anti-Tn-antigen antibody (colon carcinoma, adenocarcinomas, and pancreatic cancer); anti-1,8-ANS (1-Anilino Naphthalene-8-Sulphonic Acid) antibody; anti-C4 antibody; anti-2C4 CASP Grade antibody; anti-2C4 CASP an antibody; anti-HER-2 antibody; anti-Alpha B Crystallin antibody; anti-Alpha Galactosidase A antibody; anti-alpha-Catenin antibody; anti-human VEGF R1 (Flt-1) antibody; anti-integrin B5 antibody; anti-integrin beta 6 antibody; anti-phospho-SRC antibody; anti-Bak antibody; anti-BCL-2 antibody; anti-BCL-6 antibody; anti-Beta Catanin antibody; anti-Beta Catenin antibody; anti-Integrin alpha V beta 3 antibody; anti-c ErbB-2 Ab-12 antibody; anti-Calnexin antibody; anti-Calreticulin antibody; anti-Calreticulin antibody; anti-CAM5.2 (Anti-Cytokeratin Low mol. Wt.) antibody; anti-Cardiotin (R2G) antibody; anti-Cathepsin D antibody; Chicken polyclonal antibody to Galactosidase alpha; anti-c-Met antibody; anti-CREB antibody; anti-COX6C antibody; anti-Cyclin D1 Ab-4 antibody; anti-Cytokeratin antibody; anti-Desmin antibody; anti-DHP (1-6 Diphenyl-1,3,5-Hexatriene) antibody; DSB-X Biotin Goat Anti Chicken antibody; anti-E-Cadherin antibody; anti-EEA1 antibody; anti-EGFR antibody; anti-EMA (Epithelial Membrane Antigen) antibody; anti-ER (Estrogen Receptor) antibody; anti-ERB3 antibody; anti-ERCC1 ERK (Pan ERK) antibody; anti-E-Selectin antibody; anti-FAK antibody; anti-Fibronectin antibody; FITC-Goat Anti Mouse IgM antibody; anti-FOXP3 antibody; anti-GB3 antibody; anti-GFAP (Glial Fibrillary Acidic Protein) antibody; anti-Giantin antibody; anti-GM130 antibody; anti-Goat a h Met antibody; anti-Golgin 97 antibody; anti-GRB2 antibody; anti-GRP78BiP antibody; anti-GSK-3Beta antibody; anti-Hepatocyte antibody; anti-HER-2 antibody; anti-HER-3 antibody; anti-Histone 3 antibody; anti-Histone 4 antibody; anti-Histone H2A X antibody; anti-Histone H2B antibody; anti-HSP70 antibody; anti-ICAM-1 antibody; anti-IGF-1 antibody; anti-IGF-1 Receptor antibody; anti-IGF-1 Receptor Beta antibody; anti-IGF-II antibody; anti-IKB-Alpha antibody; anti-IL6 antibody; anti-IL8 antibody; anti-Integrin beta 3 antibody; anti-Integrin beta 5 antibody; anti-Integrin b8 antibody; anti-Jagged 1 antibody; anti-protein kinase C Beta2 antibody; anti-LAMP-1 antibody; anti-M6P (Mannose 6-Phosphate Receptor) antibody; anti-MAPKAPK-2 antibody; anti-MEK 1 antibody; anti-MEK 2 antibody; anti-Mitochondrial Antigen antibody; anti-Mitochondrial Marker antibody; anti-Mitotracker Green FM antibody; anti-MMP-2 antibody; anti-MMP9 antibody; anti-Na+/K ATPase antibody; anti-Na+/K ATPase Alpha 1 antibody; anti-Na+/K ATPase Alpha 3 antibody; anti-N-Cadherin antibody; anti-Nephrin antibody; anti-NF-KB p50 antibody; anti-NF-KB P65 antibody; anti-Notch 1 antibody; anti-OxPhos Complex IV-Alexa488 Conjugate antibody; anti-p130Cas antibody; anti-P38 MAPK antibody; anti-p44/42 MAPK antibody; anti-P504S Clone 13H4 antibody; anti-P53 antibody; anti-P70 S6K antibody; anti-P70 phospho kinase blocking peptide antibody; anti-Pan Cadherin antibody; anti-Paxillin antibody; anti-P-Cadherin antibody; anti-PDI antibody; anti-Phospho AKT antibody; anti-Phospho CREB antibody; anti-Phospho GSK-3-beta antibody; anti-Phospho GSK-3 Beta antibody; anti-Phospho H3 antibody; anti-Phospho MAPKAPK-2 antibody; anti-Phospho MEK antibody; anti-Phospho p44/42 MAPK antibody; anti-Phospho p53 antibody; anti-Phospho-NF-KB p65 antibody; anti-Phospho-p70 S6 Kinase antibody; anti-Phospho PKC (Pan) antibody; anti-Phospho S6 Ribosomal Protein antibody; anti-Phospho Src antibody; anti-Phospho-Bad antibody; anti-Phospho-HSP27 antibody; anti-Phospho-IKB-a antibody; anti-Phospho-p44/42 MAPK antibody; anti-Phospho-p70 S6 Kinase antibody; anti-Phospho-Rb (Ser807/811) (Retinoblastoma) antibody; anti-Phosopho HSP-7 antibody; anti-Phsopho-p38 antibody; anti-Pim-1 antibody; anti-Pim-2 antibody; anti-PKC β antibody; anti-PKC β11 antibody; anti-Podocalyxin antibody; anti-PR antibody; anti-PTEN antibody; anti-R1 antibody; anti-Rb 4H1(Retinoblastoma) antibody; anti-R-Cadherin antibody; anti-RRM1 antibody; anti-S6 Ribosomal Protein antibody; anti-S-100 antibody; anti-Synaptopodin antibody; anti-Synaptopodin antibody; anti-Syndecan 4 antibody; anti-Talin antibody; anti-Tensin antibody; anti-Tuberlin antibody; anti-Urokinase antibody; anti-VCAM-1 antibody; anti-VEGF antibody; anti-Vimentin antibody; anti-ZAP-70 antibody; and anti-ZEB.

Fluorophores that may be conjugated to a primary antibody include but are not limited to Fluorescein, Rhodamine, Texas Red, Cy2, Cy3, Cy5, VECTOR Red, ELF™ (Enzyme-Labeled Fluorescence), Cy0, Cy0.5, Cy1, Cy1.5, Cy3, Cy3.5, Cy5, Cy7, Fluor X, Calcein, Calcein-AM, CRYPTOFLUOR™'S, Orange (42 kDa), Tangerine (35 kDa), Gold (31 kDa), Red (42 kDa), Crimson (40 kDa), BHMP, BHDMAP, Br-Oregon, Lucifer Yellow, Alexa dye family, N-[6-(7-nitrobenz-2-oxa-1,3-diazol-4-yl)-amino]caproyl] (NBD), BODIPY™, boron dipyrromethene difluoride, Oregon Green, MITOTRACKER™ Red, DiOC7 (3), DiIC18, Phycoerythrin, Phycobiliproteins BPE (240 kDa) RPE (240 kDa) CPC (264 kDa) APC (104 kDa), Spectrum Blue, Spectrum Aqua, Spectrum Green, Spectrum Gold, Spectrum Orange, Spectrum Red, NADH, NADPH, FAD, Infra-Red (IR) Dyes, Cyclic GDP-Ribose (cGDPR), Calcofluor White, Lissamine, Umbelliferone, Tyrosine and Tryptophan. A wide variety of other fluorescent probes are available from and/or extensively described in the Handbook of Fluorescent Probes and Research Products 8th Ed. (2001), available from Molecular Probes, Eugene, Oreg., as well as many other manufacturers.

Further amplification of the signal can be achieved by using combinations of specific binding agents, such as antibodies and anti-antibodies, where the anti-antibodies bind to a conserved region of the target antibody probe, particularly where the antibodies are from different species. Alternatively, specific binding ligand-receptor pairs, such as biotin-streptavidin, may be used, where the primary antibody is conjugated to one member of the pair and the other member is labeled with a detectable probe. Thus, one effectively builds a sandwich of binding members, where the first binding member binds to the cellular component and serves to provide for secondary binding, where the secondary binding member may or may not include a label, which may further provide for tertiary binding where the tertiary binding member will provide a label.

The secondary antibody, avidin, streptavidin or biotin are each independently labeled with a detectable moiety, which can be an enzyme directing a colorimetric reaction of a substrate having a substantially non-soluble color reaction product, a fluorescent dye (stain), a luminescent dye or a non-fluorescent dye. Examples concerning each of these options are listed below.

In principle, any enzyme that (i) can be conjugated to or bind indirectly to (e.g., via conjugated avidin, streptavidin, biotin, secondary antibody) a primary antibody, and (ii) uses a soluble substrate to provide an insoluble product (precipitate) could be used. The enzyme employed can be, for example, alkaline phosphatase, horseradish peroxidase, beta-galactosidase and/or glucose oxidase; and the substrate can respectively be an alkaline phosphatase, horseradish peroxidase, beta.-galactosidase or glucose oxidase substrate.

Alkaline phosphatase (AP) substrates include, but are not limited to, AP-Blue substrate (blue precipitate, Zymed catalog p. 61); AP-Orange substrate (orange, precipitate, Zymed), AP-Red substrate (red, red precipitate, Zymed), 5-bromo, 4-chloro, 3-indolyphosphate (BCIP substrate, turquoise precipitate), 5-bromo, 4-chloro, 3-indolyl phosphate/nitroblue tetrazolium/iodonitrotetrazolium (BCIP/INT substrate, yellow-brown precipitate, Biomeda), 5-bromo, 4-chloro, 3-indolyphosphate/nitroblue tetrazolium (BCIP/NBT substrate, blue/purple), 5-bromo, 4-chloro, 3-indolyl phosphate/nitroblue tetrazolium/iodonitrotetrazolium (BCIP/NBT/INT, brown precipitate, DAKO, Fast Red (Red), Magenta-phos (magenta), Naphthol AS-BI-phosphate (NABP)/Fast Red TR (Red), Naphthol AS-BI-phosphate (NABP)/New Fuchsin (Red), Naphthol AS-MX-phosphate (NAMP)/New Fuchsin (Red), New Fuchsin AP substrate (red), p-Nitrophenyl phosphate (PNPP, Yellow, water soluble), VECTOR™ Black (black), VECTOR™ Blue (blue), VECTOR™ Red (red), Vega Red (raspberry red color).

Horseradish Peroxidase (HRP, sometimes abbreviated PO) substrates include, but are not limited to, 2,2′ Azino-di-3-ethylbenz-thiazoline sulfonate (ABTS, green, water soluble), aminoethyl carbazole, 3-amino, 9-ethylcarbazole AEC (3A9EC, red). Alpha-naphthol pyronin (red), 4-chloro-1-naphthol (4C1N, blue, blue-black), 3,3′-diaminobenzidine tetrahydrochloride (DAB, brown), ortho-dianisidine (green), o-phenylene diamine (OPD, brown, water soluble), TACS Blue (blue), TACS Red (red), 3,3′,5,5′Tetramethylbenzidine (TMB, green or green/blue), TRUE BLUE™ (blue), VECTOR™ VIP (purple), VECTOR™ SG (smoky blue-gray), and Zymed Blue HRP substrate (vivid blue).

Glucose oxidase (GO) substrates, include, but are not limited to, nitroblue tetrazolium (NBT, purple precipitate), tetranitroblue tetrazolium (TNBT, black precipitate), 2-(4-iodophenyl)-5-(4-nitorphenyl)-3-phenyltetrazolium chloride (INT, red or orange precipitate), Tetrazolium blue (blue), Nitrotetrazolium violet (violet), and 3-(4,5-dimethylthiazol-2-yl)-2,5-diphenyltetrazolium bromide (MTT, purple). All tetrazolium substrates require glucose as a co-substrate. The glucose gets oxidized and the tetrazolium salt gets reduced and forms an insoluble formazan that forms the color precipitate.

Beta-galactosidase substrates include, but are not limited to, 5-bromo-4-chloro-3-indoyl beta-D-galactopyranoside (X-gal, blue precipitate). The precipitates associated with each of the substrates listed have unique detectable spectral signatures (components).

The enzyme can also be directed at catalyzing a luminescence reaction of a substrate, such as, but not limited to, luciferase and aequorin, having a substantially non-soluble reaction product capable of luminescencing or of directing a second reaction of a second substrate, such as but not limited to, luciferine and ATP or coelenterazine and Ca.2+, having a luminescencing product.

Nucleic acid biomarkers may be detected using in-situ hybridization (ISH). In general, a nucleic acid sequence probe is synthesized and labeled with either a fluorescent probe or one member of a ligand:receptor pair, such as biotin/avidin, labeled with a detectable moiety. Exemplary probes and moieties are described in the preceding section. The sequence probe is complementary to a target nucleotide sequence in the cell. Each cell or cellular compartment containing the target nucleotide sequence may bind the labeled probe.

Probes used in the analysis may be either DNA or RNA oligonucleotides or polynucleotides and may contain not only naturally occurring nucleotides but their analogs such as dioxygenin dCTP, biotin dcTP 7-azaguanosine, azidothymidine, inosine, or uridine. Other useful probes include peptide probes and analogues thereof, branched gene DNA, peptidomimetics, peptide nucleic acids, and/or antibodies. Probes should have sufficient complementarity to the target nucleic acid sequence of interest so that stable and specific binding occurs between the target nucleic acid sequence and the probe. The degree of homology required for stable hybridization varies with the stringency of the hybridization. Conventional methodologies for ISH, hybridization and probe selection are described in Leitch, et al. In Situ Hybridization: a practical guide, Oxford BIOS Scientific Publishers, Microscopy Handbooks v. 27 (1994); and Sambrook, J., Fritsch, E. F., Maniatis, T., Molecular Cloning: A Laboratory Manual, Cold Spring Harbor Press (1989).

Other System Components

The system 200 of the present disclosure may be tied to a specimen processing apparatus that can perform one or more preparation processes on the tissue specimen. The preparation process can include, without limitation, deparaffinizing a specimen, conditioning a specimen (e.g., cell conditioning), staining a specimen, performing antigen retrieval, performing immunohistochemistry staining (including labeling) or other reactions, and/or performing in situ hybridization (e.g., SISH, FISH, etc.) staining (including labeling) or other reactions, as well as other processes for preparing specimens for microscopy, microanalyses, mass spectrometric methods, or other analytical methods.

The processing apparatus can apply fixatives to the specimen. Fixatives can include cross-linking agents (such as aldehydes, e.g., formaldehyde, paraformaldehyde, and glutaraldehyde, as well as non-aldehyde cross-linking agents), oxidizing agents (e.g., metallic ions and complexes, such as osmium tetroxide and chromic acid), protein-denaturing agents (e.g., acetic acid, methanol, and ethanol), fixatives of unknown mechanism (e.g., mercuric chloride, acetone, and picric acid), combination reagents (e.g., Carnoy's fixative, methacarn, Bouin's fluid, B5 fixative, Rossman's fluid, and Gendre's fluid), microwaves, and miscellaneous fixatives (e.g., excluded volume fixation and vapor fixation).

If the specimen is a sample embedded in paraffin, the sample can be deparaffinized using appropriate deparaffinizing fluid(s). After the paraffin is removed, any number of substances can be successively applied to the specimen. The substances can be for pretreatment (e.g., to reverse protein-crosslinking, expose cells acids, etc.), denaturation, hybridization, washing (e.g., stringency wash), detection (e.g., link a visual or marker molecule to a probe), amplifying (e.g., amplifying proteins, genes, etc.), counterstaining, coverslipping, or the like.

The specimen processing apparatus can apply a wide range of substances to the specimen. The substances include, without limitation, stains, probes, reagents, rinses, and/or conditioners. The substances can be fluids (e.g., gases, liquids, or gas/liquid mixtures), or the like. The fluids can be solvents (e.g., polar solvents, non-polar solvents, etc.), solutions (e.g., aqueous solutions or other types of solutions), or the like. Reagents can include, without limitation, stains, wetting agents, antibodies (e.g., monoclonal antibodies, polyclonal antibodies, etc.), antigen recovering fluids (e.g., aqueous- or non-aqueous-based antigen retrieval solutions, antigen recovering buffers, etc.), or the like. Probes can be an isolated cells acid or an isolated synthetic oligonucleotide, attached to a detectable label or reporter molecule. Labels can include radioactive isotopes, enzyme substrates, co-factors, ligands, chemiluminescent or fluorescent agents, haptens, and enzymes.

After the specimens are processed, a user can transport specimen-bearing slides to the imaging apparatus. In some embodiments, the imaging apparatus is a brightfield imager slide scanner. One brightfield imager is the iScan Coreo brightfield scanner sold by Ventana Medical Systems, Inc. In automated embodiments, the imaging apparatus is a digital pathology device as disclosed in International Patent Application No.: PCT/US2010/002772 (Patent Publication No.: WO/2011/049608) entitled IMAGING SYSTEM AND TECHNIQUES or disclosed in U.S. Patent Application No. 61/533,114, filed on Sep. 9, 2011, entitled IMAGING SYSTEMS, CASSETTES, AND METHODS OF USING THE SAME. International Patent Application No. PCT/US2010/002772 and U.S. Patent Application No. 61/533,114 are incorporated by reference in their entities.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Any of the modules described herein may include logic that is executed by the processor(s). “Logic,” as used herein, refers to any information having the form of instruction signals and/or data that may be applied to affect the operation of a processor. Software is an example of logic.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “programmed processor” encompasses all kinds of apparatus, devices, and machines for processing data, including by way of example a programmable microprocessor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user and a keyboard and a pointing device, e.g., a mouse or a trackball, by which the user can provide input to the computer. In some implementations, a touch screen can be used to display information and receive input from a user. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks). For example, the network 20 of FIG. 1 can include one or more local area networks.

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

### Alternative Embodiments

In another aspect of the present disclosure is a method for predicting an expression of one or more biomarkers in an unstained test biological specimen treated fixed for an unknown amount of time including obtaining test spectral data from the unstained test biological specimen, wherein the test spectral data includes vibrational spectral data derived from at least a portion of the biological specimen; deriving biomarker expression features from the obtained test spectral data using a trained biomarker expression estimation engine; and predicting the expression of the one or more biomarkers of the test biological specimen based on the biomarker expression features. In some embodiments, the predicted biomarker expression includes one of a predicted percent positivity or a predicted staining intensity. In some embodiments, the predicted biomarker expression includes both a predicted percent positivity and a predicted staining intensity. In some embodiments, a fixation status of the unstained test biological specimen is unknown.

In some embodiments, the biomarker expression estimation engine is trained using one or more training spectral data sets, wherein each training spectral data set includes a plurality of training vibrational spectra derived from a plurality of training tissue samples stained for the presence of one or more biomarkers, and wherein each training vibrational spectrum includes one or more class labels. In some embodiments, the one or more class labels comprise known biomarker expression levels for one or more biomarkers. In some embodiments, known biomarker expression levels comprise at least one of known percent positivity for one or more biomarkers and known staining intensities for one or more biomarkers. In some embodiments, the system further includes one or more class labels selected from the group consisting of a known unmasking duration, a known unmasking temperature, a qualitative assessment of an unmasking state, a known fixation duration, and a qualitative assessment of a fixation state.

In some embodiments, training spectral data set is derived by: (i) obtaining a training biological specimen; (ii) dividing the obtained training biological specimen into a plurality of training tissue samples; (iii) staining each of the obtained plurality of training tissue samples for the presence of one or more biomarkers; and (iv) quantitatively assessing an expression of the one or more biomarkers. In some embodiments, each training tissue sample of the plurality of training tissue samples is differentially unmasked, differentially fixed, or both differentially unmasked and differentially fixed. In some embodiments, the quantitative assessment of the one or more biomarkers includes determining a staining intensity of the one or more biomarkers. In some embodiments, quantitative assessment of the one or more biomarkers includes determining a percent positivity of the one or more biomarkers. In some embodiments, the quantitative assessment is performed by a pathologist. In some embodiments, the quantitative assessment is performed using one or more image analysis algorithms. In some embodiments, plurality of training tissue samples are stained in an immunohistochemistry assay. In some embodiments, the plurality of training tissue samples are stained in an in situ hybridization assay.

In some embodiments, test spectral data includes an averaged vibrational spectrum derived from a plurality of normalized and corrected vibrational spectra. In some embodiments, plurality of normalized and corrected vibrational spectra are obtained by: (i) identifying a plurality of spatial regions within the test biological specimen; (ii) acquiring a vibrational spectrum from each individual region of the plurality of identified regions; (iii) correcting the acquired vibrational spectrum from each individual region to provide a corrected vibrational spectrum for each individual region; and (iv) amplitude normalizing the corrected vibrational spectrum from each individual region to a pre-determined global maximum to provide an amplitude normalized vibrational spectrum for each region. In some embodiments, the acquired vibrational spectrum from each individual region is corrected by: (i) compensating each acquired vibrational spectrum for atmospheric effects to provide an atmospheric corrected vibrational spectrum; and (ii) compensating the atmospheric corrected vibrational spectrum for scattering.

In some embodiments, the trained biomarker expression estimation engine includes a machine learning algorithm based on dimensionality reduction. In some embodiments, the dimensionality reduction includes a projection onto latent structure regression model. In some embodiments, the dimensionality reduction includes a principal component analysis plus discriminant analysis. In some embodiments, the trained biomarker expression estimation engine includes a neural network.

In some embodiments, the method further includes comparing an actual biomarker expression of the test biological specimen with the predicted expression of the one or more biomarkers of the test biological specimen. In some embodiments, the method further includes the predicated expression of the one or more biomarkers for poor unmasking and/or poor fixation of the test biological specimen. In some embodiments, the test spectral data includes vibrational spectral information for at least an amide I band. In some embodiments, test spectral data includes vibrational spectral information for wavelengths ranging from between about 3200 to about 3400 cm⁻¹, about 2800 to about 2900 cm⁻¹, about 1020 to about 1100 cm⁻¹, and/or about 1520 to about 1580 cm⁻¹.

In another aspect of the present disclosure is a method for predicting an expression of one or more biomarkers in a test biological specimen treated fixed for an unknown amount of time obtaining test spectral data from the test biological specimen, wherein the test spectral data includes vibrational spectral data derived from at least a portion of the biological specimen; deriving biomarker expression features from the obtained test spectral data using a trained biomarker expression estimation engine; and predicting the expression of the one or more biomarkers of the test biological specimen based on the biomarker expression features. In some embodiments, the predicted biomarker expression includes one of a predicted percent positivity or a predicted staining intensity. In some embodiments, the predicted biomarker expression includes both a predicted percent positivity and a predicted staining intensity. In some embodiments, a fixation status of the test biological specimen is unknown. In some embodiments, the test biological specimen is stained for the presence of one or more biomarkers, including any of the biomarkers enumerated above. In other embodiments, the test biological specimen is unstained.

Another aspect of the present disclosure is a system for predicting an expression of one or more biomarkers in an unstained test biological specimen the system comprising: (i) one or more processors, and (ii) one or more memories coupled to the one or more processors, the one or more memories to store computer-executable instructions that, when executed by the one or more processors, cause the system to perform operations comprising: obtaining test spectral data from the test biological specimen, wherein the test spectral data includes vibrational spectral data derived from at least a portion of the biological specimen; deriving biomarker expression features from the obtained test spectral data using a trained biomarker expression estimation engine, wherein the biomarker expression estimation engine is trained using training spectral data sets acquired from a plurality of differentially prepared training biological specimens and wherein the training spectral data sets comprise class labels of known biomarker expression for one or more biomarkers; predicting the expression of one more biomarkers in the unstained biological specimen based on the derived biomarker expression features.

In some embodiments, the predicted biomarker expression includes one of a predicted percent positivity or a predicted staining intensity. In some embodiments, the predicted biomarker expression includes both a predicted percent positivity and a predicted staining intensity. In some embodiments, the one or more biomarkers include at least one cancer biomarker.

In some embodiments, each training spectral data set is derived by: (i) obtaining a training biological specimen; (ii) dividing the obtained training biological specimen into a plurality of training tissue samples; and (iii) preparing each training tissue sample of the plurality of training tissue samples under different preparation conditions. In some embodiments, the method further includes staining each of the obtained plurality of training tissue samples for the presence of one or more biomarkers; and quantitatively assessing known percent positivity and/or known staining intensity for the one or more biomarkers. In some embodiments, trained biomarker expression estimation engine includes a machine learning algorithm based on dimensionality reduction. In some embodiments, the dimensionality reduction includes a projection onto latent structure regression model. In some embodiments, the trained biomarker expression estimation engine includes a neural network. In some embodiments, the method further includes compensating the predicated expression of the one or more biomarkers for poor unmasking and/or poor fixation of the test biological specimen.

Another aspect of the present disclosure is a system for predicting an expression of one or more biomarkers in an test biological specimen the system comprising: (i) one or more processors, and (ii) one or more memories coupled to the one or more processors, the one or more memories to store computer-executable instructions that, when executed by the one or more processors, cause the system to perform operations comprising: obtaining test spectral data from the test biological specimen, wherein the test spectral data includes vibrational spectral data derived from at least a portion of the biological specimen; deriving biomarker expression features from the obtained test spectral data using a trained biomarker expression estimation engine, wherein the biomarker expression estimation engine is trained using training spectral data sets acquired from a plurality of differentially prepared training biological specimens and wherein the training spectral data sets comprise class labels of known biomarker expression for one or more biomarkers; predicting the expression of one more biomarkers in the biological specimen based on the derived biomarker expression features. In some embodiments, the test biological specimen is stained for the presence of one or more biomarkers, including any of the biomarkers enumerated above. In other embodiments, the test biological specimen is unstained.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ concepts of the various patents, applications, and publications to provide yet further embodiments.

Although the present disclosure has been described with reference to a number of illustrative embodiments, it should be understood that numerous other modifications and embodiments can be devised by those skilled in the art that will fall within the spirit and scope of the principles of this disclosure. More particularly, reasonable variations and modifications are possible in the component parts and/or arrangements of the subject combination arrangement within the scope of the foregoing disclosure, the drawings, and the appended claims without departing from the spirit of the disclosure. In addition to variations and modifications in the component parts and/or arrangements, alternative uses will also be apparent to those skilled in the art.

### Further Embodiments 1

A system (200) for predicting an expression of one or more biomarkers in an test biological specimen the system (200) comprising: (i) one or more processors (209), and (ii) one or more memories (201) coupled to the one or more processors (209), the one or more memories (201) to store computer-executable instructions that, when executed by the one or more processors (209), cause the system (200) to perform operations comprising:
   a. obtaining test spectral data from the test biological specimen, wherein the obtained test spectral data comprises vibrational spectral data derived from at least a portion of the biological specimen;
   b. deriving biomarker expression features from the obtained test spectral data using a trained biomarker expression estimation engine (210); and
   c. predicting the expression of the one or more biomarkers in the test biological specimen based on the derived biomarker expression features.

### Further Embodiments 2

The system of further embodiment 1, wherein the predicted expression of the one or more biomarkers comprises one of a predicted percent positivity or a predicted staining intensity.

### Further Embodiments 3

The system of further embodiment 1, wherein the predicted expression of the one or more biomarkers comprises both a predicted percent positivity and a predicted staining intensity.

### Further Embodiments 4

The system of any one of the preceding further embodiments, wherein a fixation status of the test biological specimen is unknown.

### Further Embodiments 5

The system of any one of the preceding further embodiments, wherein the biomarker expression estimation engine is trained using one or more training spectral data sets, wherein each training spectral data set comprises a plurality of training vibrational spectra derived from a plurality of training tissue samples stained for the presence of one or more biomarkers, and wherein each training vibrational spectrum comprises one or more class labels.

### Further Embodiments 6

The system of further embodiment 5, wherein the one or more class labels comprise known biomarker expression levels for one or more biomarkers.

### Further Embodiments 7

The system of further embodiment 6, wherein the known biomarker expression levels comprise at least one of known percent positivities for one or more biomarkers and known staining intensities for one or more biomarkers.

### Further Embodiments 8

The system of further embodiment 6, further comprising one or class labels selected from the group consisting of a known unmasking duration, a known unmasking temperature, a qualitative assessment of an unmasking state, a known fixation duration, and a qualitative assessment of a fixation state.

### Further Embodiments 9

The system of any one of further embodiments 5-8, wherein each training spectral data set is derived by: (i) obtaining a training biological specimen; (ii) dividing the obtained training biological specimen into a plurality of training tissue samples; (iii) staining the plurality of training tissue samples for the presence of one or more biomarkers; and (iv) quantitatively assessing an expression of the one or more biomarkers in each training tissue sample of the plurality of training tissue samples.

### Further Embodiments 10

The system of further embodiment 9, wherein each training tissue sample of the plurality of training tissue samples is differentially unmasked, differentially fixed, or both differentially unmasked and differentially fixed.

### Further Embodiments 11

The system of further embodiment 9, wherein the quantitative assessment of the one or more biomarkers comprises determining a staining intensity of the one or more biomarkers.

### Further Embodiments 12

The system of further embodiment 9, wherein the quantitative assessment of the one or more biomarkers comprises determining a percent positivity of the one or more biomarkers.

### Further Embodiments 13

The system of further embodiment 9, wherein the quantitative assessment of the one or more biomarkers is performed by a pathologist.

### Further Embodiments 14

The system of further embodiment 9, wherein the quantitative assessment of the one or more biomarkers is performed using one or more image analysis algorithms.

### Further Embodiments 15

The system of further embodiment 9, wherein the plurality of training tissue samples are stained in an immunohistochemistry assay.

### Further Embodiments 16

The system of further embodiment 9, wherein the plurality of training tissue samples are each stained in an in situ hybridization assay.

### Further Embodiments 17

The system of any one of the preceding further embodiments, wherein the obtained test spectral data comprises an averaged vibrational spectrum derived from a plurality of normalized and corrected vibrational spectra.

### Further Embodiments 18

The system of further embodiment 17, wherein the plurality of normalized and corrected vibrational spectra are obtained by: (i) identifying a plurality of spatial regions within the test biological specimen; (ii) acquiring a vibrational spectrum from each individual region of the plurality of identified regions; (iii) correcting the acquired vibrational spectrum from each individual region to provide a corrected vibrational spectrum for each individual region; and (iv) amplitude normalizing the corrected vibrational spectrum from each individual region to a pre-determined global maximum to provide an amplitude normalized vibrational spectrum for each region.

### Further Embodiments 19

The system of further embodiment 18, wherein the acquired vibrational spectrum from each individual region is corrected by: (i) compensating each acquired vibrational spectrum for atmospheric effects to provide an atmospheric corrected vibrational spectrum; and (ii) compensating the atmospheric corrected vibrational spectrum for scattering.

### Further Embodiments 20

The system of any one of the preceding further embodiments, wherein the trained biomarker expression estimation engine comprises a machine learning algorithm based on dimensionality reduction.

### Further Embodiments 21

The system of further embodiment 20, wherein the dimensionality reduction comprises a projection onto latent structure regression model.

### Further Embodiments 22

The system of further embodiment 20, wherein the dimensionality reduction comprises a principal component analysis plus discriminant analysis.

### Further Embodiments 23

The system of any one of further embodiments 1-19, wherein the trained biomarker expression estimation engine comprises a neural network.

### Further Embodiments 24

The system of any one of the preceding further embodiments, further comprising operations for comparing an actual biomarker expression of the test biological specimen with the predicted expression of the one or more biomarkers of the test biological specimen.

### Further Embodiments 25

The system of any one of the preceding further embodiments, further comprising operations for compensating the predicated expression of the one or more biomarkers for poor unmasking and/or poor fixation of the test biological specimen.

### Further Embodiments 26

The system of any one of the preceding further embodiments, wherein the obtained test spectral data comprises vibrational spectral information for at least an amide I band.

### Further Embodiments 27

The system of any one of the preceding further embodiments, wherein the obtained test spectral data comprises vibrational spectral information for wavelengths ranging from between about 3200 to about 3400 cm⁻¹, about 2800 to about 2900 cm⁻¹, about 1020 to about 1100 cm⁻¹, and/or about 1520 to about 1580 cm⁻¹.

### Further Embodiments 28

The system of further embodiment 1, wherein the test biological specimen is unstained.

### Further Embodiments 29

The system of further embodiment 1, wherein the test biological specimen is stained for the presence of one or more biomarkers.

### Further Embodiments 30

A non-transitory computer-readable medium storing instructions for predicting an expression of one or more biomarkers in a test biological specimen treated, the test biological specimen having an unknown fixation status and/or unknown unmasking status, comprising:
   (a) obtaining test spectral data from the test biological specimen, wherein the obtained test spectral data comprises vibrational spectral data derived from at least a portion of the biological specimen;
   (b) deriving biomarker expression features from the obtained test spectral data using a trained biomarker expression estimation engine (210), wherein the biomarker expression estimation engine is trained using training spectral data sets acquired from a plurality of differentially prepared training biological specimens and wherein the training spectral data sets comprise class labels of known biomarker expression for one or more biomarkers; and
   (c) predicting the expression of the one more biomarkers in the test biological specimen based on the derived biomarker expression features.

### Further Embodiments 31

The non-transitory computer-readable medium of further embodiment 30, wherein the predicted expression of the one or more biomarkers comprises one of a predicted percent positivity or a predicted staining intensity.

### Further Embodiments 32

The non-transitory computer-readable medium of any one of further embodiments 30-31, wherein the predicted expression of the one or more biomarkers comprises both a predicted percent positivity and a predicted staining intensity.

### Further Embodiments 33

The non-transitory computer-readable medium of any one of further embodiments 30-32, wherein each training spectral data set is derived by: (i) obtaining a training biological specimen; (ii) dividing the obtained training biological specimen into a plurality of training tissue samples; and (iii) preparing each training tissue sample of the plurality of training tissue samples under different preparation conditions; (iv) staining each training tissue sample of the plurality of training tissue samples for the presence of one or more biomarkers; and (v) quantitatively assessing an expression of the one or more biomarkers in each of the training tissue samples.

### Further Embodiments 34

The non-transitory computer-readable medium of further embodiment 33, wherein the different preparation conditions comprise different unmasking conditions.

### Further Embodiments 35

The non-transitory computer-readable medium of further embodiment 33, wherein the different preparation conditions comprise different fixation durations.

### Further Embodiments 36

The non-transitory computer-readable medium of any one of further embodiments 30-35, wherein the training biological specimen comprises the same tissue type as the test biological specimen.

### Further Embodiments 37

The non-transitory computer-readable medium of any one of further embodiments 30-35, wherein the training biological specimen comprises a different tissue type than the test biological specimen.

### Further Embodiments 38

The non-transitory computer-readable medium of any one of further embodiments 30-37, wherein the test biological specimen is unstained.

### Further Embodiments 39

The non-transitory computer-readable medium of any one of further embodiments 30-37, wherein the test biological specimen is stained for the presence of one or more biomarkers.

### Further Embodiments 40

A method for predicting an expression of one or more biomarkers in a test biological specimen fixed for an unknown amount of time, comprising:
   a. obtaining test spectral data from the test biological specimen, wherein the obtained test spectral data comprises vibrational spectral data derived from at least a portion of the biological specimen (320);
   b. deriving biomarker expression features from the obtained test spectral data using a trained biomarker expression estimation engine (340), wherein the biomarker expression estimation engine is trained using training spectral data sets acquired from a plurality of differentially prepared training biological specimens and wherein the training spectral data sets comprise class labels of known biomarker expression for one or more biomarkers; and
   c. predicting the expression of one more biomarkers in the test biological specimen based on the derived biomarker expression features (350).

### Further Embodiments 41

The method of further embodiment 40, wherein the predicted expression of the one or more biomarkers comprises one of a predicted percent positivity or a predicted staining intensity.

### Further Embodiments 42

The method of any one of further embodiments 40-41, wherein the predicted expression of the one or more biomarkers comprises both a predicted percent positivity and a predicted staining intensity.

### Further Embodiments 43

The method of any one of further embodiments 40-41, wherein each training spectral data set is derived by: (i) obtaining a training biological specimen; (ii) dividing the obtained training biological specimen into a plurality of training tissue samples; and (iii) preparing each training tissue sample of the plurality of training tissue samples under different preparation conditions.

### Further Embodiments 44

The method of further embodiment 43, further comprising staining each of the plurality of training tissue samples for the presence of one or more biomarkers; and quantitatively assessing known percent positivity and/or known staining intensity for the one or more biomarkers.

### Further Embodiments 45

The method of any one of further embodiments 40-44, wherein the trained biomarker expression estimation engine comprises a machine learning algorithm based on dimensionality reduction.

### Further Embodiments 46

The method of further embodiment 45, wherein the dimensionality reduction comprises a projection onto latent structure regression model.

### Further Embodiments 47

The method of any one of further embodiments 40-44, wherein the trained biomarker expression estimation engine comprises a neural network.

### Further Embodiments 48

The method of any one of further embodiments 40-47, further comprising compensating the predicated expression of the one or more biomarkers for poor unmasking and/or poor fixation of the test biological specimen.

### Further Embodiments 49

The method of any one of further embodiments 40-48, wherein the one or more biomarkers include at least one cancer biomarker.

### Further Embodiments 50

The method of any one of further embodiments 40-49, wherein the test biological specimen is unstained.

### Further Embodiments 51

The method of any one of further embodiments 40-49, wherein the test biological specimen is stained for the presence of one or more biomarkers.

### Further Embodiments 52

The method of any one of further embodiments 40-51, wherein the obtained test spectral data comprises vibrational spectral information for wavelengths ranging from between about 3200 to about 3400 cm⁻¹, about 2800 to about 2900 cm⁻¹, about 1020 to about 1100 cm⁻¹, and/or about 1520 to about 1580 cm⁻¹.

1. A system for predicting an expression of one or more biomarkers in an test biological specimen the system comprising: (i) one or more processors, and (ii) one or more memories coupled to the one or more processors, the one or more memories to store computer-executable instructions that, when executed by the one or more processors, cause the system to perform operations comprising:
a. obtaining test spectral data from the test biological specimen, wherein the obtained test spectral data comprises vibrational spectral data derived from at least a portion of the biological specimen;
b. deriving biomarker expression features from the obtained test spectral data using a trained biomarker expression estimation engine; and
c. predicting the expression of the one or more biomarkers in the test biological specimen based on the derived biomarker expression features.

2. The system of claim 1, wherein the predicted expression of the one or more biomarkers comprises one of a predicted percent positivity or a predicted staining intensity.

3. The system of claim 1, wherein the predicted expression of the one or more biomarkers comprises both a predicted percent positivity and a predicted staining intensity.

4. The system of claim 1, wherein a fixation status of the test biological specimen is unknown.

5. The system of claim 1, wherein the biomarker expression estimation engine is trained using one or more training spectral data sets, wherein each training spectral data set comprises a plurality of training vibrational spectra derived from a plurality of training tissue samples stained for the presence of one or more biomarkers, and wherein each training vibrational spectrum comprises one or more class labels, wherein the one or more class labels comprise known biomarker expression levels for one or more biomarkers.

6. The system of claim 5, wherein the known biomarker expression levels comprise at least one of known percent positivities for one or more biomarkers and known staining intensities for one or more biomarkers.

7. The system of claim 5, further comprising one or class labels selected from the group consisting of a known unmasking duration, a known unmasking temperature, a qualitative assessment of an unmasking state, a known fixation duration, and a qualitative assessment of a fixation state.

8. The system of claim 5, wherein each training spectral data set is derived by: (i) obtaining a training biological specimen; (ii) dividing the obtained training biological specimen into a plurality of training tissue samples; (iii) staining the plurality of training tissue samples for the presence of one or more biomarkers; and (iv) quantitatively assessing an expression of the one or more biomarkers in each training tissue sample of the plurality of training tissue samples, wherein each training tissue sample of the plurality of training tissue samples is differentially unmasked, differentially fixed, or both differentially unmasked and differentially fixed.

9. The system of claim 1, wherein the trained biomarker expression estimation engine comprises a machine learning algorithm based on dimensionality reduction.

10. The system of claim 9, wherein the dimensionality reduction comprises one of (i) a projection onto latent structure regression model, or (ii) a principal component analysis plus discriminant analysis.

11. The system of claim 1, wherein the trained biomarker expression estimation engine comprises a neural network.

12. The system of claim 1, further comprising operations for comparing an actual biomarker expression of the test biological specimen with the predicted expression of the one or more biomarkers of the test biological specimen.

13. The system of claim 1, further comprising operations for compensating the predicated expression of the one or more biomarkers for poor unmasking and/or poor fixation of the test biological specimen.

14. The system of claim 1, wherein the test biological specimen is unstained.

15. The system of claim 1, wherein the test biological specimen is stained for the presence of one or more biomarkers.

16. A non-transitory computer-readable medium storing instructions for predicting an expression of one or more biomarkers in a test biological specimen treated, the test biological specimen having an unknown fixation status and/or unknown unmasking status, comprising:
(a) obtaining test spectral data from the test biological specimen, wherein the obtained test spectral data comprises vibrational spectral data derived from at least a portion of the biological specimen;
(b) deriving biomarker expression features from the obtained test spectral data using a trained biomarker expression estimation engine, wherein the biomarker expression estimation engine is trained using training spectral data sets acquired from a plurality of differentially prepared training biological specimens and wherein the training spectral data sets comprise class labels of known biomarker expression for one or more biomarkers; and
(c) predicting the expression of the one more biomarkers in the test biological specimen based on the derived biomarker expression features.

17. The non-transitory computer-readable medium of claim 16, wherein the predicted expression of the one or more biomarkers comprises one of a predicted percent positivity or a predicted staining intensity.

18. The non-transitory computer-readable medium of claim 16, wherein the predicted expression of the one or more biomarkers comprises both a predicted percent positivity and a predicted staining intensity.

19. The non-transitory computer-readable medium of claim 16, wherein the training biological specimen comprises the same tissue type as the test biological specimen.

20. The non-transitory computer-readable medium of claim 16, wherein the training biological specimen comprises a different tissue type than the test biological specimen.

21. The non-transitory computer-readable medium of claim 16, wherein the test biological specimen is unstained.

22. A method for predicting an expression of one or more biomarkers in a test biological specimen fixed for an unknown amount of time, comprising:
a. obtaining test spectral data from the test biological specimen, wherein the obtained test spectral data comprises vibrational spectral data derived from at least a portion of the biological specimen;
b. deriving biomarker expression features from the obtained test spectral data using a trained biomarker expression estimation engine (340), wherein the biomarker expression estimation engine is trained using training spectral data sets acquired from a plurality of differentially prepared training biological specimens and wherein the training spectral data sets comprise class labels of known biomarker expression for one or more biomarkers; and
c. predicting the expression of one more biomarkers in the test biological specimen based on the derived biomarker expression features.

23. The method of claim 22, further comprising staining each of the plurality of training tissue samples for the presence of one or more biomarkers; and quantitatively assessing known percent positivity and/or known staining intensity for the one or more biomarkers.

24. The method of claim 22, further comprising compensating the predicated expression of the one or more biomarkers for poor unmasking and/or poor fixation of the test biological specimen.
